(19) United States
(12) Patent Application Publication
(10) Pub. No.: US 2024/0420264 A1
(43) Pub. Date: Dec. 19, 2024

(54) Risk Evaluation and Threat Mitigation Using Artificial Intelligence

(71) Applicants: Abhijit R. Nesarikar, Plano, TX (US); Ashlesha A. Nesarikar, Plano, TX (US); Anika A. Nesarikar, Plano, TX (US)

(72) Inventors: Abhijit R. Nesarikar, Plano, TX (US); Ashlesha A. Nesarikar, Plano, TX (US); Anika A. Nesarikar, Plano, TX (US)

(21) Appl. No.: 16/591,555

(22) Filed: Oct. 2, 2019

Related U.S. Application Data
(60) Provisional application No. 62/740,359, filed on Oct. 2, 2018.

(51) Int. Cl. G06N 5/04; G06N 3/00; G06N 20/00

(52) U.S. Cl. CPC G06Q 50/265; G06N 3/006; G06N 3/08; G06N 20/00; H04W 4/90

(57) ABSTRACT

Systems and methods that create, use, enhance, maintain, and otherwise optimize a threat model—generally used for risk evaluation and threat mitigation—comprising artificial intelligence inherent in an entity is described. Certain embodiments describe, in countering a threat event, a need for an artificial intelligence entity to cooperate with non-expert users to give the users abilities to act on the domain in the users' self-interest. In countering a threat event, certain other embodiments describe that no single actor, in a heterogeneous collection of actors with varying abilities, may act in isolation to efficiently and effectively counter the threat to the collection; a minimum inevitable loss for the threat event may be achieved by an active cooperation of the heterogeneous actors of type comprising at least one of: expert users, non-expert users, and artificial intelligence entities that are sufficiently trained and knowledgeable on the threat event.

### CROSS-REFERENCE TO RELATED APPLICATION

The present application claims the benefit of U.S. Provisional Patent Application No. 62/740,359 entitled “Risk Evaluation and Threat Mitigation Using Artificial Intelligence” filed Oct. 2, 2018, the contents of which is incorporated herein by reference in its entirety.

### TECHNICAL FIELD

The present disclosure relates generally to artificial intelligence and, more particularly, a system and method for risk evaluation and threat mitigation in one or more domain.

### BACKGROUND

Excessive generalization of risk may in itself be a risk. An oversimplification of a risk model may do more harm than good by imparting a sense of security in the actors that may rely on the simplified model; e.g., the Value at Risk (VaR) model that was widely used before the subprime-mortgage financial crisis indicated short term risk by a single dollar value. On the other hand, calculating every single observable variable in a domain to evaluate risk at its most granular level—e.g., without making statistical assumptions and other generalizations—is currently not done; e.g., risks at granular levels in communication, in documentation, in general human understanding, and the like are currently not evaluated. One commonly used generalization may be to identify and document potential and historic threats to create and assemble a threat identification logic set (TILS) and other such algorithms for the identified and documented threats. Risks and shortcomings in this generalization approach of TILS may be introduced by one or more assumption of types comprising at least one of: relevant threats may be assumed to be known beforehand; an individual threat may be assumed to be adequately understood, sampled, and measured; and all relevant inter-threat interactions may be assumed to be included in the joint threat scenario for the system. The inter-threat interaction assumption may be a prominent risk factor for TILS as most statistical assumptions (in the interest of easier human comprehension, communication, and analysis) may comprise at least one of: independence of variables; identical distribution of variables (the IID assumption in the study of probability); ignorance of the multivariate nature of complex probability distributions; and disregarding of the higher-order cumulants of the multivariate distributions, typically beyond covariance.

Artificial intelligence (AI) comprising one or more type of artificial neural network (ANN) may be capable of working with risk in a granular form and converting the risk into a usable or communicable form on demand and when needed—e.g., for communication with humans or legacy systems. The present disclosure is of such a system and method. As used herein, the term “threat model” refers broadly to a predictive model based on such AI for one or more purpose of types comprising at least one of: learning, risk analysis and mitigation, communication, collaboration, agency, and attaining goals in general; a threat model may be driven by AI that may be supplemented by one or more algorithm comprising at least one of: logic set (e.g., rules and programs) and symbolic logic in general.

Currently, existing risk models (e.g., TILS) may be static during an occurrence of one or more relevant threat event. The risk models may not be adept at handling variations in the relevant threat events. They may undergo cascading failures—leading, in some cases, to catastrophic, domain wide, and system-wide failures—if several such distinct threat events present concurrently to a risk model that may be modelled to handle these events in isolation, especially with the aforementioned generalizations and assumptions. Models may be mostly fixed in time, based on known losses or the estimates of future losses for anticipated threat events in a domain; recommendations on threat mitigation at any other—especially future—times may be based on the original model that may have been fixed in time; a domain expert may be expected to skillfully adopt the likely outdated recommendations for his own situation. For example, for modelling complex systems, information technology (IT) threat modelers and actuaries may not consider time progression of risk on a relatively continuous timescale, and the recommendation to counter a threat at a given time may be derived from a model built for a different—typically past—time. The primary purpose of these recommendations may be to make the threat containment and response easier for an expert; in almost all cases, the expert responding to the threat may have the final say in even considering the recommendation, let alone following it. The system and method disclosed here may deliver just the needed recommendations and information, to the intended beneficiary that needs it, at the time that the beneficiary needs it. This may reduce, in a threat situation in a domain, the burden of quick decision making on experts and non-experts alike without the need for extensive training on that domain or the threat.

Threats may be categorized into two types: physical threats and cyber threats. The system and method needed to mitigate a physical threat may be substantially different from that of a cyber threat. For example, a bank robber demanding money at gunpoint from a bank teller in person is a physical threat, while an overseas hacker remotely stealing money from the bank over a computer network is a cyber threat. The risk mitigation and threat response mechanisms and processes for these two events may differ substantially.

### SUMMARY

A system and method that creates, uses, enhances, maintains, and otherwise optimizes a threat model comprising artificial intelligence (AI) inherent in an entity observing a domain is described in connection with the disclosure herein; wherein the entity may comprise one of: artificial intelligence entity (AIE) and swarm intelligence collective (SIC); and wherein the one or more use of the entity's threat model for one or more domain beneficiary may comprise at least one of: risk evaluation and threat mitigation. In certain embodiments, in a domain undergoing an active threat event, the system and method may emphasize a need for an entity to cooperate with one or more non-expert user, and giving the user one or more ability comprising at least one of: to act on the threat, act on the domain, and act in general in the user's self-interest, without the need for the user to acquire one or more skill comprising at least one of: expert knowledge and comprehension of the threat and the domain. In certain embodiments, for a domain undergoing an active threat event, with a heterogeneous collection of actors with varying abilities to counter the threat, no single actor may act in isolation to efficiently and effectively counter the threat to the collection; a minimum inevitable loss (MIL) for the threat event may be achieved by active cooperation of the heterogeneous one or more actor comprising at least one of: expert user, non-expert user, and AI entity that is sufficiently knowledgeable and trained on the threat event in the domain.

In an embodiment, an AIE's structure and function are described. An AIE may comprise one or more AI, sensor for generally observing a domain, part that may impart the AIE agency to act on the domain, and network to enable communication. The AIE may be contained in one container or may be distributed. The AIE may act as a single entity or as a part of an ensemble—referred to as swarm intelligence collective (SIC)—of type comprising at least one of: community, collective, swarm, and crowd.

Certain embodiments include threat model of an entity. In an embodiment, an inherent threat model built by the entity observing a domain that is undergoing a loss event may be a product of prior experiences. The general objectives behind the threat model built from historical experiences may comprise at least one of: one or more of minimizing a loss caused by the loss event and learning from the loss to improve the inherent threat model. In general, goals of the entity may comprise at least one of: its survival, its preservation, its prosperity, and its propagation.

Certain embodiments include learning and other activities of a threat model of an entity, with optimal allocation of one or more resource comprising at least one of: energy, compute, communication bandwidth, time, and attention. Activities of the entity generally may comprise at least one of: one or more of creation, learning, replication, communication, analysis, agency, and self-preservation. Certain other embodiments describe knowledge as comprising at least one of: parts of intelligence, means of attaining goals, and requirements for performing tasks in general. Certain other embodiments describe knowledge types: naive knowledge, expert knowledge, proficient knowledge, and wholistic knowledge, and their corresponding intelligence types: naivety, proficiency, expertise, and wholistic intelligence.

Certain embodiments include an instinct of an entity, wherein the instinct may be a set comprising at least one of the entity's: capability, behavior, and action in general that may be carried out with predetermined extent and structure of attention. Certain other embodiments include learned instincts and hardcoded instincts. Certain other embodiments describe types of instincts, e.g., reflex instinct, attentive instinct, and fine-tuned instinct.

In an embodiment a threat model of an entity receives an input matrix of a domain observation by the entity and generates a risk profile, and a resolution recommendation. In an embodiment, a risk profile may comprise loss message (LM), loss likelihood (LL), and loss impact (LI); LI is further characterized by loss extent (LE), loss containment (LC) possibility, loss rectification (LR) possibility, loss social significance (LS), and loss duration (LD); and a resolution recommendation (RR) may comprise one or more resolution message (RM), resolution priority (RP), and resolution success probability (RS).

Certain embodiments, for a threat model of an entity observing a domain to deal with a threat event in the domain, may involve one or more challenges in identifying a domain observation's one or more part on which to focus its attention and apply the threat model. The one or more challenges comprise one or more shortcoming in at least one of: A. accuracy of risk profile prediction; B. Time to detection (TTD) and time to recommendation (TTR); and C. domain cooperation. Certain other embodiments include defects that may be caused by the challenges and methods and systems for mitigation of the defects.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 illustrates a block diagram of an AIE in accordance with an embodiment of the present application;

FIG. 2 illustrates a block diagram of an AIE in accordance with an embodiment of the present application;

FIG. 3 illustrates a schematic of a potential threat actor in accordance with an embodiment of the present application;

FIG. 4 illustrates a schematic of a potential threat actor in accordance with an embodiment of the present application;

FIG. 5 illustrates a flow diagram of a method in accordance with an embodiment of the present application;

FIG. 6 illustrates an implementation of a threat model in a domain in accordance with an embodiment of the present application;

FIG. 7 illustrates an implementation of a threat model in a domain in accordance with an embodiment of the present application;

FIG. 8 illustrates an implementation of a threat model in a domain in accordance with an embodiment of the present application;

FIG. 9 illustrates an implementation of a threat model in a domain in accordance with an embodiment of the present application;

FIG. 10 illustrates an implementation of a threat model in a domain in accordance with an embodiment of the present application;

FIG. 11 illustrates an implementation of a threat model in a domain in accordance with an embodiment of the present application;

FIG. 12 illustrates graph plots of a method in accordance with an embodiment of the present application;

FIG. 13 illustrates graph plots of a method in accordance with an embodiment of the present application; and

FIG. 14 illustrates an implementation of a threat model in a domain in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are exemplary by way of illustration only, and not by way of limitation. Various substitutions, modifications, additions, and/or rearrangements within the spirit and/or scope of the underlying inventive concept will become apparent to those skilled in the art from this disclosure.

As used herein, the term “entity” may refer broadly to artificial intelligence entity (AIE) or swarm intelligence collective (SIC). A threat model may be an inherent attribute of an entity. As used herein, the threat type “cyber threat” consists of threats due to computer and computer network based malware (e.g., viruses and worms), malicious hacking, and phishing. As used herein, threats are partitioned into two mutually exclusive types, “physical threats” and “cyber threats”. In general, systems and methods required for threat resolution of cyber threats may be different from those required for physical threats. In an embodiment, a hacker stealing money over a bank's computer network by maliciously transferring it from a first account to a second account is an example of a cyber threat; an individual withdrawing the stolen money from the second account from a branch of the bank is an example of the physical threat.

The present disclosure is of a system and a method to evaluate the risk of, and propose resolutions to mitigate emergencies, vulnerabilities, and losses caused by threats and threat activities resulting from the threats in real time. An emergency, vulnerability, or a loss may be before, during, or after the event of a threat or a threat activity. The threat or threat activity may comprise events ranging from at least one of: manmade to natural, physical to virtual, slow to sudden, localized and manageable to catastrophic and unmanageable, frequent to rare, and known to unknown. The harm from the threat and threat activities may come to assets comprising at least one of: life; natural resources; artifacts; businesses processes; business, private, or public infrastructures; public places; public or private interests; real, tangible, psychological, cyber, or virtual spaces; one or more intangible comprising at least one of: skills, goodwill, and reputation; and information or knowledge in general.

In an embodiment, threat modeling of a domain, to evaluate and mitigate risks for that domain, comprises at least one of: one or more of analysis of historical information; current information; and projected information (e.g., induction, inference, and the like) to identify likely threats and their impacts on threat model beneficiaries. The threat model beneficiaries may or may not be a part of that domain. For example, an insurance company insuring a certain aspect of a domain's safety against certain losses is typically not part of the domain, but may be a beneficiary of the domain threat model. In another example, a relief organization that is planning for provisions needed to cover potential losses from a coming hurricane season may be a beneficiary of threat models for the hurricane season, with or without the knowledge by the relief organization of where, when, and the extent to which the threat of the hurricane may materialize. The types of beneficiaries comprise at least one of: live, natural, and AI actors in general; systems, institutions, organizations, governments, and communities; tangible artifacts (e.g., a painting in a museum, a computer, infrastructure, etc.); and intangible artifacts (e.g., goodwill, customer data, a social opinion, an idea, etc.). An example of an intangible artifact is the social-media reputation of an organization.

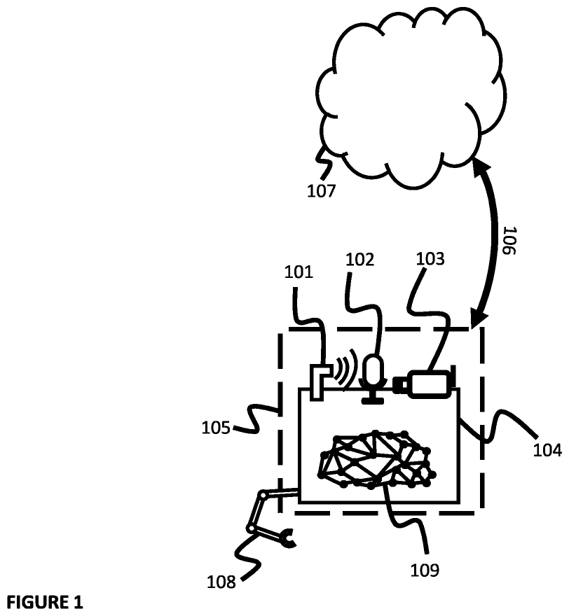

In an embodiment, threat modelling is typically part of an entity's intelligence; such an entity may be an intelligent machine, in general, or an artificial intelligence entity (AIE) owing its intelligence to one or more variety of artificial intelligence (AI) comprising at least one of: types of reinforcement agents, types of artificial neural networks (ANN), and types of expert systems. In an embodiment, FIG. 1 describes a representative AIE 105 with one or more sensor of type comprising at least one of: video 103, audio 102, tactile, inertial, orientation, motion, olfactory, three-dimensional location sensors and positon systems, light detection and ranging (e.g., lidar), and devices based on spectrum and waveforms—e.g., infrared 101 (IR), x-ray, ultra-wide band, and aggregated bandwidths. Sensory input is processed by the AI 109 comprising at least one of: ANN, and reinforcement agent. AIE 105 may be capable of agency comprising at least one of: autonomy, locomotion, and in general the ability of an AIE to act on or influence its domain; an example of agency is manipulation of robotic arm 108. AIE 105 may be for the most part held in a container 104 and may be connected 106 to a network 107; a network type may comprise at least one of: local area, wide area, wireless, the cloud (network cloud), Bluetooth, ultra-wideband (and other spectra), and Internet. The AIE is able to enhance its intelligence, efficacy, and effectiveness by participating in one or more activity comprising at least one of: communication, interaction, cooperation, resistance or coercion, competition, conflict, conflict resolution. The AIE may act as a single entity or as a part of an ensemble—referred to as swarm intelligence collective (SIC)—comprising at least one of: community, collective, swarm, crowd. As a collective, a SIC may be referred to as an entity.

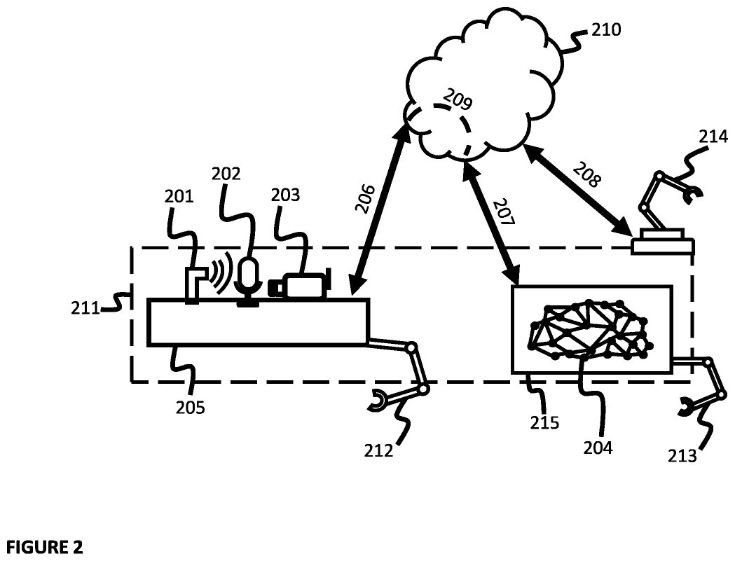

In one embodiment shown in FIG. 2, an AIE 211 may be distributed such that its constituents may not be part of a single tangible containment (e.g., 205 or 215), single physical location, single virtual location (e.g., a cloud location), or a single network. The constituents of AIE 211 comprise one or more AI 204; one or more container 205 and 215; one or more sensor 205—comprising at least one of: video 203, audio 202, IR 201, and the others similar to the ones described with respect to FIG. 1; and one or more components that enable domain manipulation, e.g. robotic arm 212, 213, and 214. Sensor container 205, sensors 205, and one or more sensor 205 are used synonymously and indicated by block 205. The communication 206, 209, and 207 between the sensors 205 and AI 204 may take place over a network 210; similarly, communication 207 and 208 between AI 204 and robotic arm 214 may take place over network 210. The constituents of AIE 211 may communicate with one another, other devices, and other entities over the same 210 or different networks. The AIE 211 constituents may be distributed in a variety of ways; e.g., locations of robotic arms may comprise at least one of: one or more of sensor container 205, AI container 215, and an independent location 214. In an embodiment, the AIE constituents may be distributed over one or more network 210 in arrangements comprising at least one of: wherein the one or more constituents may be located in different geographic locations; wherein the one or more constituents may be mobile (e.g., flying, or moving on or under water or ground); and wherein the one or more constituents may communicate in different ways (e.g., synchronously and asynchronously). An example of a distributed AIE is a mobile phone with sensors and notification agencies—e.g. ring tones, vibrations, and light flashes-communicating with one or more AI in the cloud to accomplish a certain task; in another example the mobile phone and AI in the cloud may coordinate remote actions—e.g., turn lights on/off, adjust a remote video camera, operate a remote mechanical arm, pilot a drone, and enact countermeasures to fight an impending cyberattack.

In an embodiment, a dog sensing a movement in bushes focuses its attention to that event and may not relinquish that attention until the perceived threat diminishes; e.g., the movement stops after a bird flies away from the bushes. This embodiment may also be extended to an AIE that is adequately trained and provisioned with sensory and locomotive abilities. Such an AIE is capable of identifying the movement in the bushes as a potential threat, focusing its attention on the bush, and maintaining that attention, acquiring additional information related to the situation and the domain as a whole, until a logical reason eliminating the threat perception presents itself; the movement may have been caused by a bird—a low-threat adversary.

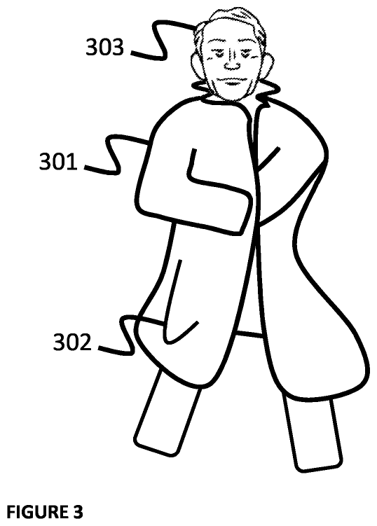

By way of analogy and not limitation: in an embodiment, a police officer or an AIE capable of focusing his/its attention notices a suspicious bulge 302 in trench coat 301 of an individual 303 with one hand clearly holding the long hidden item in the coat (FIG. 3), and focuses his/its attention on the event until such time that the perceived threat diminishes to his/its satisfaction; e.g., the man in FIG. 3 is hiding a bouquet of flowers from a women walking towards him in anticipation, and the police officer or the AIE recognizes them as such. In another embodiment, the officer or the AIE may further investigate the event if the hidden item appears to have an exposed end that resembles a known deadly weapon—for example, a club, a long blade, or a gun.

In an embodiment, an inherent threat model built by an entity may be a product of prior experiences; in some cases, the threat model may be backed by an instinct that is borne out of perceived high-impact threat incidents in the entity's portfolio of prior experiences, or learning. The general objectives behind the threat model that is built from historical experiences may comprise at least one of: minimizing losses caused by the current loss events and learning from the losses incurred in the current loss events to improve the inherent threat model. An extensively experienced entity may even use the threat model as a differentiator from other less experienced entities—of the same or other kinds—to advance its own and its community's goals. Goals of an entity may comprise at least one of: its survival, preservation, prosperity, and propagation. In other embodiments, the one or more goal also comprises at least one of: the survival, preservation, prosperity, and propagation, of one or more beneficiary comprising at least one of: domain beneficiaries; temporary or transient beneficiaries; predefined or predisposed beneficiaries in general; the entity's own beneficiaries; and the beneficiaries of a SIC, if the entity is a member of the SIC. An entity advancing its goals by improving its threat model seeks one or more activity comprising at least one of: more exploration, more experience, cultivating and effective use of instincts, and increasing efficiencies of learning. The one or more learning efficiency comprises at least one of: learning with less experience (e.g., less data); learning in shorter time; and learning with potentially ambiguous experience (e.g., unlabeled or partially labelled data). For a typical entity, in advancing its goals, its threat model is active not only in the defensive or survival situations, but also in one or more situation comprising at least one of: offensive, aggressive, attack, and counterattack. An end result of an entity's threat model activities may be its actions on its environment with one or more optimal allocation comprising at least one of: time, comprising at least one of: observation time, analysis time, and agency (e.g., the domain manipulation capability) time; resources (e.g., energy, compute, communication bandwidth, storage capacity, etc.); and attention to mitigate the impact of the current and future losses due to threats and threat incidents, or to advance its goals in general. In general, available time (e.g., duration of time) and attention may also be regarded as resources. Resources are needed by an entity and its threat model in carrying out one or more activity comprising at least one of: creation, learning, replication, communication, analysis, troubleshooting, agency (e.g., ability to act on and influence the entity's domain), self-preservation, and other operations in general.

In an embodiment, an entity's attention and its threat model observing a domain is an attribute that imparts the entity with an ability to focus its finite resources on the important aspects of the domain observations so as to achieve its goals with efficient and optimal use of time and resources—a thorough, even, and complete processing of all domain observations with the available finite resources may not be possible for the entity. Attention may be the entity's resource as well as its skill. Attention may impart the entity structured, ordered, and efficient ways to exercise its one or more ability comprising at least one of: prioritizing some aspects and some areas of the domain to make observations and disregarding some others; monitoring its surroundings in parallel with other activities; prioritizing and reprioritizing its goals in real-time; and allocating and reallocating resources in real-time. Attention may be a resource needed for an entity's learning of a task, skill, or knowledge; better attention—in both extent and quality—may lead to superior and faster learning, leading to expertise in that task, skill, or knowledge; gaining expertise may allow the entity to use less attention in exercising that task, skill, or knowledge; and the entity may direct the freed attention to learn and gain expertise in other tasks, skills, or areas of knowledge. In general, higher attention entails higher use of other resources; however, possessing or gaining expertise—either due to learning or otherwise—may allow for lower attention and optimal use of resources and time.

In an embodiment, a threat model of an entity may learn to dynamically allocate attention on execution of a first set of two or more tasks concurrently; gaining expertise in the concurrent execution of the first set of tasks may allow the entity to concurrently execute a second set of tasks effectively and efficiently; the entity may gain further expertise in concurrent execution in general by learning tasks, skills, and knowledge related to concurrent execution. Such an entity may gain one or more expertise comprising at least one of: in effective and efficient allocation of attention and other resources in concurrent execution; in anticipating, planning for, and resolving difficulties related to one or more concurrent execution comprising at least one of: deadlocks, race conditions, data or memory corruption, and indeterminism in general; in scheduling and adjusting task execution rates in real-time to achieve a desired result or goal; and in carrying out faster simultaneous execution of tasks. Concurrent execution may also be referred to as concurrent processing, concurrency, parallel processing (e.g., parallel learning), parallel execution, multitasking, and multithreaded processing, among others.

In an embodiment, a threat model of an entity observing a domain uses a first part of its attention to learn a first skill, and assigns a second part of its attention on learning to learn as a second skill. As the entity learns or masters the first skill, it may free the first part of its attention, increasing its available attention. The entity may further utilize a third part of its attention—derived from its available attention—to learn a new third skill, a fourth part of its attention to learn a new fourth skill, and so on. The entity's second part of attention on learning to learn as a second skill, may continue as the first, third, and the fourth skills are being learned—in series, in parallel, or otherwise. The first, third, and fourth part of the attention may be freed into the available attention, and the entity may improve the second learning to learn skill with every additional learning of the skills. With every improvement in the entity's learning to learn skill, the entity may require less attention, less time, and less of other resources to learn new skills, improve upon existing skills, or solve problems in general. The entity may learn to learn continuously, intermittently, serendipitously, as needed, as a planned or an unplanned activity, or otherwise. The assignment of attention to the first, second, third, and the fourth skills may be of one or more type comprising at least one of: dynamic, concurrent, real-time, need based, goal driven, learned or knowledge driven, random, and ad-hoc.

In an embodiment, a threat model of an entity observing a domain may be imparted, programmed, or hardcoded with attention as a skill; the entity may also otherwise learn attention as a skill. In an embodiment, attention as a skill may be learned as a byproduct of other learning—e.g., learning an otherwise new skill, learning to improve an existing skill, or solving a problem in general. The initial extent and quality of attention as a skill may be further improved, honed, or optimized by the entity through learning of attention in general.

In an embodiment, a threat model of an entity observing a domain uses a first part of its attention on a first task (e.g., learning, monitoring, or otherwise problem solving); and assigns a second part of its attention on a second task comprising at least one of: observing its own attention, improving its own attention, and further learning attention in general. As the entity accomplishes or otherwise completes the first task, it may free the first part of its attention, increasing its available attention. The entity may further utilize a third part of attention—derived from its available attention—on a third task; a fourth part of attention on a new fourth task; and so on. The entity's second task—e.g., observing and improving its own task, and learning attention—may continue as the first, third, and the fourth tasks are being accomplished or completed—in series, in parallel, or otherwise; the first, third, and fourth part of the attention are freed into the entity's available attention; and the entity may improve—e.g., quality and extent of—its attention or gain new attention related skills. The entity may improve—e.g., quality and extent of—its attention or gain new attention related skills continuously, intermittently, serendipitously, as needed, as a planned or an unplanned activity, or otherwise.

In an embodiment, an entity observing a domain, the entity's attention, or some part of it is assigned to monitor one or more key events (e.g., events of significance) or facts in one or more aspects of the domain, such that upon detecting such a key event or fact, the entity may reprioritize its activities and increase its attention and other resources on that key event or fact along with the relevant aspects of the domain. The key event or fact may be embedded in other information, other events or facts, or noise in general; the entity assigns its attention to identifying, searching, or in general improving the signal-to-noise ratio of the key event or fact. For example, one or more key event may be a selection of actions from a set of all possible potential actions for an entity to enable its own mobility (e.g., locomotion). In mobility, as a domain observer, the entity may estimate (e.g., perceive), due to optical flow, one or more of its own movements, shapes, distances, and relative movements of other objects, and combinations thereof; the entity may rely on this ability (which may be referred to as affordance perception), to chart its own mobility comprising at least one of: moving itself, moving one or more of its parts, and moving one or more other object; wherein optimization of attention, forecasting, and instinct may be employed by the entity.

In an embodiment, for an entity observing a domain in search of a solution or for monitoring purposes in general, the entity's attention is used to filter through clutter, superfluous or irrelevant information, or noise in general to avoid distractions—these distractions may result in unnecessary expenditure of resources, delay or failure in solving a problem, or delay or failure in reaching one or more goal—and to focus on one or more relevant part of information, which when processed by the entity's threat model, imparts one or more advantages to the threat model comprising at least one of: increasing chances of solving a problem, reaching one or more goal, and optimization of resource utilization.

In an embodiment, an entity observing a domain and having necessary agency—e.g., movements of a robot hand—is tasked to detect the appearance of red balls in a work area in the domain and to remove such red balls to a designated basket. The entity focuses its attention on the work area and away from other aspects of the domain; observation of the other aspects of the domain are filtered and ignored by the entity. Upon identification of the possibility of a red ball in a newly appeared heap of objects, the entity adjusts its camera and focuses its attention to better identify the existence, location, and other features (e.g., size, texture, etc.) of the red ball. As a result of the knowledge acquired about the red ball, the entity is able to use optimal and precise resources—e.g., proper gripping device, orientation of the gripping device, optimal force needed to hold the ball, and optimal trajectory to deliver the ball to the basket—in accomplishing the task.

An instinct of an entity and its threat model, observing a domain, may be their one or more attribute comprising at least one of: capability, behavior, initiative, and action in general, typically shared by like entities, such that the attribute may be exercised with predetermined extent and structure of attention. An instinct may be of one or more type comprising at least one of: a learned instinct, where attention as a resource may be learned or optimized (and may or may not be accompanied by optimization of other resources or learning of other skills) by the threat model, in general advancing the entity's goals; and a hardcoded instinct, where an entity may be manipulated or rendered externally predisposed (e.g., by creators, maintainers, supervisors, or administrators of the entity either at the time of creation, operation, or otherwise) to a set of capabilities, behaviors, initiatives, or actions.

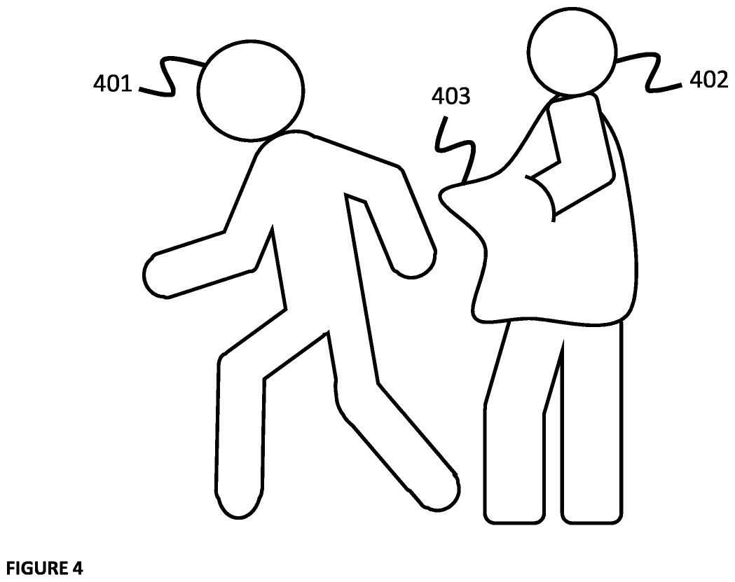

An embodiment, FIG. 4, shows a man 402 aiming a potential gun 403 from inside his jacket pocket towards a potential victim 401. Though a gun is not visible, an experienced entity may register the possibility of a gun 403 as a threat, until such time that the object 403 hidden by the man 402 is otherwise revealed as an innocuous object; e.g., a small stick. An AIE that has learned to detect guns from only direct visual cues—as an example of naivety—will miss the possibility of the hidden gun 403 in the man's 402 pocket and miss a vital threat signal in its domain. The same AIE may attain the experience of registering the threat posed by hidden guns—or other implied threats in general—due to one or more technique comprising at least one of: by inference; by induction; by communication with other more experienced AIE; by virtue of being a member of a SIC; and by prior exposure or learning of the subject matter—e.g., detecting the possibility of hidden guns from visual and other cues. The newly attained experience of identifying hidden guns is an example of proficiency, which may be elevated to expertise with further experience.

Entities may observe and influence one or more domain from different contexts of the one or more domain. Such contexts and observations of the contexts may be described by matrices of the context properties; the matrices may have various possible dimensions. As used herein, the term “matrix” is used broadly to mean one or more form of information that may be reduced, converted, or otherwise represented by an algebraic matrix in general; vectors are also considered matrices in that the terms vector and one-dimensional matrix are used synonymously. An entity in a context may act on the entity's domain and may influence that context. The entity's threat model operates on the input context properties—also referred to as an input matrix—to generate an output matrix comprising at least one of: risk profile matrix (also referred to as risk profile) and threat resolution matrix (also referred to as threat resolution). The entity's AI structure may represent its threat model, and may comprise at least one of: neural networks, reinforcement agents, and other AI methodologies (e.g., typically to simulate a non-linear function). In general, the composition of the AI structure may be dependent on the complexity and dimensionality of the input and output matrices and the complexity of the threat model in general.

In an embodiment as it relates to FIG. 2, the constituents of AIE 211 may comprise AI 204, but other components may vary; e.g., in a first example, AIE 211 may not include any sensors 205; in a second example, AIE 211 may not include robotic arm 212, 213, and 214 or other components that contribute to agency (e.g., locomotion and movements) of AIE 211; and in a third example, AIE 211 may be on an isolated network (e.g. an air-gapped network) without connectivity to the external world. The AIE 211 in the embodiment may communicate synchronously or asynchronously to receive an input matrix and send an output matrix (comprising at least one of: risk profiles and threat resolutions); e.g., the AIE may communicate using dedicated or dynamic interfaces, API, or other actors physically enabling an input (an input matrix) and retrieving an output (the output matrix); e.g., in the case of the AIE on an air-gapped network.

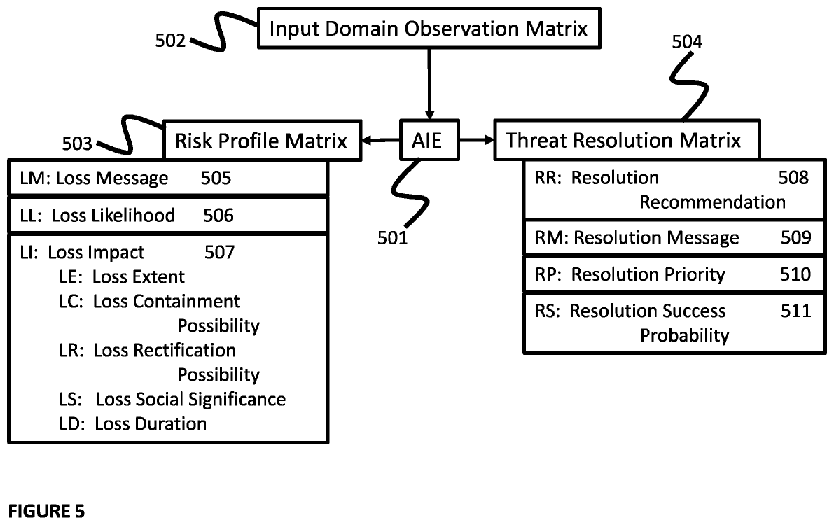

For an entity in a domain, an aggregation of input matrices of measured properties of all contexts of the domain may form one or more input matrix (typically the number of matrix dimensions may increase with number of measured properties and the number of contexts) for its corresponding threat model; the threat model may be able to evaluate or estimate a risk profile for the domain corresponding to the one or more input matrix. The risk profile may be probabilistic in nature, and it may indicate the likelihood and extent of loss for that domain for the given input matrix. Though the risk profile is generated in matrix format and may represent all available risk information, it may be inconvenient to communicate in natural languages or other colloquial forms of communication; risk profiles may be converted and represented in forms suitable for communications with one or more participant comprising at least one of: systems, other entities, and other domain actors. The communications may exist for one or more reason comprising at least one of: management, collaboration, goal advancement, and productivity gain. In an embodiment, a risk profile comprises a loss message (LM), loss likelihood (LL), and loss impact (LI). LI is further characterized by loss extent (LE), loss containment (LC) possibility, loss rectification (LR) possibility, loss social significance (LS), and loss duration (LD). Similarly, in an embodiment, a risk profile may also accompany a threat resolution comprising one or more resolution recommendation (RR) for one or more purpose comprising at least one of: corrective action, precautionary measure, and as a threat mitigation approach in general. A resolution recommendation (RR) may comprise one or more of: corresponding resolution messages (RM), resolution priorities (RP), and resolution success probabilities (RS). As part of an embodiment, FIG. 5 shows an AIE 501 in a domain—acting alone or as a member of a SIC—where input observations 502 of the domain are processed by the AIE 501, generating the risk profile 503 as well as threat resolution 504. Risk profile 503 is categorized into loss message 505, loss likelihood 506, and loss impact 507; wherein loss impact is further divided into loss extent (LE), loss containment (LC) possibility, loss rectification (LR) possibility, loss social (LS) significance, and loss duration (LD). Similarly, the threat resolution matrix (504) is categorized into one or more of resolution recommendations 508, resolution messages 509, resolution priorities 510, resolution success probabilities 511, and combinations thereof. The risk profile and threat resolution, their categories, and subcategories are data that can be represented in one or more way comprising at least one of: linguistic or symbolic, pictures, sound, and other information representations.

In an embodiment, a man overboard scenario in a marine environment for a given domain threat model of one or more observing AIE results in different risk profiles depending on whether the man is wearing a lifejacket or not. As compared to one with a lifejacket, the without lifejacket scenario may generate a severe loss impact (LI) level with high loss likelihood (LL). The scenario without the lifejacket may also have higher LE, LS, and LD, and lesser LC and LR. The AIE may notify a nearby crew member of this threat event in a brief loss message (e.g., man overboard and the location) with details and steps required for the threat resolution; e.g., a RR with the location of the nearest life jacket and an ideal location to throw the lifejacket to the scenario victim. At the same time, the AIE may notify the captain of the vessel or a person in charge of safety of the threat event, the corresponding risk profile, and a threat resolution that is tailored for the captain or the safety personnel; e.g., the crewman was notified; backup may be needed for the rescue activity; paramedics are notified but not yet on the scene; and the names of the scenario victim's next of kin who may need to be notified.

An entity learns and updates the threat model of its domain from observing its domain scenarios and their corresponding losses, and reconciling—e.g., estimating errors in—those observations with predictions to improve its threat model; e.g., reducing the errors in predicting the risk profile. The entity improves its threat model by learning and experience; e.g., repeated exposure to different domain scenarios that result in observed losses in given durations of time or with respect to other domain variables. The design of the risk profile matrix may be based on the observed, relevant, and other consequential losses for the designated beneficiaries for that domain; similarly the design of the threat resolution matrix is based on knowledge and experience of resolutions that may have been known, forecasted, or employed to mitigate those losses. Thus the domain threat model of an entity may evolve and improve with time as the entity's experience and exposure to the domain increases. As the experience and maturity of a threat model improves, the predicted or forecasted risk profile may increasingly match with that of the observed one, and the threat model may generate more effective resolution recommendations. This may result in a temporal nature of the threat model; the temporal nature of the threat model may also be a result of ongoing changes to the entities, artifacts, and other constituents of the domain, and the domain in general with time.

The entity's threat model and its effectiveness typically depends on both the completeness and granularity of the input properties matrix. An input properties matrix that covers all observable properties of a domain in their most granular forms is the complete description of the domain; such an input observation matrix or an input matrix may correspond to all known properties of the domain and may result in a complete threat model of the domain. A complete threat model may be essential to describe the complete risk profile of the domain at the present, or in the past, or to forecast the risk in the future. A future risk profile may be subject to a given set of assumptions of scenarios incorporated in the corresponding future input matrix. It may not be practical for an isolated entity with its relatively limited own resources and observation capabilities to learn or generate a relatively complete domain threat model for its domain, or be the beneficiary of the resulting relatively complete risk profile and threat resolution to advance its goals. Such an entity can be thought to be in constant pursuit of improving its threat model to effectively advance its goals within its domain with respect to the other competing entities in that domain. In another embodiment, an entity may also be limited in resources and execution time to use or infer a risk profile from a threat model at a given time for a given input matrix; it may instead rely on its instinctive ability to arrive at an ideal risk profile and threat resolution for the given input matrix. Everything else being the same, the better the ability of a threat model to infer or predict the risk profile and threat resolution for a scenario at hand, the better its chances are of making decisions that advance its goals in its domain with respect to that scenario.

For an entity observing a domain, the entity's attention and its threat model may be regarded as a resource to overcome one or more adversarial factor—comprising at least one of: variability, noise, and distraction—in the input observation matrix, the output of the threat model, and the domain in general. Attention may be needed to focus on some variables and relatively attenuate some others to improve the goals of the threat model. With increased expertise of a threat model towards certain goals in a given domain, the focus becomes well defined for a given set of observation input matrices; further need for discrimination among variables diminishes, and sensitivity and noise are at optimal levels; in other words, need for attention may diminish, and the response of the threat model may become instinctual for those goals with the given set of input matrices in the given domain.

In an embodiment, for an entity observing a domain, at the first identification of a threat, at time t=0, attention may involve the identification and confirmation of the threat. The subsequent risk profile and risk resolution may point to a need for added information about the threat and domain in general, with the added information comprising at least one of: enhanced sensitivity, improved resolution, and amplification of certain input matrix variables over others. The need for added information may be encoded in a threat resolution directed at the entity itself; the entity may act on that need to focus on the needed variables or aspects of the domain to improve one or more quality of subsequent observations—the one or more observation quality comprises at least one of: magnification, sensitivity, and resolution. For time instances t>>0, until the need for attention subsides, the entity may continue its attention on the domain aspects or the needed variables to increase the accuracy of the risk profile. The threat resolution calling for increased attention on the domain aspects may be directed to the entity itself or other actors of the domain. The other domain actors may provide feedback to the entity, improve their own threat profiles, or advance the goals of the beneficiaries in general. In an embodiment the entity is an AIE in a SIC that generates a threat resolution that is directed to its own SIC; or in another embodiment the entity is a SIC that generates a threat resolution that is directed to one or more of its constituent AIE.

As used herein, the term “naive knowledge” of one or more domain aspect—comprising at least one of: skill, task, activity in general, and thing in general—refers broadly to one or more foundational basis for intelligence related to that one or more domain aspect that an entity may acquire with techniques comprising at least one of: one or more of context-free feature learning, and first-order and simpler lower-order logic rules learning. As used herein, the term “naivety” or “naive” in one or more aspect related to a domain in general refers broadly to a type of intelligence attained by an entity in that one or more aspect due to acquisition of naive knowledge of that one or more aspect by that entity, wherein the one or more aspect comprises at least one of: skill, task, activity in general, and thing in general. Solving one or more problem with naivety may have one or more characteristic comprising at least one of: identifying features of a scenario without comprehension of the context of the scenario; not using attention or using attention non-optimally (e.g., focusing attention on individual granular input matrix facts with attention and one or more other available resource distributed across all the facts more-or-less evenly); and aggregation of one or more information without exploring or deriving knowledge and relationships that may exist in that information due to one or more underlying context. In an embodiment, an entity has attained naivety in the independent feature detection skills of identifying a handgun in video, and identifying sounds of a fired handgun; the entity may see and hear a fired shot, and report two different incidents of gunshots. The naive entity lacks the context to know that both the incidents represent a single gunshot.

As used herein, the term “proficient knowledge” of one or more domain aspect—comprising at least one of: skill, task, activity in general, and thing in general—refers broadly to one or more ability of an entity to combine one or more discrete naive knowledge abilities related to the domain aspect to perform a relatively complex task comprising at least one of: analyzing a context or a situation from one or more naive knowledge; learning of simpler lower-order relationships between things; learning of broad and general guidelines and rules of thumb; learning by supervised decomposition of a situation into goals or milestones; supervised serial stepwise learning; exercising different naive knowledge abilities in parallel; applying simplified rules in a stepwise or serial manner; and supervised decomposition of a situation to arrive at a meaningful conclusion. For such an entity, organization, interpretation, and representation of information in an input matrix may conform to and be contained within segregated, isolated areas of learning that may correlate to learned rules of thumb or simplified principles. An entity may reach proficient knowledge—or become a proficient entity—in a given task by learning that may be supervised with respect to a known objective or a goal using samples that may be drawn or derived from existing information about the task.

An entity may reach proficient knowledge—or become a proficient entity—in a given task by learning that may be supervised with respect to a known objective or a goal using samples that may be drawn or derived from existing information about the task. As used herein, the term “proficiency” or “proficient” in one or more aspect related to a domain in general refers broadly to a type of intelligence attained by an entity in that one or more aspect due to acquisition of proficient knowledge of that one or more aspect by that entity, wherein the one or more aspect comprises at least one of: skill, task, activity in general, and thing in general. In general, for a given domain aspect, an entity's proficient knowledge is superior to its one or more naive knowledge; the entity's proficiency is superior to its one or more naivety. In an embodiment, an entity's proficiency of a domain aspect comprises that entity's one or more naivety and one or more other proficiency of that aspect. In an embodiment, an entity that has attained proficiency in the independent skills of identifying a handgun, identifying sounds of a fired handgun, and ability to localize and triangulate a sound source, may hear a fired shot from an out-of-sight handgun and report it as “gunshot heard”; the novice entity may not recognize the need to triangulate on the source of the gun shot sound, turn the camera towards the identified source, and gather visual data related to the handgun.

The efficacy of the proficient entity may be practically applicable (e.g., useful in a real-life scenarios) for a set of scenarios or their derivatives that may be part of—or closely related to—the learning set of the entity; such a type of task is referred to as an interpolation-task. An entity with proficient knowledge may lack ability to deal with significant deviations from the learned set of tasks; if an input matrix represents a task that is different from the learned set of tasks—referred to as an extrapolation-task—the entity may produce erroneous results. For example, an entity trained for identifying handguns, may lack abilities related to varying and transient context, for example, the ability of triangulating gunshots sounds, and tracking handguns.

As used herein, the term “expert knowledge” of one or more domain aspect—comprising at least one of: skill, task, activity in general, and thing in general—refers broadly to one or more ability of an entity that may be superior to one or more proficient knowledge of that one or more domain aspect to achieve the entity's goals, wherein an entity may exploit techniques comprising at least one of: analyzing a varying context; differentiating important facts and assigning them attention and other available resources; recollecting one or more learning step comprising at least one of: verification of applicability of known proficient knowledge, interpretation of facts with the help of prior known facts, and organization of information in line with historic patterns to accomplish a similar task and repurpose the learning to the current task; at least proficiency on reasoning; at least proficiency in extending and applying knowledge across domains or across knowledge areas; at least proficiency in online learning (e.g., incorporating external feedback of right or wrong during its operation, e.g., at the time of prediction, into its threat model); at least proficiency in learning from sparse examples or sparse samples; having at least proficiency in one or more skill in other domains; and at least proficiency in using attention to learn one or more skill. In an embodiment, an entity that has attained expertise in identifying handguns, identifying gunshot sounds, and tracking them in a given set of scenarios, upon hearing an out-of-sight gunshot, locates the position of the gun by triangulating the source of the gunshot sound; turns its video cameras to the location of the gun; focuses attention on the gun, the gun shot, and related things and events; and tracks them with time.

An entity may reach expert knowledge—or become an expert entity—in a given task by learning that may be supervised, unsupervised, or combinations thereof, with respect to a known objective or a goal using samples that may be drawn or derived from existing information about the task. A need or a goal of the task is imparted in the entity by an actor or a domain beneficiary other than the entity itself. The entity may not be able to hypothesize, justify, or reason, in general, about having, learning, or using the task. The entity lacks one or more higher-order knowledge about the task-related goals and learning, the task and its uses', and one or more broader impact comprising at least one of: unintended use, unforeseen consequence, misuse in general, and redundancy in general. In an embodiment, where the expert entity triangulates on the sound of a gunshot and tracks the event with time, a need for a previously unknown task may not be overcome by the expert entity. A newly introduced echo of the gunshot may interfere with the entity's learned method of triangulating sounds. Errors introduced by gunshot echoes may make such an entity ineffective in achieving its goals-triangulating and tracking sounds of gunshots. In an example, where the expert entity is not trained on acoustic echoes and their interference in the triangulation of gunshots, without an intervention of an expert actor other than the entity itself, the entity may not overcome the errors.

In an embodiment, for an expert entity, wherein the goals, need, and justification of learning are imparted by an actor or a beneficiary other than the entity itself, supervised and unsupervised learning may comprise at least one of: one or more of learning with or without supervision from new and random scenarios; choosing scenarios and observations of the domain that may increasingly contribute to the entity's expertise; applying knowledge and analysis techniques—that may have been previously regarded as unrelated—to a new scenario that may be well outside the set of scenarios used for the learning of the entity; deriving or inferring higher-order relationships (e.g., relationships of relationships), higher-order rules (e.g., rules of rules), and maps of relationships and rules; and organizing, interpreting, and consolidating the higher-order relationships, the higher-order rules, and the maps of relationships into simpler and fewer facts to reflect the important aspects of the input matrix in line with the entity's goals. As used herein, the term “expertise” or “expert” in one or more aspect related to a domain in general refers broadly to a type of intelligence attained by an entity in that one or more aspect due to acquisition of expert knowledge of that one or more aspect by that entity; wherein the one or more aspect comprises at least one of: skill, task, activity in general, and thing in general. In the embodiment, attaining expertise of a domain may allow the entity to incorporate the map of a whole situation in its working memory—to realize the situation as whole. The ability of an expert entity to accommodate increasing amounts of information in its working memory may be improved by its capabilities comprising at least one of: focusing on higher-order relationships and logical maps as compared to the individual granular facts in an input matrix; assigning different priorities, or weighted attention and resources, to aspects of a situation based on the aspects' influence on and sensitivity to the goals of the entity; assigning reduced or no attention and resources to irrelevant and innocuous facts; and categorizing, consolidating, or dividing the input matrix into chunks that may be regarded as individual facts needing reduced processing and hence lowered attention and resources. As a result of accommodating and processing an increased number of facts in its working memory, an expert entity is more adept than a proficient entity at dealing with the multidimensional nature of an input matrix and domain in general. Typically, real-life domains and their situations may be complex due to their higher dimensionality, requiring an observing domain entity with practical goals to have a threat model with a minimum expert knowledge with related expertise to function effectively. In general, for a given domain aspect, an entity's expert knowledge is superior to its one or more proficient knowledge; the entity's expertise is superior to its one or more proficiency. In an embodiment, an entity's expertise of a domain aspect is supported and supplemented by that entity's one or more other intelligence comprising at least one of: one or more naivety, one or more proficiency, and one or more other expertise. In an embodiment, for an entity responsible for a dog-detection task, the characteristics of naivety, proficiency, and expertise are listed below:
a. Example of naivety: A first naive entity may detect dogs in general in pictures. A second naive entity may detect dog sounds in audio. A third naive entity may distinguish a cartoon picture (e.g., a cartoon depiction of dogs and other animals) from a real-life picture (e.g., a picture of real dogs, or other real animals.)
b. Example of proficiency: A first proficient entity may detect dogs and their breeds in pictures. A second proficient entity may detect dogs and their breeds in soundbites (e.g., audio). A third proficient entity may separate a cartoon picture (e.g., a cartoon depiction of dogs and other animals) from a real-life picture (e.g., a picture of real dogs, or other real animals.), and further identify the object depicted in the cartoon and real-life pictures.
c. Example of expertise: A fourth expert entity detects dogs and dog breeds in different forms of media (e.g., pictures, audio, video, cartoons, etc.) by extending and applying knowledge across domains or across knowledge areas comprising proficiencies of the first, the second, and the third proficient entities; and at least proficiencies in techniques comprising at least one of: detecting concocted pictures meant to fool an entity or an actor, detecting adversarial examples (e.g., ones designed to trick an entity or an actor into making a mistake, or acts of malicious intent in general), and detecting abnormalities—also referred to as novelties and outliers—in the environment or the contexts of a given domain (e.g., observing different medium sources and processing their corresponding input matrices simultaneously, so as to detect inconsistencies of knowledge and information as it relates to that domain).

In an embodiment, an at most expert (e.g., expert, proficient, or naive) first entity may learn or otherwise acquire a first knowledge and its related first intelligence of one or more domain aspect—comprising at least one of: skill, task, activity in general, and thing in general—due to one or more other second entity or one or more other third domain actor imparting one or more need of learning the first knowledge and related one or more specification comprising at least one of: one or more goal, one or more parameters of learning, and one or more accuracy requirements. The first entity or its threat model may not have one or more second knowledge and its related one or more second intelligence comprising at least one of: intelligence about the first intelligence characteristics comprising at least one of: its wholistic need, its wholistic goals, and its wholistic structure in general; in general, the ability to reason about or justify the need for the second entity or third domain actor (not the first entity itself) to impart learning into the first entity; broader impacts; and one or more common sense comprising at least one of: regarding the first knowledge, regarding the first intelligence, and regarding the learning thereof.

In an embodiment, a first expert entity with its first expertise coexists with a second expert entity with its second expertise. Both the entities learn continuously to improve their respective expertise; however, without an intervention from a different third entity or a different third actor, the first entity may not learn the second intelligence or a different third intelligence, and the second entity may not learn the first intelligence or a different fourth intelligence. Both the entities may lack higher-order intelligence comprising at least one of: initiative and autonomy; wherein one or more higher-order intelligence may be needed to autonomously acquire a new skill.

As used herein, the term “wholistic knowledge” of one or more domain aspect—comprising at least one of: skill, task, activity in general, and thing in general,—refers broadly to one or more ability of an entity that may impart the entity with one or more higher-order-intelligence characteristics comprising at least one of: one or more initiative of, among others, different types, degrees, orders, and combinations thereof; one or more autonomy of, among others, different types, degrees, orders, and combinations thereof; and one or more intent of, among others, different types, degrees, orders, and combinations thereof. Due to the higher-order intelligence (supplemented by one or more other reasons comprising at least one of: repeated exposures to diverse new observations from one or more diverse and new domains), the entity may attain one or more attributes of wholistic knowledge comprising at least one of: diversity, depth, and breadth of knowledge; ability to generalize knowledge across domains or generalize in general; ability to forecast and speculate; ability to hypothesize (e.g., form, design experiments regarding, test, verify, validate, and improve one or more hypothesis; and a cycle thereof); ability to hypothesize about, and gain related common sense of, one or more knowledge, intelligence, and learning thereof (e.g., the entity's own knowledge, intelligence, and learning thereof, and one or more related common sense); one or more ability to identify, analyze, and benefit from novelties through one or more of exploration, surprise, and curiosity; self-identification and prioritization of goals; self-learning comprising at least one of: joint learning, co-learning, and interactions (e.g., improvements to a knowledge or an intelligence due to shared observations and experiences with one or more domain actor or observations of such); self-execution comprising at least one of: self-correction, self-diagnosis, self-analysis, self-justification, and anticipation; one or more adaptability comprising at least one of: ability to change goals that may be either implicit or explicit, and ability to change goals to suit domain or environment variations; continuous and ongoing improvements in general; increased efficacy of instincts; behaviors that may be generally regarded as rational; and learning to learn. As used herein, the term “wholistic” in relation to one or more domain aspect in general refers broadly to a type of intelligence attained by an entity in that one or more domain aspect due to acquisition of wholistic knowledge of that one or more domain aspect by that entity, wherein the one or more domain aspect comprises at least one of: skill, task, activity in general, and thing in general. Wholistic intelligence of an entity may allow it to discover, identify, self-learn, need, evolve with, and use one or more intelligent behavior comprising at least one of: exploration, attention, surprise, and curiosity.

In an embodiment, for a wholistic entity to gain one or more of a new at least expert knowledge (e.g., expert knowledge and/or wholistic knowledge) or to attain related one or more of at least expertise (e.g., expertise and/or wholistic intelligence) of one or more domain aspect—comprising at least one of: skill, task, activity in general, and thing in general—an entity may formulate, extrapolate, or otherwise generate one or more probabilistic conclusions using techniques comprising at least one of: one or more of random search; inference; induction; formulating and validating hypotheses, choosing observations for an experiment to prove, disprove, or analyze the hypothesis, and subsequently modifying or reformulating the hypothesis to be consistent with the outcome of the experiment; conducting the hypothesis-proving experiment in real-time (for example, using a continuous stream of a cyclical time series data); pushing the extrapolation exceedingly outside the available data range as one or more hypothesized model of the domain becomes more accurate or otherwise improves, and confidence levels and accuracy of the extrapolated predictions increase (for example, as the one or more expertise of the entity improves, it may explore outside of its own verified, tested, or otherwise known sphere of knowledge); increasing the difficulty of extrapolation by reintegrating the dimensionality of data that may have been previously removed from the input matrix or the threat model (e.g., the removal may have been in general to facilitate assurance of reaching a solution within practical limits of time and resources); optimizing exploration of the domain at the expense of immediate or assured rewards; introducing randomness to the observation and learning samples to achieve one or more improved generalization in predictions; and increasingly reapplying the previous exploratory methods that have proven successful to improve the extrapolation efforts as an aspect of learning to learn. In an embodiment, a wholistic entity observing a domain trained in a task of identifying handguns, triangulating gunshots sounds, and tracking handguns under generic scenarios has achieved one or more expertise in the task. Over a period of operation and with additional learning, exploration, surprise, and curiosity, the entity gains wholistic intelligence at the task by one or more way comprising at least one of: repeated exposure to the domain and generally improving its threat model's performance with extrapolation-task situations. The threat model may gain a new knowledge of echoes happening in the domain, their effect on sound triangulation, and methods to overcome the effects of echoes. Such a threat model is able to compensate for gunshot echoes to triangulate the position of the gun with relative ease, without excess expenditure of resources, and without needing excessive attention to the effects of echoes—that is, the threat model has attained a fine-tuned instinct at overcoming the effects of gunshot echoes.

In an embodiment, a wholistic first entity may be imparted with (e.g., by creators, maintainers, supervisors, or administrators of the entity at the time of creation) one or more first intelligence—wherein the one or more first intelligence excludes a second intelligence—as a base configuration. Due to its wholistic nature, the first intelligence possesses one or more higher-order intelligence (e.g., intelligence of intelligence, intelligence that may represent or otherwise generate new intelligence) that may allow the first entity to identify, evaluate, and acquire the second intelligence in ways comprising at least one of:
A. By observing a second entity that has acquired the second intelligence as a proficiency and is co-located in the first entity's domain. The first entity identifies, evaluates, and acquires the second intelligence by imitating the activities of the second entity. The imitation allows the first entity to reach naivety in the second intelligence; thereafter, after continued observation and imitation, the first entity attains proficiency in the second intelligence. The first entity may thereafter observe, hypothesize, and experiment with the second intelligence, thereby acquiring an expertise in the second intelligence. In this example, the expertise in the second intelligence was not a part of the base configuration of either of the two, the first and the second, entities. In this embodiment of initiative, autonomy, and intent as intelligence, expertise in the second intelligence is a newly created intelligence that may or may not have existed in the domain before, such that the newly created intelligence may be superior to the sum-of-parts involved in and used for creating it.
B. In an embodiment, the second entity is a second actor in the domain. The first entity observes the second actor in place of the second entity as described in example “A” above to attain one or more expertise in the second intelligence.
C. In an embodiment, the first wholistic entity may learn one or more third intelligence from one or more third entity or actor.
D. In an embodiment, the first wholistic entity may generalize the second intelligence and the third intelligence across each other by the way of one or more technique comprising at least one of: hypothesizing and experimenting, wherein a fourth intelligence is generated that is of one or more form comprising at least one of: new, existing, and higher-order.

For a wholistic entity observing a first domain, in an embodiment of initiative, autonomy, and intent, in one or more form comprising at least one of: self-learning, self-improvement, self-diagnosis, learning-to-learn, and meta-learning, the entity is in the process of acquiring a first knowledge and its related first intelligence. The entity, due to one or more surprise and one or more follow up with one or more curiosity, identifies a possibility of the existence of the first knowledge; thereafter, the entity evaluates the first knowledge as of one or more type comprising at least one of: new and a priori; and wherein, as an example of intent, the entity formulates a first hypothesis of the first knowledge with one or more first intent to test and validate the first hypothesis. Thereafter, the entity, with the one or more first intent, searches its own knowledge and the knowledge available to it otherwise through one or more activity comprising at least one of: to identify and formulate one or more need for testing comprising at least one of: metamorphic-relation testing, unit testing, and system testing; to identify and formulate one or more test structure comprising at least one of: test scenario and test criteria—to serve, in general, as one or more test-oracle—for one or more test comprising at least one of: verification, validation, improvement, what-if analysis, and as precursor to one or more other hypothesis; and to identify one or more test success criteria. The entity may further extend and expand the one or more first intent to test and validate one or more other aspects comprising at least one of: the first knowledge, the first intelligence, one or more other related hypothesis, and one or more proposed test setup and system. Thereafter, the first entity follows one or more cycle comprising at least one of: static testing, unit testing, continues testing, static validation, continuous validation, and continuous hypothesis updating; wherein, it may use one or more technique comprising surprise and curiosity, to seek diverse new observations and test samples; and wherein the one or more cycle may adopt and improve the first intelligence and the related first knowledge from the one or more hypothesis to achieve one or more naivety (e.g., iteratively develop the one or more hypothesis into one or more naive knowledge), thereafter, achieving one or more proficiency; and thereafter, achieving one or more expertise. Thereafter, the entity through activity comprising at least one of: further learning and further experience from diverse one or more domain, may achieve improvement of the first knowledge from the one or more expert knowledge to one or more wholistic knowledge.

In an embodiment, a threat model of an entity is observing a hospital environment as its domain; the threat model's goals are ensuring wellbeing of patients and other hospital habitants and attaining efficiencies in the operation of the hospital; the threat model is operating at a wholistic level. In a ward of the hospital, the threat model identifies—due to exploration, curiosity, attention, and surprise—an anomaly in a set of patients' symptoms as they are spreading. Early symptoms are mild, and go unnoticed by the healthcare staff; the threat model explores the possibility of an unknown disease; follows movements and activities of the related individuals to track the suspected transmission of the disease; and narrows down the possible ways of transmission. As the first of the infected patients indicates worsened symptoms that are unrelated to known or previously diagnosed causes—an embodiment of surprise and curiosity—the threat model dedicates more attention and other resources to the containment, identification, and cure for the disease; notifies authorities and initiates a quarantine of the hospital ward; and presents a timeline, other aggregated information, and the suspicion of the infectious disease to healthcare professionals for further decision-making and actions. The disease is caused by a newly mutated and unknown infectious strain. Though the threat model has not learned about the mutations of strains causing new symptoms, it arrives at a useful and practical conclusion that is effective towards the management and mitigation of the disease. The intelligence that emerged from the activities of the threat model was previously unknown to the threat model; also, the threat model learns from this experience the possibility that new diseases and symptoms can erupt without notice; and though they are few and far between, early detection and mitigation of such new diseases is necessary to achieve its goals. The new knowledge is quite different from the learned prior knowledge of the threat model, and the threat model required wholistic intelligence to arrive at the previously unknown knowledge.

In an embodiment for wholistic intelligence, the entity that identified a new disease interacts with health professionals and learns that the new disease was caused by a newly mutated strain with an unknown transmission mechanism. Having learned about mutating strains and gaining related proficiency, the threat model—as an example of attention and self-learning—reanalyzes the sequence of events; it narrows down the modes of transmission to bodily-fluid based, through touch or through aerosol (e.g., airborne fine liquid droplets) based transfer; and proposes changes to the ongoing quarantine and containment techniques. The threat model further identifies three patients as an anomaly in that they did not exhibit symptoms despite their high propensity to the disease due to their repeated exposures, their other ailments, and their physical conditions. The threat model identifies one or more similarity between them separating them from other infected patients-only they were administered a certain drug. The threat model concludes the drug is a potential counteractive to the disease, and notifies the related healthcare professionals. Thus wholistic intelligence may result in knowledge that may not be closely associated with the threat model's learned prior knowledge and may be a newly revealed (e.g., previously unknown or undiscovered) knowledge or skill. The newly revealed knowledge or skill may add to an existing areas of intelligence of the threat model, or it may belong to a new area of intelligence. The threat model may enhance the efficacy of the newly revealed knowledge or skill by sharing it with other entities and domain beneficiaries.

In an embodiment of wholistic intelligence where a threat model of an entity is monitoring an offshore natural gas production platform (or rig), the threat model has improving safety, efficiency, and productivity as goals. The threat model is independently trained and has attained at least expertise in several activities; two of the activities include monitoring the gas production and helping to manage human activity and scheduling. The rig has operated safely, within parameters, and without incidents in the past. There are two engineers—experts at identifying, diagnosing, and countering blowout accidents in the unlikely scenario that the blowout preventer does not perform as designed. The engineers have performed within parameters during past drills of simulated abnormal situations (e.g., accidents). A third engineer with less experience exhibited slower response times and indecision when faced with similar drills. The threat model—due to and as an example of exploration, attention, and curiosity—identifies overlapping timelines of three independently innocuous events, which on their own are not considered noteworthy: a. The regularly scheduled time for a safety drill and a maintenance of the blowout preventer and its well-head is delayed by three weeks; b. The two expert engineers have prescheduled overlapping times off during one of the weeks before the drill and the maintenance—the less experienced engineer is in charge during that week; and c. for the past few days, undesirable fluctuations have been noted in the production of gas and associated liquids (e.g., changes in temperature, pressure, flow-rate, etc.). Though undesirable fluctuations were capably mitigated before by the two expert engineers, the third engineer showed slower response times and indecisiveness during those incidents. All the three activities are projected by the threat model to overlap during the one week, causing increased level of risk for the rig and the threat model's goals in general, and in an illustration of surprise, the threat model issues a cautionary note to authorities of the heightened risk.

In an embodiment, wholistic intelligence of an entity observing a domain may overcome gaps in information or incompleteness of an input matrix through coordinated application of its expertise in different fields supplemented by one or more higher-order intelligence comprising at least one of: exploration, curiosity, surprise, attention, self-learning, and hypothesizing. The gaps in information may be due to obstruction in observation or input measurement by one or more factor comprising at least one of: an event beyond the control of the entity, reduced sensitivity or resolution of the input measurement capability of the entity, lack of available resources, and operational failures in general (e.g., resulting from wear and tear, manufacturing defects, bugs, or accidents). The wholistic intelligence may impart in the entity with one or more capability comprising at least one of: self-correcting; self-diagnosing; self-healing; fault-tolerating; anticipating to minimize adversities; counteracting malicious activities and intent of one or more actor in or out of the domain (e.g., intentional or unintentional sabotage, interruptions, and disruptions); retreating, regrouping, assessing, cutting-losses, and sacrificing to achieve goals; and exercising agency over the domain as a rational actor in general. In an embodiment, an entity observing a domain trained in the task of identifying handguns, triangulating gunshots sounds, and tracking handguns under generic scenarios has achieved expertise in the task. In addition, as a result of the entity's further learning and expertise in other diverse tasks, it has reached capability of wholistic intelligence. An individual with the intention of wielding and firing a handgun knowingly disrupts the primary vision capability of the entity (e.g., either by blocking one or more video camera or otherwise disabling them). The entity has not experienced an unplanned, coordinated, and intentional disruption of its video input before; however due to attention, curiosity, and surprise, it recognizes the low probability of such an incident and investigates further. In an example of self-identification of a new goal, self-learning, attention, curiosity, and surprise, the entity recognizes that the attempt to block its vision may be intentional and malicious. The entity notifies authorities of the disruption attempt; notifies and solicits observation input from other entities, potentially attracting their vison towards the area of interest; and focuses its own attention on the input variables that are available to it (e.g., audio of the situation). The anticipation, forecasting, and planning of the entity for a potential incident may be beyond the capability of a single area of its expertise; however, by coordinating different expertise simultaneously, the entity may be able to find an optimal solution to a problem that may not have any historic similarity or historic frame of reference.

In an embodiment, naivety and proficiency may lack common sense—typically, due to lack of depth and diversity of prior experience—as compared to wholistic intelligence. As part of the embodiment, and not by way of limitation, the following are examples of naivety, proficiency, expertise, and wholistic intelligence:
a. A naivety example: An AIE, having undergone a first learning of—as a first skill—detection of dogs in pictures, identifies dog pictures with a reasonable confidence level; wherein it does not differentiate between pictures of real dogs and cartoon dogs (e.g., cartoon depictions of dogs); wherein its first learning is limited to a first domain of dog picture samples; and wherein the AIE attains naive knowledge or naivety in the first skill of dog detection in pictures.
b. A proficiency example: Thereafter, the AIE may undergo a second learning of one or more second skill comprising at least one of: to differentiate between pictures of real dogs versus cartoon dogs; to differentiate between pictures of different dog breeds; and to assign reasonable confidence levels to its predictions; wherein the AIE maintains or improves confidence levels of detections; wherein its second learning extends its domain exposure from the first domain to a second domain comprising pictures and corresponding labels of different dog breeds and cartoon dogs; wherein the AIE may not differentiate between a typical picture of a whole dog from that of a dog picture concocted by parts of other pictures of different types of dogs (e.g., a concocted picture of dog created by joining a picture of a front part of a real dog to that of a rear part of a cartoon dog); wherein the AIE extends its knowledge to proficient knowledge and attains proficiency in the first skill (of dog detection in pictures); and wherein the second skill may be deemed equivalent to a proficiency in the first skill.
c. An expertise example: The AIE may undergo one or more third learning of one or more third skill comprising at least one of: at least proficiency in detecting pictures that are original versus concocted; at least proficiency in detecting other objects and objects in general in a picture; at least proficiency on reasoning comprising in detecting pictures that are original versus concocted; at least proficiency in extending and applying knowledge across domains or across knowledge areas; at least proficiency in online learning (e.g., incorporating external feedback of right or wrong during its operation, e.g., at the time of prediction, into its threat model); at least proficiency in learning from sparse examples or sparse samples; at least proficiency in one or more skill in other domains that may not be directly related to the first and second skills; and at least proficiency in using attention to learn one or more skill; wherein the AIE may undergo the third learning, chronologically, either before or after attaining the first skill or the second skill (e.g., in a first case, an otherwise expert AIE may learn naivety in the first skill; in a second case, an otherwise expert AIE it may learn proficiency in the first skill if it already has the first skill at naivety; and in a third case, an AIE proficient in the first skill, which is equivalent to having the second skill, may learn skills needed to attain expertise in the second skill); wherein the AIE maintains or improves confidence levels of detections related to the second skill; wherein its third learning extends its domain exposure to a multitude of diverse other domains from the first domain and the second domain; wherein the AIE may differentiate between a typical picture of a dog and other unlikely, impractical, or unusable variations (e.g. the concocted pictures); wherein due to repeated learning and repeated exposures related to one or more dog-detection skill, the AIE attains expertise in the second skill of dog detection in pictures; wherein the third skill may be deemed equivalent to the expertize in the second skill; wherein a need or a goal of a dog-detection (in pictures) skill is imparted in the AIE and its threat model by an actor or a domain beneficiary other than the AIE itself; the AIE and its threat model may not be able to hypothesize, justify, or reason, in general, about having, learning, or using the dog-detection skill; and wherein the AIE and its threat model may lack one or more common sense—related to the dog-detection skill—about the skill related goals and learning, the skill and its uses' one or more broader impact comprising at least one of: unintended use, unforeseen consequence, misuse in general, and redundancy in general. In an embodiment, the AIE has not learned, experienced, or otherwise known a thylacine; upon observing a thylacine picture, the AIE predicts that it is a picture of a dog with reasonable confidence, while ignoring thylacine stripes.
d. Wholistic intelligence example: A second AIE, with its threat model, that has attained wholistic intelligence has higher-order intelligence capabilities, among others; wherein the second AIE has attained wholistic intelligence in the skill of detecting dogs in pictures due to its own initiative, autonomy, and intent. The second AIE has not learned, experienced, or otherwise known a thylacine. Upon observing a thylacine picture—a first event—the AIE predicts (e.g., in response to an external or a self-hypothesized query) that it is a dog-like animal (or similar to a dog), but due to the thylacine's stripes—in an embodiment of metamorphic relation that “Dogs don't have stripes.” and the relation's testing and verification—may not be a dog, and that the first event is an anomaly. The anomaly, with its one or more surprise, induces the second AIE to—as an embodiment of curiosity—investigate further with one or more step comprising at least one of: hypothesizing and confirming that the picture is real (e.g., not concocted) and in general the animal, background, and context in the picture are consistent and real; hypothesizing and rejecting—in an embodiment of knowledge generalization—that the animal is a tiger, dog, and other known four-legged animal; hypothesizing and confirming—in an embodiment of autonomy—the relevance, need, and, in general, broader impact of the query or task related to the first event; generating, in a first risk profile, a for-and-against first reasoning with associated confidence levels that the dog-like animal in the picture is or is not a dog; providing to and soliciting from a possible expert entity or expert domain actor, opinions on the first reasoning and the picture; incorporating responses to one or more such solicitation in the threat model and generating a second risk profile; seeking one or more relevant knowledge from unexplored domains, incorporating that into the threat model, and generating a third risk profile; confirming and validating the findings in general with test structures; continuing the steps in one or more way comprising at least one of: synchronous and asynchronous; and stopping the search and investigation of the query if a success or termination criteria of the relevant test structure is met. A resolution recommendation generated by the threat model from the first event may have a rich set of knowledge of thylacine with related one or more recommendation messages (RM) comprising: “The picture is of a dog-like animal—a thylacine—but not of a dog”; “The picture may have been taken over 80 years ago considering the quality, resolution, and texture of the picture, and that thylacines have been deemed extinct for that duration”; “The picture is real and there is no attempt at manipulation or concoction”; “Broader impact: The existing threat from thylacines is non-existent. Threat to thylacines as a species is inconsequential”. The recommendation messages generated by the second entity are embodiments of reasoning and providing justification. The second entity's self-initiated learning and attaining a new skill of identifying thylacines in pictures is an embodiment of autonomy in general. A system and method of this wholistic intelligence example illustrates the wholistic second entity's common sense, one or more way of generating common sense, enhancing common sense, and using common sense, among others.

An instinct of an entity observing a domain may be categorized as:
a. A reflexive instinct or a reflex instinct: An action of one or more type comprising at least one of: predictable, almost instantaneous, consistent, and preliminary, taken by an entity in response to a given input observation matrix; wherein the action is derived from one or more intelligence comprising at least one of: learned and preprogrammed; and wherein a duration of the action and a duration the action's generation by the entity are so short that the action and its generation are paid little or no attention by the entity. For example, an AIE with audio-video input capability, upon hearing a gunshot, may immediately (e.g., in a quick action that may not be deliberate, or otherwise not appear deliberate) turn its video camera lens towards the direction of the gunshot and send an alert message—of one or more type comprising at least one of: high priority, high urgency, and high fidelity—that the gunshot was heard to one or more other AIE, other domain actor, its own or other SIC, and combinations thereof. Due to their short-duration nature, reflex instincts may be mostly lower-order representations or lower-order logical actions.
b. An attentive instinct or an instinct accompanied by heightened attention: A predetermined focused initiative of an entity that may be accompanied by consequential domain variations and requires increased attention from the entity in its pursuit of the focused initiative or attentive instinct; wherein, the action is derived from one or more intelligence comprising at least one of: learned and preprogrammed. For example, an entity dedicated to following suspects, as an attentive instinct activity, may follow a suspect with increased attention and may support the instinct activity with new analysis or strategies (e.g., in one or more focused actions that may be deliberate); the entity may ignore other unrelated domain activity (e.g., a road accident or a car fire) over the attentive instinct activity (e.g., identify, track, and follow the suspect, his interactions, and his intent). An attentive instinct may typically have a long duration and a need for focused attention on one or more activity comprising at least one of: certain domain observations, communication with other entities or systems, and making complex decisions. In another example, by way of analogy, not by way of limitation, a bird is building a nest in time to lay its eggs; the bird may assign most of its attention to the nest-building activity until the activity is complete.
c. A fine-tuned instinct (e.g., an instinct needing little or no attention for an otherwise deliberate—typically complex—action): A fine-tuned instinct, as it relates to a first expertise, is a first action that may be predictable, well known, generally high-confidence, deliberate, and one or more simplification of one or more second action—related to one or more second expertise, and generally complex and deliberate—such that: the first action may require little (e.g., substantially less) or no attention, less time, less deliberation, and generally less resources than that for the one or more second action; the first action and the second action may have one or more essential functional similarity comprising at least one of: input and output matrices, domain, goal or purpose in general, and environment or surroundings in general; the one or more simplification of the one or more second action into the first action by one or more first entity in a first domain may essentially obsolete the one or more second action for the first entity in the first domain; as a first case, one or more second entity may learn the one or more second action, and thereafter due to one or more learning and one or more experience, attain the first expertise related to the first action. As a second case, for one or more third entity, the first intelligence may be attained in one or more way comprising at least one of: otherwise learned, otherwise experienced, imparted by one or more other actor, and preprogrammed; and, for the most cases, one or more fourth entity that has learned the first action may be at least an expert (e.g., an expert or a wholistic entity). In an embodiment, for an experienced and expert entity that has attained a fine-tuned instinct (e.g., a simplified version) of an underlying action, the fine-tuned instinct may be executed in a relatively shorter time, with relatively reduced one or more resources comprising at least one of: attention, deliberation, compute, and memory, as compared to an execution of (e.g., a complex version of) the underlying action by other comparable but less experienced entities that have not achieved the fine-tuned instinct.

In an embodiment, an at least expert entity and its threat model may be a result of a first learning by the entity of one or more higher-order aspect comprising at least one of: higher-order logic, higher-order knowledge representations, and higher-order relationships (e.g., relationships of relationships); thereafter, with a second learning by the entity-comprising at least one of: goal-directed learning, exploratory learning, hypothesizing, simulated learning from historic information or information generated by other entities, expert learning in general, and wholistic learning in general—the entity may formulate shortcuts or simplified expert-level representations of the higher-order aspect. For that entity, its second learning imparts further ease in executing the one or more higher-order aspect by transforming them into the shortcuts (or the simplified expert-level representations of the higher-order aspect) and related or one or more fine-tuned instinct; the ease in execution may cause reduced need of one or more resource comprising at least one of: attention, energy, and time. For the expert entity, the shortcuts (or the simplified expert-level representations of the higher-order aspect) and related one or more fine-tuned instinct may be formed, derived, or simplified from all other available actions and knowledge comprising at least one of: other shortcuts, lower-order representations, higher-order representations, lower-order-logical actions, and higher-order logical actions. For example, an entity in a department store may observe that a newly arriving customer opens and walks through a front door with a shopping bag and what resembles a store receipt in her hand; she is generally looking around. The entity, without need for extensive analysis, deliberation, or elaborate predictions, executes an instinct to ask the customer whether she needs directions to the store's returns counter. Besides being a fine-tuned instinct, this may also be an example of a reflex instinct if the entity acted in a short enough time. In another embodiment, fine-tuned instincts may control high-frequency routine actions; e.g., an AIE may act in one or more regular cycle comprising at least one of: internal self-maintenance, resource-level checks, and sensor calibrations.

For a threat model of an entity observing a domain, an instinct for a given scenario may be represented by one or more of the three categories of instinct (reflexive, attentive, and fine-tuned instincts). Some other scenarios may use variable attention throughout the resolution of a scenario, attention as a resource may be actively optimized, or the threat model may not be able to make a decision on the extent of attention needed before the resolution; these are referred to as non-instinct actions. A given scenario may require one, more, or a combination of the three instinct types and the non-instinct type actions to successfully resolve a risk profile or to act on resolution recommendations.

In an embodiment, a threat model of an entity observing a domain may use methodologies—comprising at least one of: optimization, trial and error, and metaheuristics—to identify an ideal solution to reaching and advancing its goals for a given scenario or an input observation matrix. The ideal solution for the given threat scenario may be a practical solution that the threat model may deem itself capable of executing under the given circumstances; as opposed to, for example, the best mathematical solution to a given scenario; an otherwise better solution that the threat model deems improbable to result in adequate threat resolution; or a solution that may—despite its eventual success—result in undesirable outcomes comprising at least one of: unacceptable resource expenditures, and damages. The threat model may identify an ideal solution, regardless of whether a unique best solution to the scenario may or may not exist, or whether reaching the best solution may or may not be practical for the entity's capabilities; e.g., the entity may not have sufficient resources, time, or knowhow. Moreover, with frequent exposure to the scenario or others like it, an instinctive response—comprising at least one of: reactive or reflexive actions, automatic responses, and predisposed behaviors on the short or long timescales—may be borne out of the need to find an ideal solution that may not necessarily be the best solution. During the frequent exposures, the threat model may continually seek and learn the ideal solution by reconciling an observed input with its output risk profile and resolution recommendations.

For a given scenario, an ideal solution for a threat model of an entity may be a reflex instinct solution to overcome a risk profile with a high-impact and imminent loss situation that may require a relatively quick response in order for the threat model to advance its goals; there may not be enough observational data available, or even if it is available, the entity may lack the ability to process it in a short-enough time. The risk profile is temporal in nature. The need to arrive at a solution in the short-enough time is identified early in time in the risk profile and threat resolution. Recognizing the short-enough time may be inadequate to arrive at the best solution, the threat model may instead focus its attention on an ideal solution that may be evaluated in the short-enough time. Frequent exposure to the scenario or others like it may result in a reflex instinct action. Such an instinctive action performed by the entity in the short-enough time is akin to a predisposed, reactive, automatic, or reflex reaction.

In an embodiment, benefits and need for the instinctive approach to a solution are greatly enhanced when an AIE is a member of a SIC (swarm intelligence collective). As an individual separate from the SIC, the AIE may not be able to advance its goal as far, as compared to when it is a member of the SIC. The collective (the SIC) may use one or more technique comprising at least one of: safety in numbers; long distance inter-member communication; social or dominance hierarchy; presenting a direct or indirect threat to an adversary as the collective; and taking turns between lookout and recharging (wherein the recharging may happen during one or more period comprising at least one of: downtime, maintenance, and energy reserve replenishment). As a member of the collective for a given threat scenario, the AIE's threat model seeks observations read by the collective along with its own observations of the scenario and performs actions to contribute to the collective's and its beneficiaries' goals. The AIE—which typically may not have the capability to satisfactorily resolve the threat individually—may or may not have a complete observation or analysis of the scenario to which the collective as a whole is responding, but the AIE may compensate through enhanced instinctual abilities to respond to the scenario. A collective of entities gives rise to a collective intelligence—swarm intelligence or wisdom of crowds—that is superior to an individual intelligence in the collective; an individual of the collective is better able to advance its goal in the collective as opposed to on its own.

In an embodiment, a threat model of an entity observing a domain may be provisioned, encoded, or preprogrammed to ensure a certain minimum required knowhow, expertise, and behavior of the threat model deemed necessary for its field use—referred to as a base configuration. The provisioning may happen on occasions comprising at least one of: before field use, during down-time, and during field use—e.g., as part of operational steps, as online or real-time maintenance, or as offline maintenance. The base configuration may maintain the threat model to one or more of certain minimum levels comprising at least one of: levels of efficacy, efficiency, design, and compliance. The threat model may improve itself, gain additional expertise, and fine-tune its expertise over the base configuration using one or more technique comprising at least one of: experience acquisition and collaboration. The gaining of experience and fine tuning enables the threat model with operational ease of use, ease of finding facts and discovering relationships in input observation matrices, and fluency of operation in general.

In an embodiment, a base configuration may be a hardcoded instinct. The hardcoded instinct may be an initiative or an observation response that is preprogrammed immutably or hardwired in an entity, typically from its inception. Such an entity may be predisposed to the hardcoded behavior for a pertinent initiative or observation input matrix. A hardcoded instinct may be different from a learned model in that it may be immutable to newly acquired observations and experiences of the entity's domain. A hardcoded instinct may encode one or more instruction—comprising at least one of: certain goals, certain goal priorities, and policy directives—into the threat model of an entity. The threat model may follow the one or more instruction regardless of counter-indicative, competing, or conflicting ongoing observations of the domain. The threat model's risk profiles and threat resolutions as well as the threat-model induced actions—direct or indirect—over the domain may reflect the hardcoded instinct. For the general operation of the threat model that otherwise does not conflict with the hardcoded instinct, the threat model may function as any other threat model. A hardcoded instinct in a threat model may introduce certainty in the threat model's behaviors that may be needed for one or more reason comprising at least one of: legal, jurisdictional, ethical, end-user desired, as countermeasures against undesirable behaviors, mitigation of contingencies, temporary or permanent bug fixes, efficiency, and general efficacy.

In an embodiment, a first AIE with audio-video sensory capability, upon hearing a gunshot, may exhibit a reflex instinct in immediately turning its video camera lens towards the direction of the gunshot. It may also send an alert message to one or more other AIE—with or without the ability to hear the gunshot—regarding the gunshot sound, inducing a similar reflex instinct in those other AIE. This reflex instinct behavior may be incorporated within the first AIE and the other AIE as a hardcoded instinct. The hardcoded instinct may not only include a reflexive instinct to turn the cameras towards gunshots, but also the sending, receiving, and acknowledging of the alert messages among the related AIE.

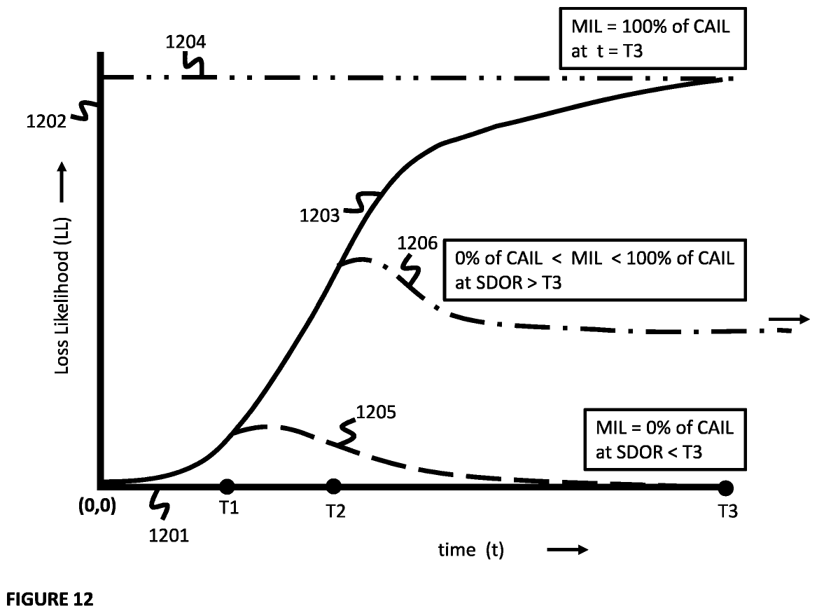

In an embodiment, a more experienced, more advanced, more skilled, and expert threat model of an entity observing a domain may generate a risk profile and a threat resolution that may induce actions which are better at mitigating a risk from a given scenario as compared to actions induced by a risk profile and a threat resolution of an otherwise comparable, but less experienced threat model. The experienced threat model may be able to extract more relevant and accurate information in a shorter time from the given scenario to generate a better risk profile and threat resolution towards its goals. In an embodiment, as seen in FIG. 4, a threat model, well trained in a task of identifying guns as they come in the view, may not perceive that there may be a possibility 403 of a gun, and threat 403 as a consequence of the possibility of the gun. The threat model may register heightened risk only after a gun is clearly seen and identified. However, as the threat model comes across more situations—or gains more experience to become an expert at the task—similar to the one embodied in FIG. 4, in the process of learning from the observed losses in the situations, it may extract a pattern or information from the knowledge (or information) structures of the scene—knowledge structures comprising at least one of: spatial, temporal, behavioral, and social—that indicate a possibility of a hidden gun significantly early in the timeline of the event. The possibility of the gun also leads to an updated risk profile as well as a proposed actionable threat resolution that much earlier in time. As will be described with a plot in FIG. 12, early identification of threats may give an entity observing a domain better control over the threat situation with a contained MIL (minimum inevitable loss) and a contained actual materialized loss.

In an embodiment of expert knowledge structures as seen in FIG. 3, where suspect 303 is potentially hiding object 302 under his trench coat 301, there may not be a clear appearance of a gun or any other weapon; but the possibility of a weapon and its threat may not be ruled out. An entity's threat model observing a domain comprising suspect 303 and object 302—due to the entity's related expertise—may recognize the intent of suspect 303 in hiding an object as a reason to sense a threat in the situation, generating a heightened risk profile accompanied with threat resolutions. The heightened risk may indicate a need for greater attention towards suspect 303 from the entity. The threat resolutions may comprise: indicating to the authorities the need for heightened attention on the situation; initiating other investigative actions on the suspect 303, e.g. searching for the identity of the suspect; and indicating the need to review archives to identify similar actions, situations, or any relevance of suspect 303 to his current location.

In an embodiment, for an entity observing a domain, acquiring of experience by its threat model may be understood as fine tuning its abilities with respect to new domain observations; steps involved in fine tuning may comprise:
a. to identify observable facts comprising at least one of: pertinent logical constructs, input signals, and interaction of variables in an observation input matrix; and to formulate a meaningful knowledge structure from the relevant facts so as to address the newness—e.g., deviations from expectation—of input observations;
b. thereafter, to focus on or intensify focus on relevant facts or variables and attenuate all others to construct, improve upon, or use an efficient and effective input observation matrix as an aspect of the knowledge structure (this action may also be viewed as giving attention to certain important aspects and discarding the unimportant facts);
c. thereafter, to generate an output or knowledge structure by applying the threat model to a given input observation matrix;
d. thereafter, to reconcile the generated knowledge structure with the observed results and intended goals to identify shortcomings of the threat model—e.g. to evaluate errors in the threat model;
e. thereafter, to update the threat model to minimize the shortcomings or errors; and
f. thereafter, to repeat steps beginning with step [0085].a until the shortcomings and errors reduce to a desired level, or until the efficacy of the threat model improves to a desired level.

In an embodiment, for a given sample set of domain scenarios, a threat model for an entity acquiring experience may reach a minimum error condition with a given state of the threat model and a corresponding input observation matrix structure; the threat model may reach a proven attention pattern with respect to the domain scenarios to reach a fine-tuned operational state in attaining the goals of the entity and the domain beneficiaries. A marginal change in an input observation matrix may have insignificant changes to the error; however, a slight variation in the fine-tuned threat model state and the corresponding structure of the input observation matrix may result in increased error. This fine-tuned state of the threat model may be referred to as a minimum-error state or a minimum. Optimization techniques to achieve a minimum for a threat model undergoing learning are based on one or more factor comprising at least one of: available compute, wall time needed for the optimization, expected shape of the error curve or hypersurface, the need for the threat model to communicate with other entities (e.g., as a requirement for the learning) in the domain or other members of the SIC, and available bandwidth.

For an entity observing a domain, its threat model may reach a minimum-error state for a given set of input-output matrix combinations corresponding to a set of domain scenarios. However, for the threat model, on its error curve or hypersurface, in that domain, there may be more than one minima, where only one may be a global minimum with others being local minima. Choice of optimization technique and initial conditions—among others—may influence the possibility, practicality, and speed (e.g., rate of change of error with respect to time) of the threat model reaching a minimum and its type—local or the global minimum. The threat model error may be further reduced when the resources, wall-time, and need for inter-entity communication—among other constraints—permit by changing the optimization techniques to ones comprising at least one of: genetic algorithms, simulated annealing, and others that introduce randomness or in general high entropy. The change in optimization technique may be accompanied by changes to data input types comprising at least one of: real-time, replay of historic events and their results, forecasts, and analysis of what-if scenarios.

In an embodiment, the steps [0085].a through [0085].f may improve the accuracy of a threat model to a certain level; however, further gains in accuracy may be impractical and a marginal reward (e.g., further reduction in error) for attention and other resources may diminish. The threat model may have reached a local minimum but not the possible global minimum. Such a threat model further grows its scope of expertise to achieve fluency in operation—to reach another lower local minimum or the global minimum—through expert learning comprising at least one of: higher-order representation, higher-order relations and maps, higher-order logic, intangible properties, and consolidation of two or more other knowledge (e.g., detection, analysis, and learning) steps into a seamless and fluent desired expert knowledge (e.g., detection, analysis, and learning) step. This expert learning may impart in the threat model the ability to review and analyze larger and interdependent sets of input variables and scenarios together as one knowledge structure and further improve the threat model in a manner that may not be otherwise possible by reviewing scenarios independently. Expert learning may be done online, during regular operations, during downtime or maintenance, or through combinations thereof. In some cases, expert learning may be time or resource intensive and may require external guidance for one or more reason comprising at least one of: to propose learning steps, to propose starting structures or values, to resolve conflicts, and to rectify race conditions. Examples of the steps for expert learning may comprise:
a. To explore and replay—or undergo iterative practice sessions of—prior or historical scenarios, forecasted scenarios in their original or perturbed forms (e.g., what-if scenarios) or combinations thereof.
b. Thereafter, to form unified sets of scenarios—from the scenarios conventionally and historically regarded as disparate and independent—to review and analyze the sets as a single input matrix so as to maintain the interdependence between scenarios and their variables, e.g., by increasing the dimensionality of the input matrix, so that two otherwise different scenarios may use the same input matrix.
c. Thereafter, to reconcile the observed losses and risk profile with the estimated ones, so as to identify new discerning facts across one or more input matrix variable—to improve one or more quality comprising at least one of: sensitivity, differentiation, accuracy, and efficiency—as logical structures.
d. Thereafter, to incorporate the newly identified structures and relations (in the threat model), which then may be further improved using other learning techniques that may improve the probability of achieving the global minimum on the threat model error curve or hypersurface.

Experience and expertise of a threat model of an entity may increase with the number of repetition cycles or time spent on gaining experience, and one or more other factor comprising at least one of: diversity, resolution, and sensitivity of sensory inputs; diversity and extent of the base configuration that the threat model started out with; capability and extent of available resources (comprising at least one of: compute, storage, memory, networking, and energy); diversity of input scenarios; and extent of reference material available to enhance and validate the higher knowledge learning steps. The increased experience and expertise may improve the threat model's operational capabilities comprising at least one of: accuracy, sensitivity, discrimination, and ease and increased speed of arriving at a risk profile or threat resolution. At its peak, all other variables being the same, the increase in experience and expertise may result in a threat model with a fine-tuned instinct for a given set of domain scenarios. If a threat model achieves one or more expertise in several different independent areas of knowledge, with continued exposure to rich and challenging operational environments, the threat model may begin to discover or realize previously unknown knowledge structures and higher order knowledge—it may begin to learn wholistic intelligence.

In an embodiment, for a given domain scenario, a threat model may estimate that no practically viable solution exists due to one or more of reason comprising at least one of: inadequate knowledge, inadequate expertise, lack or resources, lack of time, and lack of available methodologies. The threat model may engage in alternate knowledge representations and experimental (e.g., regarded as having low probability of success) approaches—generally to identify telltale signs of a possible solution—that may comprise previously unknown representations of the input matrix or the knowledge structure; breaking down the input matrix or knowledge structure into portions that may be analyzed with increased attention and other available resources; including in its operation input matrix variables or parts of the knowledge structure that were originally regarded as less effective, less efficient, or unlikely to bring about a solution; communicating with other entities, devices, and systems to recruit for expertise, insight, information, solutions, or help in general; exercising higher-order search algorithms; and transfer learning or using models of AI trained for other purposes. If one or more of the low likelihood experimental approach shows signs of a possible solution, the threat model may reprioritize its attention away from the other experimental approaches to the approaches that showed signs of a solution. The threat model then may resume its approach of using known representations and approaches, and may no longer pursue experimental approaches. An experimental approach—as an embodiment of curiosity and self-learning—is one way for a threat model to gain experience and enhance its expertise at one or more occasions comprising at least one of: during operation, during learning, during self-diagnosis, during exploration, during addressing curiosity, and during idle times (in general to use spare resources); the threat model may apply the experimental approach to one or more domain scenario comprising at least one of: ones without an existing practical solution, ones where efficacy gains—as per the historic or existing knowledge base—may not be further improved with other techniques, and previously unknown scenarios that are encountered as a result of exploration.

In an embodiment, a first entity (e.g., a first AIE or a first SIC) observing a domain may be replicated, copied, or combined with other AI or a second entity to generate a third new entity in one or more configuration comprising at least one of: combining one, more, or part of a first entity with one, more, or part of another AI or one, more, or a part of a second entity creating a third entity that may be a new entity or new versions of the first entity or the second entity; and adding to or removing from one, more, or a part of the second entity one, more, or a part of the first entity creating the third entity that may be a new entity or new versions of the first entity or the second entity. Examples of configuration comprise at least one of: creating a new SIC with one or more new AIE and their versions; adding or removing a new AIE from an existing SIC; creating a new SIC with a mix of existing and new one or more AIE or SIC; and creating a new AIE or a new SIC that is modified, augmented, or otherwise combined with other AI. The new AIE or SIC may be for observation of the same domain, a new domain, or any combination of one or more domain. Reasons for creation, augmentation, depletion, deletion, and modification in general of an AIE or a SIC comprise at least one of: performance gains; efficacy improvements; increasing, decreasing, modifying, or otherwise altering the scope of intended activities; generally, to create, recreate, or mass produce systems of AIE or SIC; and productivity gains. Modification techniques to improve efficiency, efficacy, and performance in general comprise at least one of: genetic techniques and algorithms (e.g., such techniques used over different expert AIE or SIC from the same or different domains); and one or more activity among entities (e.g., expert entities), wherein the one or more activity comprises at least one of: competition, collaboration, co-learning, and communication (e.g., to challenge, to share, and to gain new and diverse experiences from one another).

In an embodiment, an entity capable of observing one or more domain that may or may not have a base configuration at its inception is trained or learned in a stepwise or other structured fashion; the training or learning may be divided into steps or lessons for one or more reason comprising at least one of: effectiveness, efficiency, efficacy, productivity gains, mass production, trial-and-error, and experimentation to derive new expertise. For example, for such a new entity, learning lessons may be made progressively more difficult, with initial simpler lessons with or without a follow up verification testing for a desired mastery or expertise, followed by more difficult or advanced lessons that build on top of the already gained expertise, also with or without the verification testing for a desired mastery or expertise.

In an embodiment, a wholistic entity observing a domain may gain incremental expertise, wholistic intelligence, or generalized skills in general across one or more area—comprising at least one of: domains, activities, and actions—by interactions, co-learning, or joint learning with one or more other entity; this is referred to as assembly learning, where entities or their teams may form an assembly. The interactions, co-learning, or joint learning may comprise at least one of: joint problem solving; joint analysis; joint training and collaboration in general, and individual or group competitions with teams that are formed beforehand (e.g., externally assigned teams, dynamically self-assigned teams, and intra-conference-negotiated teams). The teams may also change or adjust dynamically during an assembly learning session. The reasons behind the creation of teams and team structure comprise at least one of: cross-pollination of skills, cross-pollination of—typically higher-order—ideas, desired group dynamics, and randomness in general. In another embodiment, assembly learning may be used to resolve generally difficult domain scenarios comprising at least one of: complex, intractable, never-before seen by one or many members of the assembly, and ones needing multi-entity interactions.

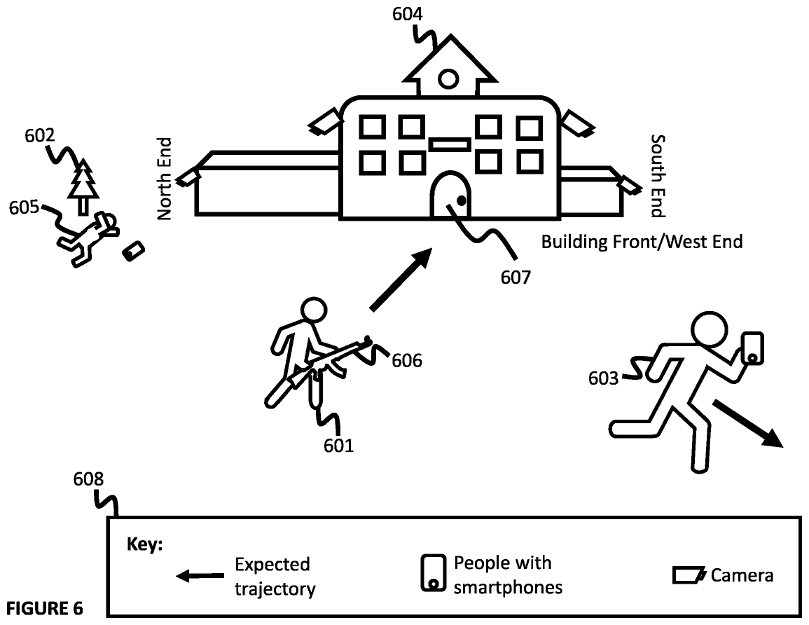

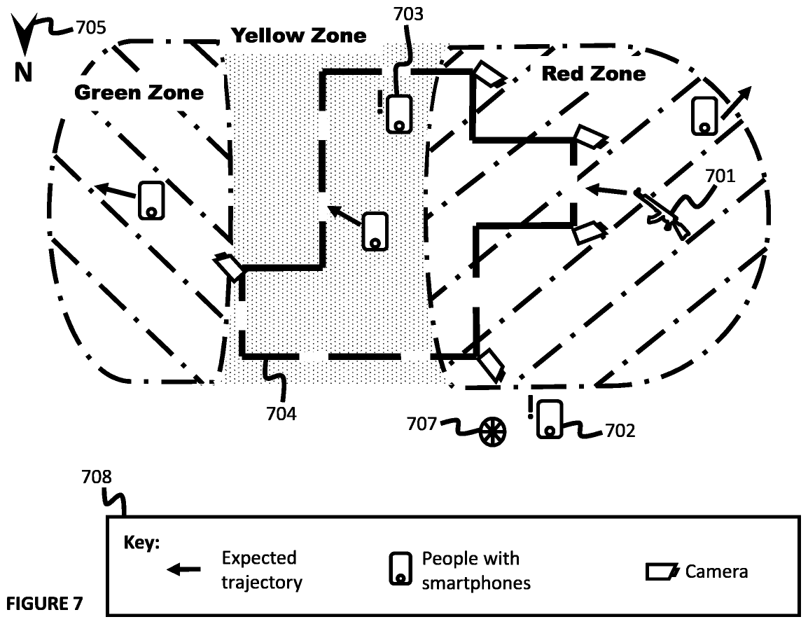

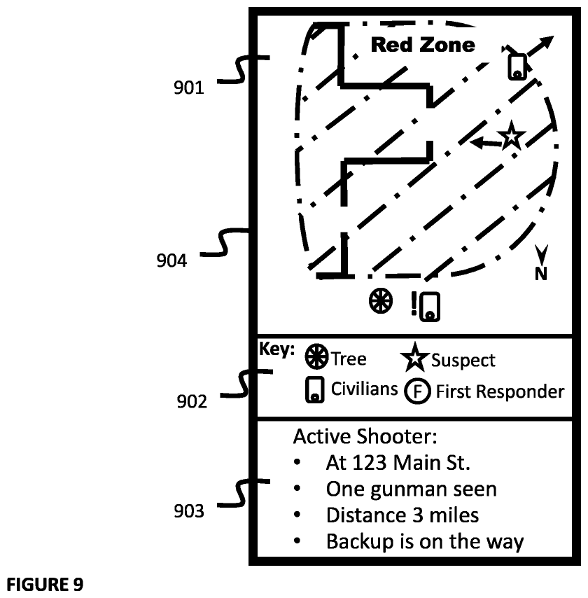

In an embodiment, an entity with its expert threat model capable of one or more sensory observation—comprising at least one of: video, audio, smoke, fire, carbon monoxide, and infrared—generally represented by cameras in schematic representations FIG. 6 and FIG. 7, is placed on building 604 and 704 for threat monitoring and mitigation. FIG. 6 represents the west-facing front of the building, with the schematic's legend or key 608; FIG. 7 represents a top view of the same building, with a legend or key 708 and north arrow sign 705. Key 608 and 708 indicate the symbols used for the cameras, people with their smartphones, and expected trajectories. In FIG. 6, beneficiary people 603 and 605 (also indicated in keys 608 and 708) are shown with their smartphones; a threat actor 601 and 701 is shown with gun 606 approaching door 607 of building 604 and 704. The building occupants, other third parties, and authorities (e.g., law enforcement, paramedics, other first responders, and building management) may be the beneficiaries of the entity and be able to communicate and interact with the entity using one or more device comprising at least one of: personal device, on person or wearable device, and otherwise accessible device (e.g., handheld devices of one or more type comprising at least one of: smartphone as shown in keys 608 and 708, other mobile device in general, and fixed device). The entity is learned and trained to surveil for and to act on threats, threat activities, and threat actors. For example, the entity in FIG. 6 and FIG. 7 is actively impeding the threat intent and activities of a potential perpetrator—threat actor 601 and 701—with gun 606, by sending notifications, warnings, and projections of the threat intent and activity to the beneficiaries, which then are able to take proactive actions, escaping 603 from the threat to protect themselves against the threat and threat activities. The notifications may comprise risk loss impact (LI), risk loss message (LM), and resolution recommendation RR (along with RM, RP, and RS) encoded as text, pictures, symbols, or otherwise to communicate the risk and the resolution to the beneficiaries. The extent and content of the notifications may be tailored to the intended end user based on one or more criteria comprising at least one of: roles, responsibilities, user preferences, policy, and legal compliance. For example, FIG. 9 represents an example of the threat notification sent to a law enforcement official, showing Red Zone as an active scene of a crime where threat is imminent—as estimated by the expert threat model and conveyed through the risk profile—and a summary of a RM and a LM. A generic user shown in the relatively safe Green Zone in FIG. 7 may be informed of a generic threat at the west end of the building, and be asked to leave and head away from the building in the east-bound direction. Paramedics may be notified of the relatively low-threat Yellow Zone and the imminent-threat Red Zone, receiving indication of users who are not moving 702 and 703 (shown without a trajectory and with an exclamation mark) and may need assistance, and their locations. The zones may alert paramedics that the potential victim 702 is in the direct sight of threat actor 701 and that he may not be safely accessible; on the other hand, the potentially immobile victim 703 is in the relatively safe Yellow Zone and the paramedics may be alerted that he may be easily accessible from the south door of building 704.

In FIG. 7, the entity combines and distills the risk profile and the resolution recommendations to divide the map and area close to building 704 into three dynamic zones: Red Zone, which is a scene of an active shooting; Green Zone, which is beyond the immediate reach of threat actor 701 and represents an ideal route for escape; and Yellow Zone, which is not in imminent danger, but may become part of the Red Zone if threat actor 701 is able to continue to move on his intended trajectory. The entity, by virtue of its expert threat model, tailors its notifications and its actions based on the zone specifications in coordination with the beneficiaries of the domain, keeping in line with the regular drills conducted for such an event. Besides using zones for reference, RR and notifications include known landmarks in the area, e.g. tree 707 and 602.

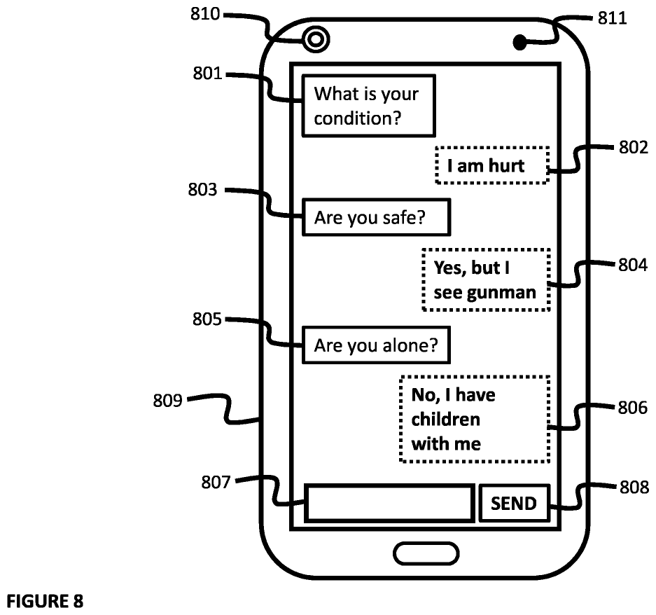

In an embodiment in FIG. 8, a beneficiary user is able to interact with the entity and its expert threat model to exchange mutually needed information using his device 809 with camera 810, microphone 811, and a capability to enter a message in text area 807 and send the message using button 808. Noticing that the user is immobile in a room, the entity may ask the user about his health 801, safety condition 803, and if other users are with him 805, and receive and process the corresponding responses (802, 804, and 806) from the user. The interaction—in forms comprising at least one of: text, visual, and audio—with the user is then incorporated into the risk profile and the resolution recommendations are updated. The entity may also mediate information exchange between a beneficiary—typically a beneficiary victim—and his caregiver or other support entities (e.g., a support group, his family and friends, and a social group), monitoring the physical and mental condition of the beneficiary victim with or without devices, after, during, or before the threat incident—in anticipation of or as a result of the projection of the threat. This information exchange may be further used for learning, training, and improving the entity's performance or to improve the general and overall understanding of one or more subjects comprising at least one of: threats, threat actors, victims, localities, and society in general. The information exchange may use other media besides the users' smartphones, comprising at least one of: audio-visual devices, augmented-reality devices, social media, and electronic or other communication channels. A potential loss (e.g., long-term loss) to domain beneficiaries (e.g., beneficiary victims, localities, businesses, non-profits, or governments) may far exceed the immediate losses that may happen at the site of or during the active threat, e.g., long term trauma, ongoing physical and psychological problems, inability of victims to ably function in general, financial and productivity losses, and societal and civic discord in general. The entity may exchange information and contribute to the users' and other domain beneficiaries' recovery from losses on an ongoing basis.

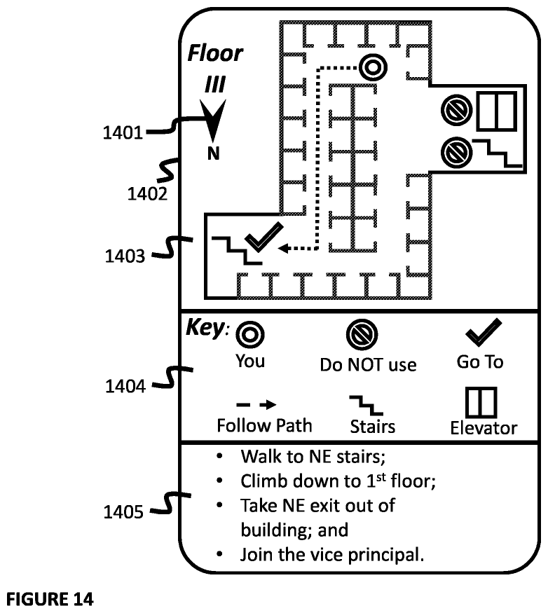

In an embodiment, an example of a notification from an expert threat model of an entity of a domain monitoring an active threat event—as shown in FIG. 6 and FIG. 7—is given in FIG. 14. FIG. 14 shows an example of a notification received by a user, who may be on the third floor as indicated above north arrow sign 1401. The threat information, risk profile, and threat resolution recommendation are created for the user as an intended beneficiary, and tailored to user's one or more attribute comprising at least one of: his circumstances (e.g., location and demographics), needs, profile (e.g., social profile, work profile, or civic profile), roles, and responsibilities. The information is sent to the user's device 1402 in a format suitable for communication with that user so as to maximize the efficacy of the information for that user. Device 1402 displays a map of the user's surroundings (in this case the third floor) on map area 1403; the map is supported by key 1404 that explains the symbols used in the map; text area 1405 enhances the efficacy of the notification sent to the user by one or more method comprising at least one of: providing instruction to enhance the user's security; guiding him to a safer area; warning him against the danger and dangerous areas; broadcasting messages relevant to the user (e.g., in FIG. 14, “Join the vice principal”); enhancing health, comfort, and general wellbeing; reminding him about jurisdictional or legal requirements; reminding of and reinforcing the steps used in prior drills simulating such threat conditions; and indicating alert level (e.g., red, orange, yellow, and green; mild, moderate, and severe; or walk slowly, run, or hide immediately; etc.) associated with the scenario. The notification received by the user changes as the attributes of the user and the situation change; e.g., as the user moves to a different location, performs an action, and as circumstances in general change. A second user in the same domain under similar circumstances may receive a threat notification tailored for the second user in one or more format comprising at least one of: format suitable for the second user (e.g., his age, his social condition, his level of expertise, his general understanding, etc.) and for his ability to follow instructions (e.g., instruction with certain details, complexity, scope, and extent); format suitable for his device (e.g., its resolution; input methods; whether it is worn, embedded, carried, etc.; and its default settings), and among others, its communication grid access and bandwidth capability, and its power level and state (e.g., logged in, sleeping, etc.); and format suitable for his situation in general. A third user in the domain under similar circumstances may receive a threat notification tailored for the third user and his augmented-reality device to enhance the efficacy of the notification in general; e.g., an augmented-reality enhancement may help the third user to overcome a physiological or psychological handicap.

In an embodiment, an entity observing a domain identifies a threat and sends threat notifications. If a first vulnerable domain beneficiary (e.g., a child, an animal, or a disabled individual), which may or may not be a user, is incapable of processing—receiving, understanding, and generally following—a threat notification comprising one or more resolution recommendations, the entity may coordinate, include, and facilitate the resolution recommendation for the first vulnerable beneficiary with that of a second user that is capable of acting on behalf of the first vulnerable beneficiary. For example, the second user may be an adult present in the vicinity of a child that may need help with its threat resolution recommendation, e.g., need for the child to move away from the threat. The adult second user may receive consolidated resolution recommendations for him and the child. In another embodiment, a first vulnerable domain beneficiary may be a tangible or an intangible first vulnerable artifact that may be a beneficiary instead. A second user may receive a threat notification with consolidated resolution recommendation for both the second user as well as the first vulnerable artifact. For example, in case of an imminent fire, a museum caretaker, as the second user, may receive a risk profile and resolution recommendation instructions to save a close-by culturally significant painting—the first vulnerable artifact—from the fire by escaping the fire along with the painting. In yet another embodiment, for an imminent-flood threat, a system, a device, a SIC, or an AIE, as a second user, may receive resolution recommendations to secure its premises. The second user may take steps to shut down or otherwise secure other vulnerable devices and systems, secure first vulnerable domain beneficiaries (e.g., animals, patients, elderly people, etc.) and first vulnerable artifacts (e.g., tangible things that may be susceptible to the threat). The second user may notify an entity, third responsible systems, or third responsible domain beneficiaries of the process and progress of its activities.

In an embodiment, an example of role-based notification from a first entity of a domain monitoring an active threat event (shown in FIGS. 6 and 7) is given in FIG. 9. FIG. 9 shows an example of a notification received by a law enforcement officer, who is then expected to arrive at the threat location and respond to the threat and the threat actor, a gunman 601 and 701, and perform duties to help and control the threat situation in general. The law enforcement officer, just as with other beneficiaries of the threat model, receives the notification in real-time as soon as the gunman 601 and 701 and the threat posed by him are detected, and a risk profile and the resolution recommendations are generated. The officer on his smartphone 904, augmented reality device, or other device is given practically all information that he may need in real time; the officer may further communicate with the first entity, requesting additional information similar to the way described in connection with FIG. 8, where a second entity is shown requesting additional information from the device 809 user. The risk profile and resolution recommendation are distilled to provide map 901 of the active imminent threat scene: Red Zone, as shown in FIG. 7. A role-specific key 902 provides locations of the gunman, prominent landmarks (e.g., a tree), civilians, and other first responders (if any), facilitating understanding of the crime scene map in general. Additional information that may be required by the officer is given in text area 903. The same interface 901,902, and 903 on device 904 may be used to provide other information: pictures related to the threat comprising at least one of: pictures of the gun, the gunman, and any other condition; and answers to queries and other details comprising at least one of: type of gun, the capability of rounds per magazine, ability of a bulletproof vest to withstand the bullets from that type of gun, background information and prior criminal record of the gunman, and conveyance used by gunman to arrive at the threat scene. As a part of the risk profile and resolution matrix, the first entity may coordinate or cooperate with multiple such officers and their supervisors and offices in proposing the best tactical approach for the officer at the threat scene. Similar to the way described in connection with FIG. 8, the first entity may act as a mediator, a go between, or an orchestrator of communication between the officer and one and more other actor comprising at least one of: his supervisor, his office dispatch, other officers (e.g., on or off the threat scene), other first responders, and authorities in general. The first entity, if needed, may enable for the active threat situation a command-and-control structure of one or more type comprising at least one of: a predetermined structure, an impromptu structure, a transient structure, and a permanent structure.

Typically, the threat model of an entity that acts on a given domain is a property of that domain. Other entities that are influenced by that domain are subject to the threat model of the entity. For example, as an analogy, and not by way of limitation, a gazelle as prey and a cheetah as predator may share significant properties of their shared domain in their own threat models; one of the significant differences between the threat models may be the nuances of their goals as well as the end result of a given interaction between the two—success for one may be loss for the other. In this prey-predator interaction, both of them share some of the same goals—survival, preservation, and propagation. In an embodiment (FIGS. 6, 7, 8, and 9), one or more first entities notify the threat model beneficiaries of threat intent and activities of a potential perpetrator (601 and 701)—a threat actor—with a weapon 606 in a domain that the first entities have learned, trained on, and are tasked to surveil. The actions of the first entities impede the goals of that threat actor 601 and 701. An intelligent threat actor may catch up with the interference in his goals by the first entities, and may include neutralizing or compromising the first entities in his objectives to enhance the chance and impact of his intended threat activities, and to improve the extent and probability of success of his eventual goals. A threat actor that is knowledgeable, experienced, expert, or otherwise able to project, forecast, and analyze scenarios of his intended threat activities and the interference presented by the first entities may identify, learn, and counter the interference of the first entities in his intended threat activities. A material advantage in capabilities, expertise, and intelligence of the threat actor 601 and 701 over the first entities—all other variables being the same—may result in substantial loss and severe loss impact for the first entities' beneficiaries, thus possibly defeating the purpose and effectiveness of the first entities. Thus, over time, the efficacy of the first entities that are tasked to counter the actively learning threat actor may only be maintained by the first entities' own continuous and efficient one or more learning, comprising at least one of: learning from new tasks and experiences that the first entities may encounter; learning from adaptive and changing strategies—one or more of adaptive activities comprising at least one of: making plans, making projections, forming alliances, interacting socially, and actions in general—of the actively learning threat actor; and learning from changing domain conditions in general. In an embodiment, one or more threat actors may be a direct or indirect beneficiary of one or more second entities, such that the second entities enhance abilities of the threat actors in achieving the threat actors' goals; e.g., the second entities may enhance the audio, visual, and other perceptions of the threat actors; the second entities may enhance planning, forecasting, analytics, communication, and adversary mitigation, among others; or the second entities may be dedicated to countering the actions, agency, and effects of the first entities. The loss impact and loss extent for the beneficiaries of the first entities may be determined by a dynamic, real-time, and adversarial interaction between the first entities along with their beneficiaries, and the second entities and the threat actors as the beneficiaries of the second entities.

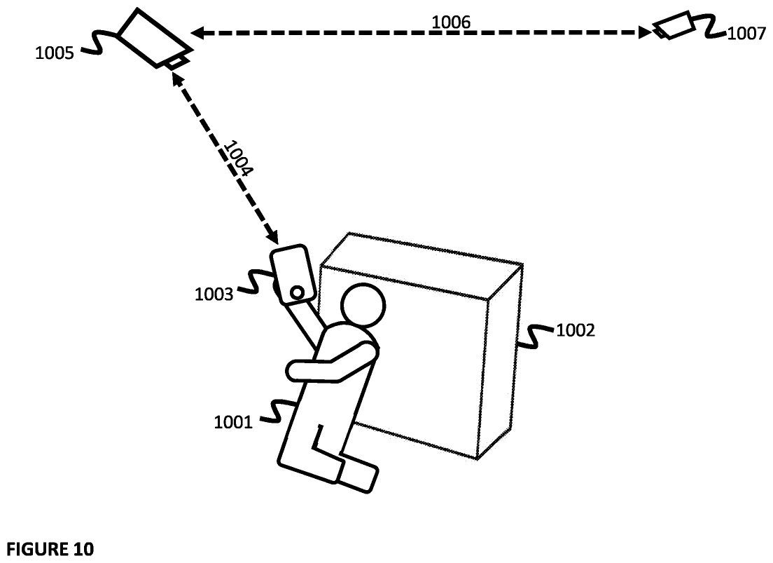

In an embodiment as shown in FIG. 10, an AIE 1005 acting alone or in a SIC employs redundant methods, techniques, devices, or combinations thereof to perform a needed action or task in advancing its goals. In a building lockdown in response to an active shooter (not shown) situation: a user 1001—with a smartphone 1003, an augmented-reality device, or a mobile device capable of communicating with the AIE 1005 or its SIC primarily over a wireless network (either the mobile phone network or Wi-Fi)—is hiding behind an object 1002 perceived as an obstacle for the shooter. If the primary wireless network connection of the smartphone 1003 is lost, the user loses the ability to communicate with the AIE 1005 (or its SIC), and as a result loses the ability to know the user's risk profile and threat resolution and convey the user's condition and needs to the AIE, SIC, other one or more outside domain beneficiary, or other one or more outside entity. Thus, the user's risk profile and the threat resolution outlook worsens. The user's communication with the AIE 1005, as shown in FIG. 10, may be established with a direct two-way IR connection 1004—a secondary communication—between AIE 1005 and the user's smartphone 1003. The IR connection 1004 is shown to require a direct line-of-sight between the AIE 1005 and the user's smartphone 1003; however, other methods, devices, or combinations thereof as means of secondary communication may not be bound by such limitations. The reasons for loss of primary network connectivity may comprise at least one of: accidents, threat activities, and natural consequence of a given circumstance, e.g., the user 1001 is forced to hide in a place that does not receive the primary wireless network connectivity. The extent, quality, and effectiveness of the secondary communication may depend on the extent, quality, effectiveness, and permissible use of the secondary communication means; possible limitations of the secondary communication may be identified, learned, and compensated for by the AIE 1005 (or its SIC).

In an embodiment in FIG. 10, if the AIE 1005 loses its primary network connectivity—wired, wireless mobile, Wi-Fi or otherwise—to its SIC, network cloud, or the external world, the AIE 1005 may fall back on secondary communication like two-way IR communication 1006 to establish the network connectivity. The reasons for loss of the AIE's primary network connectivity comprise at least one of: accidents, threat activities, and natural consequence of the given circumstance. The extent, quality, and effectiveness of the secondary communication may depend on the extent, quality, effectiveness, and permissible use of the secondary communication means; the possible limitations of the secondary communication may be identified, learned, and compensated for by the AIE 1005 (or its SIC).

In an embodiment, as seen in FIG. 10 where a primary network connectivity-wired, wireless mobile, Wi-Fi or otherwise—of an AIE 1005 and its SIC, where connectivity to some fraction of its SIC, network cloud, or the external world is wholly or partially lost, and a user's (1001) smartphone 1003 has a wireless network connectivity, the AIE and its SIC (1007, in part or as a whole) may use the smartphone's 1003 wireless network connectivity—a secondary connectivity for the AIE or its SIC—to restore all or part of the needed network connectivity. The extent, quality, and effectiveness of the secondary connectivity depends on the extent, quality, effectiveness, and permissible use of the secondary communication means; e.g., the smartphone's 1003 wireless network. The AIE 1005 and its SIC (all or in parts, 1007) may be linked to user's (1001) smartphone 1003 over two-way IR connections 1004 and 1006. The reasons for loss of the AIE's primary network connectivity may comprise at least one of: accidents, threat activities, or a consequence of the given circumstance. The possible limitations of the secondary communication may be identified, learned, and compensated for by the AIE 1005 (or its SIC).

A threat model of a first entity observing a domain with designated domain beneficiaries may employ and manipulate actors—cooperative or uncooperative—with different intents to achieve its goals. All the cooperative actors may not be domain beneficiaries, and all the beneficiaries may not cooperate. For example, the first entity may use a second actor in general (e.g., a second entity)—an expendable actor (or a decoy in some scenarios)—to diffuse or detonate an explosive in a controlled fashion so as to minimize resulting overall loss to the domain beneficiaries as a whole; though, both the expected or resulting loss for the expendable second actor may be complete and irreversible. In another embodiment, a decoy actor may be used to divert attention of an attacker away from high-value or vulnerable targets by presenting the attacker with alternatives (e.g., alternate routes, alternate targets, etc.) or obstacles to improve the risk profile of the high-value or vulnerable targets of the attacker, e.g., giving the targets or their caretakers time to enact defense or to counter the attacker's harmful intents in general.

In an embodiment, an unpredictable or dangerous artifact, an unwilling actor in custody—protective or otherwise—or a psychologically imbalanced actor that is expected to cause harm to himself, others, or his domain in general, may be a beneficiary of a threat model of an entity observing the domain, such that the actor may not cooperate with the threat model or the other beneficiary artifacts or actors of the domain. For example, a patient that is a recovering alcohol or drug addict in a drug rehabilitation center may be cooperative most of the time; however, when the addiction cravings become unbearable for the patient, the patient may engage in activity that is uncooperative, e.g., potentially relapse-inducing substance abuse, self-harm, or property (e.g., artifact) damage.

In an embodiment, one or more first entity observing a domain may be compromised by one or more reason comprising at least one of: being infected; spoofed; disconnected; taken over; overcome by one or more thing comprising at least one of: threat, threat actor (e.g., intentionally, unintentionally, or with help from a third-party), accident, and natural phenomenon; and otherwise disabled. Such a compromised first entity is identified, diagnosed, and counteracted by one or more second entity observing the domain. The compromised first entity on its own, or with the help or coercion of the second entity, or by combinations thereof, may be contained or corrected by one or more action, leading to the compromised first entity being in one or more state comprising at least one of: powered off, cordoned off, destroyed, used as a decoy (e.g., as an expendable thing), and otherwise isolated from the domain and the other domain things, to avoid or minimize the compromised first entity's direct or indirect infliction on one or more thing comprising at least one of: the domain in general, other domain things, other domain entities observing the domain, and the domain beneficiaries in general. Thus, the SIC, or in general the second entity, may include its own survival, preservation, and propagation-among others—as goals in its threat model and employ the tools and devices under its control to achieve those goals. In an embodiment, instead of the first entity, a third thing—a device, an agency (e.g., the domain manipulation capability), an artifact, or an actor—may be compromised by one or more reason comprising at least one of: being infected; spoofed; disconnected; taken over; otherwise disabled; and overcome by one or more thing comprising at least one of: threat, threat actor (e.g., intentionally, unintentionally, or with help from a third-party), accident, and natural phenomenon. The compromised third thing is identified, diagnosed, and counteracted by a second entity observing the domain; the compromised third thing may be contained or corrected by one or more action, leading to the compromised third thing being in one or more state comprising at least one of: powered off, cordoned off, destroyed, used as a decoy (e.g., as an expendable thing), and otherwise isolated from the domain and the other domain things, to avoid or minimize the compromised third thing's direct or indirect infliction on one or more thing comprising at least one of: the domain in general, other domain things, other domain entities observing the domain, and the domain beneficiaries in general. In an embodiment, such a compromised third thing is a fourth device (e.g., a notification device, or a smartphone) in possession and control of a fifth threat actor causing or intending to cause one or more loss to one or more sixth domain beneficiary or the domain in general. One or more aspect of the fourth device comprising at least one of: its possession, its control, its communication, and its use in general, increases the loss for the sixth domain beneficiary. Such a compromised fourth device is identified, diagnosed, and counteracted by a second entity observing the domain; the compromised fourth device may be contained or corrected by one or more action, leading to the compromised fourth device being in one or more state comprising at least one of: powered off, cordoned off, destroyed, used as a decoy (e.g., as an expendable thing), and otherwise isolated from the domain and the other domain things, to avoid or minimize the compromised fourth device's direct or indirect infliction on one or more thing comprising at least one of: the domain in general, other domain things, other domain entities observing the domain, and the domain beneficiaries in general.

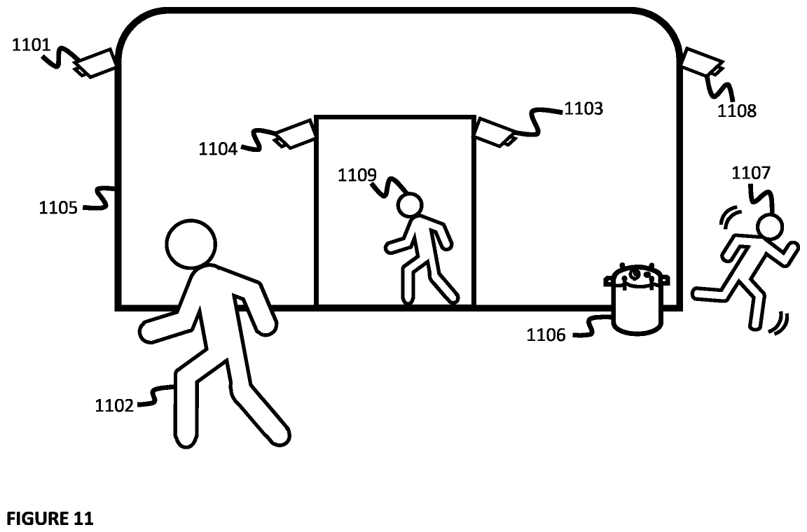

In an embodiment, FIG. 11, a seemingly innocuous household item—e.g., pressure cooker 1106—presents a severe risk profile with high loss impact (e.g., high LE, LS, and LD, and low LC and LR) and high loss likelihood as identified by one or more AIE (indicated by camera 1101, 1103, 1104, and 1108) acting alone or as a member of a SIC observing a domain. Though a pressure cooker in and of itself is commonplace, it is presented in an environment and under conditions that are improbable. Pressure cooker 1106 in FIG. 11 is left unattended in front of a busy storefront 1105 with customers 1102, 1107, and 1109. The AIE detects pressure cooker 1106 in the unusual environment and identifies a risk profile that indicates high LL and severe LI. Subsequent to identifying the risk profile, it generates resolution recommendations RR. When the threat is first detected, it creates two resolution recommendations RR-11 and RR-21. After 30 minutes, it creates the next versions of the original resolution recommendations RR-12 and RR-22. The temporal nature of the threat and the threat mitigation is represented by the updated resolution recommendations as well as the updated underlying risk profile. Thus, at the time the threat is first detected and thereafter, the threat resolution matrix includes:
a. RR-11 (resolution recommendation-11): Notify authorities and management of the building with RP-11 (resolution priority-11) of “high”, and RS-11 (resolution success probability-11) of “medium”, along with a resolution message (RM-11) of “An unattended pressure cooker is identified outside store number 23. Pressure cooker lid is closed. Situation is dangerous and needs immediate attention. Condition orange.”
b. RR-21: Notify customers, employees, first responders, and other building habitants, with RP-21 as “high” and RS-21 of “medium”. The resolution message is tailored to the intended audience's role, location, and message delivery method.
   i. A typical employee receives on her devices, phones, and monitors: “This is not a drill. Condition orange—evacuate; do not use south gate or pass store number 23. If you are a department safety monitor, wear your safety monitor red jacket, ensure that your designated area is evacuated, render aid when needed and possible; if unable to do so, contact emergency services for help before evacuating yourself.”
   ii. A first responder receives “Condition orange. Suspicious object in front of store number 23. Evacuation in progress. Paramedic: No casualties are known at this time; stand ready to render help. Security: Move towards store 23; facilitate evacuation; prevent and contain panic.”
   iii. Customers and other inhabitants are notified on the public address (PA) system “Customers are asked to evacuate the shopping complex at this time. Walk to the north and east exits. If you need medical or evacuation help, please ask security personnel or the department safety monitors in red jackets”.
c. RR-12: After 30 minutes, an update to RR-11-RR-12—is sent, indicating that a bomb squad is on location, has characterized the threat, and has estimated three hours for defusing the threat. The shopping complex is evacuated with a high level of certainty. All employees are accounted for and all department safety monitors report success with their designated tasks. The risk profile is still elevated, though loss impact has changed (e.g., medium LE with low LD; loss social significance (LS) is still high. On the other hand, LC is high and LR is medium), and the loss likelihood (LL) has diminished significantly. The threat RP-12 is still “high”, though RS-12 is also “high”. RM-12 is sent to the authorities as well as the building management as an update to RM-11
   i. “Condition orange. Suspicious object in front of store number 23. Bomb squad on site and evacuation complete.”
d. RR-22: After 30 minutes, customers, the employees, the first responders, and the other building habitants are sent an update to the original RR-21. An update to RM-21, RM-22, is tailored to the intended audience's role, location, and delivery method.
   i. The employees receive an update “Evacuation successful. Your immediate supervisor, human resource, or employers will contact you with further instruction. Raise any errors and omissions in evacuations by calling the emergency number.”
   ii. The first responders receive an update “Condition continues to be orange. Paramedic: No casualties are known at this time; stand ready to render help. Security: Maintain your posts until further notice.”
   iii. Customer information and enquiry automated telephone messages and online presence (web page, social-media, etc.) for the shopping complex are updated with a public announcement: “An unidentified object was detected, authorities are on site, evacuation of employees and customers has been successful; the shopping complex will be closed until further notice. Contact the emergency telephone number if you have additional important information.”

In an embodiment, FIG. 12 represents observed risk profiles of a disease over a period of time, and shows the subsequent losses caused by the disease in different scenarios. The horizontal axis 1201 represents time t, and the vertical axis 1202 represents loss likelihood (LL). The first signs of the disease appear in one or more first patient at time t=0, and if unchecked, the natural progression—progression 1203—of the disease results in a complete and irreversible loss (CAIL), MIL-03, at about t=T3; MIL-03, the complete and irreversible loss (MIL=100% of CAIL) is shown by threshold 1204. The natural progression of the disease in the first patient—progression 1203—may be influenced, checked, and changed in general by actions of the first patient and other domain actors; here, the one or more action comprise at least one of: diagnosis, psychological and social support, treatment (e.g., of one or more type comprising at least one of: medical, surgical, psychological, social, and therapy), and prevention. In the embodiment, as a first example, an entity that has a wholistic threat model to counter and mitigate the disease monitors the possibility and progression of the disease in one or more second patient. Though the first signs of the disease for the second patient appear at time t=0, the entity detects and diagnoses the disease at t=T1, and proposes a resolution recommendation (RR-05), which when followed by the second patient and his caretakers (wherein, the entity may exercise its agency to act as a caretaker), diminishes the risk of the disease in the second patient—indicated by progression 1205—with the shortest duration of recovery (SDOR) designated by SDOR-05. SDOR-05 may be less than or comparable to t=T3; an MIL, MIL-05, in this case is 0% of CAIL—the second patient undergoes full recovery. The entity needed T1 amount of time from the first signs of the disease to detect it, generate a risk profile, and arrive at the resolution recommendation RR-05; thus, the time to detection (TTD) and time to resolution recommendation (TTR) are the same. In the embodiment, as a second example, the full recovery is prevented as the entity is unable to detect the disease at T1, but does so at a later time, t=T2 (T2>T1 and TTD=T2). Also at T2, the entity proposes a corresponding resolution recommendation RR-06 (TTR=T2), which when followed by the second patient and his caretakers, arrests the progression of disease and lowers the risk—indicated by progression 1206—but may increase the corresponding SDOR to SDOR-06 with SDOR-06>SDOR-05, and may indicate a lasting loss or damage. After the disease has run its course, and maximum possible recovery has been attained, a corresponding MIL, MIL-06, is greater than 0% (though less than 100%) of CAIL, and it may take longer than t=T3 in general to achieve it. Thus MIL-05<MIL-06<MIL-03. In FIG. 12, early detection and resolution of the disease risk is important to limit a possible MIL and limit a possible SDOR. Note that it has been assumed, by way of example and not by way of limitation, in FIG. 12 that the RR proposed at both t=T1 and t=T2 are the best possible solutions at the given times to limit the corresponding MIL as well as SDOR. If the RR are not accurate, at a minimum, it would further increase the risk and introduce uncertainty in the risk profile; the loss may be higher than the corresponding MIL, and recovery duration may be longer than the corresponding SDOR. Another assumption, by way of example and not by way of limitation, in FIG. 12 is that all the actors involved followed the RR in the most efficient manner; otherwise, the actual loss due to the disease may be greater than the corresponding MIL, and the actual duration may be longer than the corresponding SDOR. In an embodiment of wholistic intelligence, a threat model that started out with an assumption of complete, informed, and ideal compliance by the domain actors (e.g. patients) may recognize the assumption to be error prone after repeated exposures to real-life situations of the disease with different patients; learn from the repeated exposures; and include a set of patient characteristics and behaviors as new dependent factors needing heightened attention in its newer versions of threat model, input matrix, and domain observations in general. The new dependent factors may be the confounders of the original threat model and their identification, and inclusion in the newer version of the threat model may improve its effectiveness and efficacy and reduce errors and residuals in general.

For a threat model of an entity observing a domain to deal with a threat event in the domain, possible challenges that may be involved, by way of example and not by way of limitation, in identifying a domain observation's one or more part (and its one or more corresponding input matrix) on which to focus its attention and apply the threat model comprise one or more shortcoming in at least one of: A. accuracy of risk profile prediction; B. TTD and TTR; and C. domain cooperation. Types of said challenges comprise at least one of: new, existing, expected, unexpected, transient, and permanent. Note that challenges posed by an adversarial scenario, a threat-causing actor, or a compromised artifact (e.g., device, system, or an article) may be considered as a part of the threat event under consideration. Further description of the listed challenge types, by way of example and not by way of limitation, follows:

A. The challenge of a lack of accuracy of risk profile prediction for the entity is affected by factors comprising at least one of:
a. Random and uncertain threat events: Truly random events cannot be predicted; a solution to such random threat events may be diversification. In nature, true random event types are few and far between; e.g., atomic radiation or other quantum activity. In general, some other events may be successfully modelled as random for contemporary practical purposes; e.g., granular movements in a stock market.
b. Complex threat events that may be modelled only by nonlinear functions: Some aspects of such threats may not be asserted with certainty in a complex domain without one or more domain expertise and a capable domain threat model typically built from the expertise. Actuaries use statistical models to gain insight—e.g., to estimate causes and effects—into apparent (or assumed) randomness of a domain; however, no attempt is made to formulate the underlying mechanism by contemporary actuaries and the like. On the other hand, ANNs, with their ability to identify nonlinear functions in an observed domain, may be able to formulate the underlying mechanisms of the complex threat events. Diversification may be a currently accepted solution to complex or pseudorandom events; however, interrelated and codependent threat events—regardless of their complexity or the extent of their non-linearity—may have better solution alternatives, or even a unique solution; in that case, the use of diversification may be counterproductive.

B. The challenge of TTD and TTR delay for the entity: Time to detection (TTD) and time to resolution recommendation (TTR) may influence a desired MIL and a desired SDOR from a threat. Almost all risks, threats, and recoveries may have time as an important factor; for example, FIG. 12. Short TTD and TTR may be essential in successfully containing, countering, and recovering from a given threat. Unlike in FIG. 12, a risk detection at a TTD may not immediately result into a risk resolution recommendation at a TTR—TTR may be greater than TTD. A risk may be identified, but a viable resolution may depend on several other factors in the domain; e.g., availability of time and resources for a high priority resolution (or a resolution with high RP); a RR may be contingent on one or more approvals comprising at least one of: legal, medical, policy, of an end user, and of a beneficiary. One or more action needed for the implementation a RR may or may not be within the control of the entity or other cooperating actors regardless of their agency (e.g., domain manipulation ability) and other abilities in the domain. Due to these constraints, a highly desirable (e.g., high RP) RR may not be the one with higher RS (success probability). The entity may document the said considerations in the corresponding resolution messages (RM). After generating a complete set of RR, the entity may continue to observe and update the RR in response to material changes in the risk profile. For clarity of further discussion—not by way of limitation—a TTD and a TTR for a threat event may be assumed to be practically the same, wherein exceptions to the assumption comprise at least one of: limitations of abilities, agencies, time (an example of time limitation is a wait involved in garnering necessary approvals), and resources for actors responsible for implementing RR.

C. The challenge of subpar domain cooperation for the entity performance: The entity may require involvement of actors, both in and out of the domain, and the beneficiaries of the domain in implementing a resolution recommendation. Several inefficiencies of the domain actors and the beneficiaries may contribute to a loss that is larger than the a possible desired MIL and a recovery duration that is longer than a possible desired SDOR. Those inefficiencies comprise at least one of: miscommunication, bias, misconception, misunderstanding, lack of knowledge, lack of skill, and lack of ability. The inefficiencies themselves may manifest as one or more of delay or inability in actions comprising at least one of: to make decisions, to acquire skills, and to render consent.

In an embodiment, for an entity observing a domain and dealing with threat events in the domain, incidents of excess losses over a desired MIL or excess times over a desired SDOR are referred to as defects. The causes of the defects comprise at least one of: inefficiency in the threat model accuracy (a defect of accuracy, a DACC), inefficiency in TTR or a delay in arriving at a resolution recommendation (a defect of TTR delay, a DTTR), and inefficiency or lack of cooperation (a defect of cooperation, a DCOP) among actors (e.g., entities, or beneficiaries of the domain). While the DACC and DTTR can be corrected mostly by improving the entity, the defect of cooperation (DCOP) needs improvements of the joint actions of the actors and the entity. In an embodiment, wherein the entity observing the domain is a wholistic entity, the entity may rectify, mitigate, and otherwise gain knowledge of one or more defects due to one or more reason comprising at least one of: further learning; further experience with diverse observations from diverse domains; further acquisition of knowledge from sources comprising at least one of: other actors, other entities, other domains, and otherwise externally; using higher-order knowledge (e.g., initiative, autonomy, intent, surprise, curiosity, exploration, etc.); an ongoing collaboration with other actors and entities; and an one-off collaboration with other actors and other entities.

In an embodiment, for an entity observing a domain, the effectiveness of the domain as a unified system to deal with a threat event for the benefit of domain beneficiaries is a combined ability of cooperating things in general—comprising at least one of: one or more AIE, one or more SIC, devices, artifacts, and actors involved in the domain processes (DP)—in and out of the domain, to minimize possible defects to attempt to keep a realized loss at a desired MIL and a duration of recovery at a desired SDOR in a resolution of the threat event. The minimizing of the defects may also be seen as an effort to improve the quality of the domain processes (DP) involving the entity and other domain related actors.

Quality improvements of an individual domain process (DP) component involving human actors based on human knowledge, recollection, and skill are subject to broad standard deviations. For constant motivations, objectives, training, and environments, though optimal quality assurance from a group of human actors in a given DP component can be estimated, attempts of different methods to derive marginal improvements in human productivity and quality may prove to be futile, especially over the long run. A robust and self-correcting DP can, however, be constructed out of several such DP components to derive accuracy better than 3-sigma—and in some cases approaching 6-sigma. For example, a six-sigma objective (SSO) methodology may be deployed for solving a chronic fraud-prevention problem on an international scale by bringing in human expertise from fields including:
a. Banking, clearing, and settlement: Processing of credit cards and checks. Marchant's roles and responsibilities in internationally different jurisdictions.
b. Insurance and risk assessment: Data on human psychology and human behavior, and human fallacies in enabling and committing fraud.
c. Retail and point of sale: Challenges and opportunities at manned stations, IVR (interactive voice response) points, and Internet points of sale.
d. Marketing, customer retention and customer satisfaction: Eliminate clumsy steps in customer experience by identifying and eliminating fraud early in the cycle.

In the embodiment, a diverse set of intelligent systems and human knowhow may be combined with near real-time exchange of information to improve fraud detection. Though no one system component may be able to accomplish the desired performance in isolation, by combining the different components supplemented with SSO methodologies, performance better than 3-sigma may be achieved.

ANN are designed to strike a balance between accuracy and generalization. Overfitting is decidedly countered by introducing biases (e.g., from ANN weights and biases), introducing noise, or other randomization techniques in general. SSO experiments, on the other hand, assume a steady state and stable process that approaches a delta function, and they strive to attain it. For a single ANN, the two methodologies may not be combined; or if they are combined, conventional methods to improve the accuracy of the ANN may systematically fail. An analogy may be drawn between the human intelligence described in the fraud detection case and different ANN with similar goals and expertise. Applying the SSO approach to a system of diverse sets of ANN may derive accuracy better than any one of the component ANN of the system.

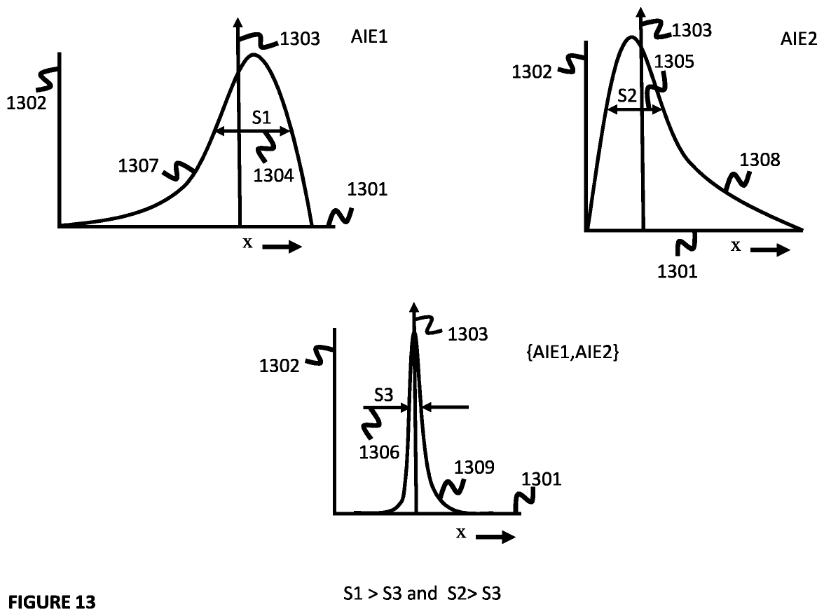

In an embodiment shown in FIG. 13, a diverse set of ANN are combined with SSO methodologies—two representative ANN performance distributions are shown, AIE1 and AIE2. The performance distribution of the combination is shown by a set {AIE1, AIE2}. AIE1 and AIE2 (and the other members of the set) are combined using one or more component comprising at least one of: dedicated AI (e.g., ANN or a reinforcement agent) and an algorithmic system (e.g., business rule engine management system—BRMS). The three plots show prediction, x, on the horizontal axis 1301 versus the number of samples on the vertical axis 1302. For AIE1, the prediction curve 1307 represents the number of samples versus their prediction, x; for AIE2 the prediction curve 1308 represents the number of samples versus their prediction, x; and for combined {AIE1, AIE2} the prediction curve 1309 represents the number of samples versus their prediction, x. For all three curves 1307, 1308, and 1309, the delta function 1303 represents the same, most accurate prediction. The delta function 1303 is an idealized representation where all the samples give the same correct prediction; 1303 represents a hypothetical most accurate system with zero errors. In reality, predictions for AIE1, AIE2, and {AIE1, AIE2} are distributed around the most accurate prediction. The spread of the predictions is given by two-standard-deviations, S1 1304 for curve 1307, S2 1305 for curve 1308, and S3 1306 for curve 1309; they represent the variability in the prediction. SSO methodologies reduce the variability of the combined set {AIE1, AIE2} more than that of any of the individual members of the combined set; S1>S3 and S2>S3.

Reducing the variability of the threat model prediction improves (e.g., reduces the number of defects for a given sample size) the DACC (defects due to accuracy of the threat model) and DTTR (a defect of time-to-recommendation delay, DTTR). The defects in domain cooperation, DCOP, requires cooperation of disparate actors related to the domain. The domain process (DP) components related to the disparate actors of the domain may also be combined similarly to the fraud detection example using a component comprising at least one of: algorithmic system (e.g., BRMS) and AI (e.g., ANN or reinforcement agent). An approach used to reduce the variability of DP with the disparate actors may require reducing the variability of the individual DP components below an acceptable level and then combining DP components to reduce the variability further using SSO methodologies. One successful methodology to reduce the defects and variability is to conduct end-to-end drills on the entire domain; quantify the performance of individual components in the process; identify the most defect-prone DP component or link between two components; and correct the most defect-prone component or link. The closer the drill is to the real scenario, the better the predictability of the model. After the domain processes have attained satisfactory specification limits, the system is deployed in the field while the defect data is collected in real-time or near real-time. Quality control is verified and altered if the number of defects exceeds the designated control limit (for allowable number of defects) in the live system. Integration of quality control in the day-to-day operation of the domain processes is a key to achieving the lowest possible number of defects.

In an embodiment, an instinctive response is used to mitigate risk instead of calculating a risk profile and threat resolution in their entirety. Need for a quick response is identified early; the relatively long time taken to evaluate the risk profile and generate risk recommendations based on it is deemed a risk in itself. In an embodiment, an entity associated with an autonomous vehicle in motion that notices a pedestrian and anticipates an impact within a couple of seconds generates an instinctive response to the threat and comes to a sudden stop. It may not have time to estimate other less important risks comprising at least one of: the wear and tear of its components due to the sudden stop, and the resultant sudden movements of passengers and luggage in the vehicle. An MIL, in the absence of the sudden stop, is evaluated to be so significantly higher than the next highest loss that even the attempts to evaluate the other losses are postponed until the sudden stop is definitively initiated. The inference accuracy, resolution priority, and loss impact level considerations supersede the generation of a comprehensive picture as well as domain cooperation. Once such an event is identified with the prescribed accuracy, the TTR and the subsequent action—execution of that recommendation—is almost instantaneous.

In an embodiment showing instinctive response, smoke is detected in a crowded hall. An entity observing the domain recognizes that the panic activity is increasing as people rush to the only open door of the venue. Within the duration of a potential TTR, a potential MIL (if TTR for it is delayed) for the panic threat is far greater than that for the possibility of fire due to the smoke. The entity gives instinctive priority to the panic threat over the potential fire or smoke inhalation threat. It arrives at RR to subdue the panic by opening the windows and all the doors to the venue, notifying the people in the hall—over the PA system as well as through handheld devices—that the other doors are open and reminds them to calmly move towards them, giving coordinated instructions to authorities inside and outside the hall about the panic threat in the form for RR, RM, RP, and RS.

In an embodiment for instinct response of an entity to a gunman, a threat actor is identified in a crowded hall after a couple of shots are fired; one known casualty is identified, and the gunman is further identified as carrying multiple weapons and a potentially large number of ammunition rounds. The entity observing the situation identifies the known casualty as well as the ensuing panic as both potentially high MIL and high SDOR threats, though it recognizes the ongoing threat from the gunman as of far more consequence (if the corresponding TTR and action is delayed) with orders of magnitude greater MIL and SDOR. It instinctively defers—shifts its attention away from—the two earlier threats to respond to, focus on, and contain further potential damage by the gunman. It generates a RR (with RM, RP, and RS) and sends it to contain the threat actor: it sends the RR to authorities inside and outside of the venue; opens the windows and all the doors to the venue; dims the lights of the venue and immediately outside to just enough luminosity for escaping people to see their way; and points all the available floodlights of the venue onto the gunman blinding him for a few minutes, eliminating the possibility of the gunman having clear sight of his potential victims.

In general, temporal variables involve a continuous time and a duration of time; e.g., duration of an event. An example of continuous time is the system time at a given instance of time, or the current date and time. Duration, on the other hand, in general is the time difference between two continuous times as represented by the corresponding two beginning and end event markers; for example, the duration between the first identification of smoke to the first identification of fire; the duration between the beginning of an avalanche to the end of an avalanche as the avalanche slide comes to a stop; or the trigger of a gun being pulled to the firing of a bullet being a first duration, and subsequently from the firing of the bullet to the bullet hitting its target being a second duration. Though a continuous time—based on its conventional measurement—may be considered in itself a duration of some form, conventionally, the forms of durations associated with measuring continuous time may be on different scales than the durations that an entity may encounter in its lifetime or its existence as an actor in a domain.

Duration may be further categorized in to types comprising at least one of: cyclic and repeating durations, also known as time cycles; increasing durations; decreasing durations; and other types where durations are encoded in a time-series. Example of time cycles are day-night cycles, circadian cycles, and biological cycles like migratory cycles. Examples of time series with increasing extent of outcome and decreasing duration are atomic chain reactions; exothermic chemical reactions where the heat generation increases the temperature and hence the reaction rate increases; and, in a behavioral example, panic in an individual or a group of people that may increase exponentially—or feed on itself—with time. Examples of diminishing outcomes with increasing duration are exponential or near-exponential decays and half-life decays—e.g., a radioactive decay; half-life of drugs in humans; and half-life of pesticides in plants. Other time series duration examples are financial cycles, crime cycles, and election cycles.

In an embodiment for a domain with one or more beneficiary comprising at least one of: one or more of entity, actor, environment, artifact, things, and systems—in and out of the domain, or otherwise—one or more event, scenario, or condition in general may be regarded as a threat, wherein the one or more event, scenario, or condition may inflict one or more loss for the domain beneficiary. A loss may comprise at least one of: damage, injury, pain, cost, demise, death, deficit, deficiency, shortfall, missed gain, missed opportunity, missed advantage in general, failure, and defeat. A loss may be of one or more of resource, wealth, energy, viability, vitality, efficiency, knowledge, skill, ability, agency (e.g., the domain manipulation capability), social or group status, reputation and social standing, and approval in general; a loss may be due to one or more actor's activities comprising at least one of: speculation, mistake, error, representation, communication, planning, inaction, and action in general; other reasons for a loss are one or more cause comprising at least one of: natural, manmade, intentional, unintentional, planned, accidental, inevitable, and avoidable. Examples of threats that are possible on variable timelines, timescales, and expectations—e.g., as an occurrence, an aftermath, an inevitability, or an implication—are:
a. Natural disasters and accidents; e.g., earthquakes, floods, storms, mudslides, sinkholes, fires, radiation, asteroids, animal attacks, bird attacks, insect attacks, pandemics, famine, and poisoning.
b. Manmade disasters; e.g.:
   i. Wars, strife, cyber-attacks, financial and white-collar crimes, terrorism, and pollution. Natural disasters due to human actions.
   ii. Attacks and accidents with firearms, blades, projectiles, bludgeons, devices (e.g., acoustic, electromagnetic, chemical, nuclear, gases and liquid), biological agents, nano-devices and nano-materials, remotely or autonomously operated vehicles and devices, and poisoning.
   iii. Psychological crimes—e.g., cons; hysteria; panic; fooling isolated uninformed and vulnerable entities; and social discord.
c. Combinations of natural and manmade threats: one kind may feed on and possibly propagate the other; e.g.; global warming; effects of nuclear explosions and accidents-fallouts, contaminations, and possible winter; and wars and famines causing each other.

An ANN may comprise at least one of various configurations; by way of example, and not limitation, a configuration may be altered by altering the number of hidden layers or depth configuration. ANN may include static, temporal, generative, generative adversarial, and/or reinforcement learning models. Temporal ANN may be discrete, continuous, time-delayed, or asynchronous. Reinforcement learning—both online and offline—may be utilized for Markov decision processes, their derivatives, and non-Markovian processes.

In certain embodiments, the term “learning” refers to training of artificial intelligence. The training of ANNs may be supervised, unsupervised, generative, generative adversarial, reinforcement (both online learning and offline learning), active or query learning (e.g., where the learning mechanism is designed to choose certain learning samples over others), and combinations thereof. Reinforcement learning—e.g., goal-directed, decision making, and/or planning-based—of systems may be done by learning one or more of policy learning, reward learning, and value function learning. The learning of the model of the environment in its entirety may not be needed (e.g., in hidden-mode Markov decision processes). Genetic algorithms and annealing may be used either independently of, or in combination with, the other learning methods. In an embodiment, a threat model of an entity, as part of its operation or its learning in general, may use forgetting as a method or as a skill to increase efficiency and effectiveness, improve efficacy, and to generally advance goals of the entity.

Generation of the labeled learning data may be specific to a domain, its events, actors, and/or the efficacy of the desired threat model. Depending on the ANN and the learning techniques, there may be specific techniques of input data preprocessing (e.g., normalization, flattening, and centering) that may affect the performance of the ANN.

In an embodiment, artificial intelligence learning may also comprise at least one of: linear regression, support vector machines, Bayesian networks, and clustering. Artificial intelligence systems may also comprise at least one of: expert systems, rules engines, inference engines, semantic reasoners, and other systems capable of processing higher-order representations as well as higher-order logic. Examples of higher-order representations and higher-order logic are an entity having information on its own knowledge, other entities' knowledge, and knowledge of its SIC, other concepts of higher-order relationships, and knowledge of learning in general.

It is noted that marks and identifiers used in black-and-white FIGS. 1-14 may be represented in different colors; the marks and identifiers may comprise at least one of: symbols, keys or legends, text notations, hatching and shading to indicate different areas on a map, a floor-plan, or the like. Figures that are embodiments of user interfaces, user interactions, and user communication in general—e.g., displays of a smartphone, an augmented-reality device, or other device—may be representations of colored displays. There may be other ways to display the same user information comprising at least one of: different languages, symbols, notations, conventions, and representation. In an embodiment, the user information may be governed by the rules and regulations of the concerned jurisdiction.

As used herein, the phrase “comprising at least one of” for a first list is referred broadly to mean: a second list equivalent to “at least one of a list comprising the first list” inclusive of combinations, and “comprising a list of at least one of the first list” inclusive of combinations. For example, a first list of letters is “A, B, and C” and a second list of letters-equivalent to comprising at least one of the first list—may include one or more of: one or more A, one or more B, one or more C, one or more D, one or more Z, and one or more of all combinations of A, B, C, D, and Z.

It is noted that the functional blocks and modules in FIGS. 1-14 may comprise at least one of: processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with one or more central processing units (CPUs), graphics processing units (GPUs), digital signal processors (DSPs), quantum circuits, or custom designed and fabricated application specific integrated circuits (ASICs) configured for ANNs; for example, field programmable gate arrays (FPGAs), vision processing units (VPUs), Tensor processing units (TPUs), and/or a combination of these and other computer components utilized in mobile and/or stationary devices. ANNs may have access to non-volatile memory for storing, logging, troubleshooting, and the like. Input and output capabilities of ANNs may be supplemented by related input-output channels and devices. Instructions for ANNs to initialize, learn, validate, and/or infer may be delivered through one or more input channels. The execution of the commands may occur over the processing units in coordination with RAM and storage to generate and deliver output over one or more output channels.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, DSL, or other mode of transmission are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the above disclosure, processes, machines, manufacture, compositions of matter, means, methods, or steps—presently existing or later to be developed—that perform substantially the same function or achieve substantially the same result as the corresponding embodiments described herein may be utilized. Accordingly, the appended claims are intended to include within their scope such processes, machines, manufacture, compositions of matter, means, methods, or steps.

1-26. (canceled)

27. A learning method comprising:
learning, in a first learning stage, with respect to at least one nondeterministic complexity, by one or more artificial intelligence (AI) construction, at least one first domain exposure,
wherein the at least one nondeterministic complexity is with respect to at least one field use,
wherein the at least one field use is subject to real life,
wherein the at least one nondeterministic complexity comprises at least one multidimensional nonlinear complexity,
wherein the one or more AI construction is configured on at least one processing device,
wherein at least one expert knowledge structure is configured, with respect to the at least one nondeterministic complexity, on the one or more AI construction,
wherein the one or more AI construction, with respect to the at least one expert knowledge structure, is generative, and
wherein the learning in the first learning stage comprises:
configuring, by the at least one processing device, the at least one first domain exposure on the at least one expert knowledge structure;
validating, by the at least one processing device, with respect to the at least one field use, the learning in the first learning stage,
wherein validating the learning in the first learning stage comprises:
validating the at least one first domain exposure, and
validating, based on validating the at least one first domain exposure, the one or more AI construction;
deploying, by the at least one processing device, with respect to the at least one field use, the validated one or more AI construction;
learning, in a second learning stage, by the deployed one or more AI construction, wherein the learning in the second learning stage comprises:
collaborating, with respect to the at least one nondeterministic complexity, among a plurality of third entities,
wherein the plurality of third entities comprises the one or more AI construction and at least one second entity;
differentiating, with respect to the collaborating, by the at least one expert knowledge structure, at least one fact;
representing, by the at least one expert knowledge structure, the differentiated at least one fact in one knowledge structure; and
updating, by the at least one processing device, based on representing the at least one fact in the one knowledge structure, the one or more AI construction; and
mitigating, by the deployed one or more AI construction, based on the learning in the second learning stage, at least one loss with respect to the at least one nondeterministic complexity.

28. The learning method of claim 27,
wherein the collaborating is based on assembling among the plurality of third entities; and
wherein the assembling begins during the at least one field use.

29. The learning method of claim 27,
wherein the collaborating is based on assembling among the plurality of third entities; and
wherein the assembling and the updating occur in real-time.

30. (canceled)

31. (canceled)

32. The learning method of claim 27,
wherein at least one wholistic knowledge structure is configured on the one or more AI construction;
wherein the at least one wholistic knowledge structure comprises the at least one expert knowledge structure; and
wherein the learning method further comprises:
revealing, by the at least one wholistic knowledge structure, with respect to the one knowledge structure, new knowledge,
wherein the new knowledge is generative with respect to the one or more AI construction.

33. (canceled)

34. The learning method of claim 27, further comprising:
increasing dimensionality, by the at least one processing device, based on the learning in the second learning stage, with respect to the at least one first domain exposure; and
mitigating, based on the increased dimensionality, by the at least one processing device, at least one defect regarding one or more confounder.

35. The learning method of claim 27, further comprising:
extending, by the at least one processing device, based on the learning in the second learning stage, the at least one first domain exposure; and
mitigating, based on the extended at least one first domain exposure, by the at least one processing device, at least one defect regarding domain cooperation.

36. The learning method of claim 27, further comprising:
constructing, by the at least one processing device, based on collaborating among the plurality of third entities, at least one domain process regarding the at least one field use, wherein the at least one domain process is fault tolerant.

37. The learning method of claim 27, wherein the at least one second entity is: live, or natural, or combination thereof.

38. The learning method of claim 27, further comprising:
operating, based on at least one second domain exposure, the at least one second entity, wherein at least one ability of the at least one second entity is based on the at least one second domain exposure;
updating, based on the collaborating, the at least one second entity; and
extending, based on updating the at least one second entity, the at least one second domain exposure, wherein the extended at least one second domain exposure represents at least one improvement to the at least one ability.

39-52. (canceled)

53. The learning method of claim 27,
wherein the one or more AI construction is based on at least one artificial neural network; and
wherein the at least one artificial neural network learns the at least one nondeterministic complexity.

54. The learning method of claim 27, wherein at least one first expertise of the deployed one or more AI construction differs substantially from at least one second expertise of the at least one second entity.

55. (canceled)

56. The learning method of claim 27, wherein updating the one or more AI construction is iterative.

57. The learning method of claim 27,
wherein a plurality of layers is configured on the one or more AI construction;
wherein the at least one expert knowledge structure is configured on the plurality of layers; and
wherein the learning in the first learning stage further comprises:
evaluating, by the at least one processing device, at least one error with respect to at least one prediction,
wherein the at least one prediction is with respect to the at least one nondeterministic complexity;
reconciling, with respect to at least one objective, by the at least one processing device, the evaluated at least one error; and
updating, by the at least one processing device, based on the reconciled at least one error, the plurality of layers.

58. The learning method of claim 27, wherein differentiating the at least one fact comprises:
extracting, by the at least one processing device, based on the at least one expert knowledge structure, at least one higher-order relationship,
wherein the at least one higher-order relationship is regarding the at least one field use, and
wherein the extracting comprises:
decomposing at least one map of relationships,
or generalizing at least one map of relationships,
or combination thereof.

59. (canceled)

60. The learning method of claim 27, wherein the collaborating is initiated by the at least one processing device.

61. The learning method of claim 27, further comprising:
adapting, by the updated one or more AI construction, based on collaborating among the plurality of third entities, with respect to at least one competition, as a rational actor, wherein the at least one competition is with respect to the at least one field use.

62. (canceled)

63. The learning method of claim 27, further comprising:
cooperating, by the at least one processing device, with respect to at least one guidance regarding the at least one field use; and
mediating,
by the one or more AI construction,
based on the cooperating,
among the plurality of third entities;
wherein the mediating mitigates at least one loss with respect to the at least one field use.

64. The learning method of claim 27, further comprising:
complying, by the at least one processing device, with respect to at least one directive regarding the at least one field use,
wherein the at least one directive is regarding at least one jurisdiction; and
initiating, by the deployed one or more AI construction, at least one immutable initiative;
wherein the at least one immutable initiative is configured, with respect to the at least one directive, prior to the deploying.

65. The learning method of claim 27, further comprising:
generating, by the deployed one or more AI construction, a plurality of inferences,
wherein generating the plurality of inferences benefits at least one beneficiary,
wherein the at least one beneficiary is with respect to the at least one field use, and
wherein the plurality of inferences comprises:
at least one first inference generated before the learning in the second learning stage
and at least one second inference generated after the learning in the second learning stage.

66. The learning method of claim 27, further comprising:
continually learning, by the deployed one or more AI construction, based on the learning in the second learning stage.

67. An attention learning method comprising:
scoping, by at least one processing device, with respect to at least one nondeterministic complexity, at least one field use,
wherein the at least one nondeterministic complexity is with respect to the at least one field use, and
wherein the at least one nondeterministic complexity comprises at least one multidimensional nonlinear complexity;
assigning, by the at least one processing device, at least one part of at least one first attention to one or more first task,
wherein the at least one first attention is configured on at least one expert knowledge structure,
wherein the at least one expert knowledge structure is configured, with respect to the at least one nondeterministic complexity, on one or more artificial intelligence (AI) construction, and
wherein the one or more AI construction is configured on the at least one processing device;
monitoring, in a first monitoring stage, by the at least one first attention, progressing of the one or more first task with respect to the at least one nondeterministic complexity;
monitoring, in a second monitoring stage, by the at least one first attention, progressing of a plurality of second tasks;
comparing, in a first comparing stage, by the one or more AI construction, the monitoring in the first monitoring stage and the monitoring in the second monitoring stage, wherein the comparing in the first comparing stage comprises:
representing, by the at least one expert knowledge structure, the one or more first task and the plurality of second tasks in one knowledge structure; and
updating, in a first updating stage, by the at least one processing device, based on the comparing in the first comparing stage, the one or more AI construction;
wherein scoping the at least one field use comprises:
sizing, with respect to the at least one field use, the monitoring in the first monitoring stage,
sizing, with respect to the at least one field use, the one or more AI construction,
scoping verification with respect to: the sized monitoring in the first monitoring stage and the sized one or more AI construction, and
scoping, with respect to the at least one field use, validation with respect to: the sized monitoring in the first monitoring stage and the sized one or more AI construction; and
wherein the attention learning method, based on the updating in the first updating stage, enables learning, by the one or more AI construction, based on the at least one first attention.

68. The attention learning method of claim 67,
wherein progressing of the one or more first task, or progressing of the plurality of second tasks, or the comparing in the first comparing stage, or combination thereof is dynamic.

69. The attention learning method of claim 67,
wherein at least one first knowledge structure represents the one or more first task;
wherein at least one second knowledge structure represents the plurality of second tasks;
wherein the at least one first knowledge structure and the at least one second knowledge structure are independent and disparate;
wherein at least one higher-order relationship represents interdependence between progressing of the one or more first task and progressing of the plurality of second tasks; and
wherein the one knowledge structure comprises the at least one higher-order relationship.

70. The attention learning method of claim 67,
wherein configuring the at least one first attention, or assigning the at least one part of the at least one first attention, or configuring the one or more AI construction, or combination thereof is dynamic.

71. The attention learning method of claim 67,
wherein the monitoring in the first monitoring stage, the monitoring in the second monitoring stage, and the comparing in the first comparing stage occur in real-time.

72. The attention learning method of claim 67, further comprising:
validating, with respect to the scoped at least one field use, the monitoring in the first monitoring stage; and
deploying, based on validating the monitoring in the first monitoring stage, the at least one first attention;
wherein the at least one field use, with respect to the deployed at least one first attention, comprises progressing the one or more first task.

73. The attention learning method of claim 67, further comprising:
deploying, based on scoping the at least one field use, the at least one first attention; and
optimizing, by the deployed at least one first attention one or more resource of a basis: volatile memory, or non-volatile memory, or communication bandwidth, or compute, or sensory input, or combination thereof.

74. The attention learning method of claim 67, further comprising:
deploying, based on scoping the at least one field use, the at least one first attention; and
scaling up, by a first ratio, the at least one field use;
wherein scaling up the at least one field use is based on scaling up, by a second ratio, the at least one first attention.

75. The attention learning method of claim 67, further comprising:
deploying, based on scoping the at least one field use, the at least one first attention; and
distributing the deployed at least one first attention based on distributing at least one resource.

76. The attention learning method of claim 67, further comprising:
focusing, based on the at least one expert knowledge structure, the at least one first attention.

77. The attention learning method of claim 67,
wherein the plurality of second tasks is based on one or more natural phenomenon.

78. The attention learning method of claim 67,
wherein the monitoring in the second monitoring stage is based on replay with respect to progressing of the plurality of second tasks.

79-84. (canceled)

85. The attention learning method of claim 67,
wherein the one or more AI construction is based on at least one artificial neural network; and
wherein the at least one first attention is configured on the at least one artificial neural network.

86. The attention learning method of claim 67, further comprising:
allocating, by the at least one processing device, the at least one first attention;
allocating, by the at least one processing device, at least one third attention;
focusing the at least one first attention on the one or more first task;
focusing the at least one third attention on one or more third task; and
coordinating, by the one or more AI construction, allocating the at least one first attention, allocating the at least one third attention, focusing the at least one first attention, and focusing the at least one third attention;
wherein the coordinating enables improvement based on:
concurrent processing, wherein at least one duration of allocating the at least one first attention and at least one duration of allocating the at least one third attention overlap;
or multitasking, wherein at least one duration of focusing the at least one first attention and at least one duration of focusing the at least one third attention overlap;
or transience, wherein allocating the at least one third attention, or focusing the at least one third attention, or combination thereof is transient;
or reprioritizing, wherein the at least one third attention is reallocated to one or more fourth task, wherein a third priority of the one or more third task is lower than a fourth priority of the one or more fourth task;
or at least one context, wherein the at least one context is shared between the at least one first attention and the at least one third attention;
or adapting to the at least one field use, by the one or more AI construction, wherein the coordinating is dynamic;
or combination thereof.

87. (canceled)

88. The attention learning method of claim 67,
wherein at least one wholistic knowledge structure is configured on the one or more AI construction;
wherein the at least one wholistic knowledge structure comprises the at least one expert knowledge structure; and
wherein the attention learning method further comprises:
revealing, by the at least one wholistic knowledge structure, with respect to the one knowledge structure, new knowledge,
wherein the new knowledge is generative with respect to the one or more AI construction.

89. (canceled)

90. The attention learning method of claim 67, further comprising:
learning, in a first learning stage, by the one or more AI construction, repurposing, or redistributing, or reassigning, or combination thereof of the at least one part of the at least one first attention;
wherein the learning in the first learning stage enables overcoming one or more resource limitation.

91. The attention learning method of claim 67, further comprising:
monitoring, in a third monitoring stage, progressing of at least one third task;
monitoring, in a fourth monitoring stage, by the at least one first attention, the monitoring in the third monitoring stage;
comparing, in a second comparing stage, by the one or more AI construction, the monitoring in the third monitoring stage and the monitoring in the fourth monitoring stage; and
updating, in a second updating stage, based on the comparing in the second comparing stage, the at least one first attention;
wherein the updating in the second updating stage improves at least one efficacy of the at least one first attention.

92. The attention learning method of claim 91, further comprising:
monitoring, in a fifth monitoring stage, by the at least one first attention updated in the second updating stage, progressing of the one or more first task with respect to the at least one nondeterministic complexity;
monitoring, in a sixth monitoring stage, by the at least one first attention updated in the second updating stage, progressing of the plurality of second tasks;
comparing, in a third comparing stage, by the one or more AI construction, the monitoring in the fifth monitoring stage and the monitoring in the sixth monitoring stage; and
updating, in a third updating stage, based on the comparing in the third comparing stage, the one or more AI construction updated in the first updating stage.

93. A collective learning method comprising:
receiving, by at least one third entity, one or more third observation regarding at least one loss,
wherein the at least one loss is regarding at least one collective with respect to at least one field use,
wherein at least one nondeterministic complexity is with respect to the at least one field use,
wherein the at least one nondeterministic complexity comprises at least one multidimensional nonlinear complexity,
wherein at least one expert knowledge structure is configured on a plurality of layers,
wherein the plurality of layers is configured on one or more artificial intelligence (AI) construction,
wherein the one or more AI construction is configured on at least one processing device,
wherein the at least one collective comprises a plurality of first entities,
wherein the plurality of first entities comprises at least one second entity and the at least one third entity, and
wherein the at least one third entity is driven, with respect to the at least one field use, by the at least one expert knowledge structure;
learning, in a first learning stage, by the one or more AI construction, with respect to the at least one nondeterministic complexity, comprising:
evaluating, by the at least one processing device, at least one error with respect to at least one prediction,
wherein the at least one prediction is with respect to the at least one nondeterministic complexity;
reconciling, with respect to at least one objective, by the at least one processing device, the evaluated at least one error;
updating, by the at least one processing device, based on the reconciled at least one error, the plurality of layers; and
representing, based on the updating, by the at least one expert knowledge structure, the at least one nondeterministic complexity in one knowledge structure;
generating, with respect to the at least one expert knowledge structure, based on the one knowledge structure, by the at least one third entity, one or more third intelligence;
learning, in a second learning stage, by the one or more AI construction, comprising:
differentiating, based on receiving the one or more third observation, with respect to the at least one collective and the at least one field use, by the at least one expert knowledge structure, at least one fact;
representing, by the at least one expert knowledge structure, the differentiated at least one fact in the one knowledge structure; and
updating, in a first updating stage, based on representing the at least one fact in the one knowledge structure, the one or more third intelligence;
learning, in a third learning stage, with respect to the at least one collective and the at least one field use, by the at least one collective, comprising:
exchanging, among the plurality of first entities, one or more second intelligence and the one or more third intelligence,
wherein the one or more second intelligence is generated by the at least one second entity;
extracting, by the at least one processing device, based on the exchanging, one or more first intelligence;
propagating, among the at least one collective, by the at least one processing device, the extracted one or more first intelligence;
counteracting, by at least one part of the at least one collective, based on propagating the one or more first intelligence, the at least one loss; and
updating, in a second updating stage, by the at least one processing device, based on counteracting the at least one loss, the one or more third intelligence; and
mitigating, based on the learning in the second learning stage and the learning in the third learning stage, the at least one loss with respect to the at least one nondeterministic complexity.

94. The collective learning method of claim 93,
wherein at least one wholistic knowledge structure is configured on the one or more AI construction;
wherein the at least one wholistic knowledge structure comprises the at least one expert knowledge structure; and
wherein the collective learning method further comprises:
revealing, by the at least one wholistic knowledge structure, with respect to the one knowledge structure, new knowledge,
wherein the new knowledge is generative with respect to the one or more AI construction.

95. (canceled)

96. The collective learning method of claim 93, further comprising:
deploying, with respect to the at least one field use, the one or more AI construction; and
adapting, by the at least one collective, based on the learning in the third learning stage, to the at least one field use;
wherein the learning in the third learning stage and the learning in the second learning stage are with respect to the deployed AI construction.

97. The collective learning method of claim 93,
wherein the plurality of first entities, or the at least one second entity, or the at least one collective represents at least one crowd;
wherein the exchanging, or the propagating, or the counteracting, or combination thereof is based on sampling subject to: competition, or randomization, or combination thereof; and
wherein the learning in the third learning stage, based on the at least one crowd and the sampling, enables:
improvement regarding wisdom of crowds;
or improvement regarding consensus, regarding the at least one loss, of the at least one crowd;
or improvement regarding control, based on the at least one expert knowledge structure, regarding the at least one crowd;
or combination thereof.

98. The collective learning method of claim 93,
wherein the exchanging, or the propagating, or the counteracting, or combination thereof is subject to one or more structure of a basis:
hierarchical, or stepwise, or combination thereof; and
wherein the learning in the third learning stage, based on the one or more structure, enables:
at least one structure regarding benefit allocation,
or at least one structure regarding the at least one collective,
or combination thereof.

99. The collective learning method of claim 93, wherein the exchanging, the extracting, the propagating, the counteracting, and the updating in the second updating stage occur in real-time.

100. The collective learning method of claim 93, wherein the duration of the learning in the second learning stage and the duration of the learning in the third learning stage overlap.

101. The collective learning method of claim 93,
wherein the at least one collective is at least one swarm; and
wherein the learning in the third learning stage improves at least one intelligence of the at least one swarm.

102. The collective learning method of claim 93,
wherein the one or more AI construction is based on at least one artificial neural network; and
wherein the at least one artificial neural network learns the at least one nondeterministic complexity.

103. The collective learning method of claim 93, wherein the at least one loss is based on one or more competition, or one or more malicious activity, or combination thereof.

104. The collective learning method of claim 93, wherein the at least one field use is subject to real life.

105. The attention learning method of claim 67, wherein the at least one field use is subject to real life.

106. The attention learning method of claim 92, further comprising:
updating, in a fourth updating stage, based on the comparing in the third comparing stage, the updating in the first updating stage,
wherein the updating in the fourth updating stage enables learning to learn regarding the attention learning method.

107. The attention learning method of claim 67, further comprising:
deploying, with respect to the at least one field use, based on scoping the at least one field use, the one or more AI construction; and
mitigating, by the deployed one or more AI construction, based on the updating in the first updating stage, at least one loss with respect to the at least one nondeterministic complexity;
wherein the at least one field use, with respect to the deployed one or more AI construction, comprises progressing the one or more first task.

108. The attention learning method of claim 67,
wherein the monitoring in the first monitoring stage, or the monitoring in the second monitoring stage, or combination thereof is normalized.

109. The attention learning method of claim 67,
wherein a plurality of layers is configured on the one or more AI construction;
wherein the at least one expert knowledge structure is configured on the plurality of layers; and
wherein the attention learning method further comprises:
learning, in a first learning stage, with respect to the at least one nondeterministic complexity, by the one or more AI construction, comprising:
evaluating, by the at least one processing device, at least one error with respect to at least one prediction,
wherein the at least one prediction is with respect to the at least one nondeterministic complexity;
reconciling, with respect to at least one objective, by the at least one processing device, the evaluated at least one error, and
updating, by the at least one processing device, based on the reconciled at least one error, the plurality of layers.

110. The attention learning method of claim 67, further comprising:
continually learning, by the one or more AI construction, based on the updating in the first updating stage, with respect to the at least one field use.

111. The attention learning method of claim 67,
wherein scoping the at least one field use further comprises:
scoping at least one first context
and scoping, with respect to the scoped at least one first context, at least one service;
wherein the attention learning method further comprises:
deploying, with respect to the scoped at least one first context, the scoped at least one service;
wherein the at least one service comprises:
receiving, with respect to the at least one first context, by the one or more AI construction, at least one first query;
providing, by the one or more AI construction, based on receiving the at least one first query, at least one first response;
receiving, with respect to the at least one first context, by the one or more AI construction, based on providing the at least one first response, at least one second query;
comparing, in a second comparing stage, by the one or more AI construction, with respect to the at least one expert knowledge structure, the received at least one second query against the provided at least one first response with respect to the received at least one first query; and
updating, by the one or more AI construction, based on the comparing in the second comparing stage, the at least one first response; and
wherein updating the at least one first response enables learning in the at least one first context.

112. The attention learning method of claim 111, wherein the at least one first context is transient.

113. The attention learning method of claim 111, further comprising:
updating, based on the comparing in the second comparing stage, the at least one expert knowledge structure.

114. The attention learning method of claim 67, further comprising:
deploying, based on scoping the at least one field use, at least one service;
wherein the at least one service comprises:
receiving, by the one or more AI construction, at least one first query;
evaluating, by the one or more AI construction, with respect to the at least one expert knowledge structure, based on receiving the at least one first query, at least one first proposed response;
detecting, by the at least one processing device, based on evaluating the at least one first proposed response, at least one inconsistency; and
verifying, by the one or more AI construction, based on detecting the at least one inconsistency, the at least one inconsistency.

115. The attention learning method of claim 114, wherein verifying the at least one inconsistency comprises:
evaluating, by the one or more AI construction, with respect to the at least one expert knowledge structure, at least one second query, wherein at least one consistency between the received at least one first query and the evaluated at least one second query represents at least one fact with respect to the at least one field use; and
evaluating, by the one or more AI construction, with respect to the at least one expert knowledge structure, based on the evaluated at least one second query, at least one second proposed response.

116. The attention learning method of claim 115,
wherein at least one first confidence level is correlated to the at least one second query with respect to the at least one fact;
wherein at least one second confidence level is evaluated, based on the at least one first confidence level, with respect to evaluating the at least one second proposed response; and
wherein the attention learning method enables probabilistic verifying.

117. The attention learning method of claim 114, wherein detecting the at least one inconsistency is based on: the plurality of second tasks, or at least one metamorphic relationship, or at least one semantic reasoner, or combination thereof.

118. The attention learning method of claim 114, wherein verifying the at least one inconsistency is based on: the plurality of second tasks, or at least one metamorphic relationship, or at least one semantic reasoner, or combination thereof.

119. The attention learning method of claim 114, wherein the at least one service further comprises:
evaluating, with respect to the at least one expert knowledge structure and the at least one first proposed response, based on verifying the at least one inconsistency, at least one first response; and
providing the evaluated at least one first response;
wherein the at least one first response comprises at least one justification based on: receiving the at least one first query, or evaluating the at least one first proposed response, or detecting the at least one inconsistency, or verifying the at least one inconsistency, or evaluating the at least one first response, or combination thereof.

120. The attention learning method of claim 114,
wherein verifying the at least one inconsistency represents at least one initiative by the one or more AI construction; and
wherein the at least one service further comprises:
mitigating, by the one or more AI construction, based on verifying the at least one inconsistency, at least one loss based on: at least one misconception, or at least one malicious act, or combination thereof.

121. The attention learning method of claim 67, further comprising:
deploying, based on scoping the at least one field use, at least one service;
wherein the at least one service comprises:
receiving, by the one or more AI construction, at least one first query; and
providing, by the one or more AI construction, based on receiving the at least one first query, at least one first response,
wherein the at least one first response comprises at least one map of reasoning and at least one justification,
wherein the at least one justification is with respect to the at least one map of reasoning, and
wherein the at least one map of reasoning and the at least one justification are evaluated with respect to the at least one expert knowledge structure; and
wherein the at least one map of reasoning and the at least one justification enable stepwise reasoning.

122. The attention learning method of claim 121, wherein the at least one map of reasoning comprises:
at least one statement logically derived with respect to the at least one first query.

123. The attention learning method of claim 121, wherein the at least one justification is with respect to reasoning based on:
at least one metamorphic relation,
or diversity of expertise with respect to the at least one expert knowledge structure,
or semantic reasoning,
or combination thereof.

124. The attention learning method of claim 67, further comprising:
deploying, based on scoping the at least one field use, at least one service;
wherein the at least one service comprises:
receiving, by the one or more AI construction, at least one first query;
providing, by the one or more AI construction, based on receiving the at least one first query, at least one first response,
wherein the at least one first response comprises at least one map of reasoning and at least one justification,
wherein the at least one justification is with respect to the at least one map of reasoning, and
wherein the at least one map of reasoning and the at least one justification are evaluated with respect to the at least one expert knowledge structure;
receiving, by the one or more AI construction, based on providing the at least one first response, with respect to the at least one map of reasoning, at least one instruction; and
reevaluating, by the one or more AI construction, based on:
receiving the at least one instruction
and the at least one expert knowledge structure,
the at least one map of reasoning; and
wherein the reevaluating enables instruction-following by the one or more AI construction.

125. The attention learning method of claim 67, further comprising:
deploying, based on scoping the at least one field use, at least one service;
wherein the at least one service comprises:
receiving, by the one or more AI construction, at least one first query, wherein the at least one first query comprises at least one instruction; and
providing, by the one or more AI construction, based on receiving the at least one first query, at least one first response,
wherein the at least one first response comprises compliance with respect to the at least one instruction; and
wherein the compliance enables instruction-following by the one or more AI construction.

126. The attention learning method of claim 125, wherein the compliance with respect to the at least one instruction comprises at least one change with respect to:
at least one response,
or at least one context,
or at least one behavior,
or combination thereof.

127. The attention learning method of claim 67, further comprising:
deploying, based on scoping the at least one field use, at least one service;
wherein the at least one service comprises:
receiving, by the one or more AI construction, at least one first query, wherein the at least one first query comprises at least one instruction; and
providing, by the one or more AI construction, at least one proposal with respect to the at least one instruction,
wherein the at least one proposal is evaluated with respect to the at least one expert knowledge structure, and
wherein the at least one proposal comprises:
at least one alternative
or at least one alternative and at least one justification.

128. The attention learning method of claim 127, wherein providing the at least one proposal is based on at least one rationality.

129. The learning method of claim 27:
wherein deploying the validated one or more AI construction comprises:
deploying, with respect to the at least one field use, at least one first context;
wherein the collaborating further comprises:
interacting, by the deployed one or more AI construction, with the at least one second entity,
wherein the interacting comprises:
receiving, with respect to the at least one first context, by the one or more AI construction, from the at least one second entity, at least one first query;
providing, by the one or more AI construction, based on receiving the at least one first query, at least one first response;
receiving, with respect to the at least one first context, by the one or more AI construction, based on providing the at least one first response, at least one second query;
comparing, by the one or more AI construction, with respect to the at least one expert knowledge structure, the received at least one second query against the provided at least one first response with respect to the received at least one first query; and
updating, by the one or more AI construction, based on the comparing, the at least one first response; and
wherein updating the at least one first response enables learning in the at least one first context.

130. The learning method of claim 129, wherein the deployed at least one first context is transient.

131. The learning method of claim 129, further comprising:
updating, based on the comparing, the at least one expert knowledge structure.

132. The learning method of claim 27, wherein the collaborating further comprises:
interacting, by the deployed one or more AI construction, with the at least one second entity,
wherein the interacting comprises:
receiving, by the one or more AI construction, from the at least one second entity, at least one first query;
evaluating, by the one or more AI construction, with respect to the at least one expert knowledge structure, based on receiving the at least one first query, at least one first proposed response;
detecting, by the at least one processing device, based on evaluating the at least one first proposed response, at least one inconsistency; and
verifying, by the one or more AI construction, based on detecting the at least one inconsistency, the at least one inconsistency.

133. The learning method of claim 132, wherein verifying the at least one inconsistency comprises:
evaluating, by the one or more AI construction, with respect to the at least one expert knowledge structure, at least one second query, wherein at least one consistency between the received at least one first query and the evaluated at least one second query represents at least one fact with respect to the at least one field use; and
evaluating, by the one or more AI construction, with respect to the at least one expert knowledge structure, based on the evaluated at least one second query, at least one second proposed response.

134. The learning method of claim 133,
wherein at least one first confidence level is correlated to the at least one second query with respect to the at least one fact;
wherein at least one second confidence level is evaluated, based on the at least one first confidence level, with respect to evaluating the at least one second proposed response; and
wherein the learning method enables probabilistic verifying.

135. The learning method of claim 132, wherein detecting the at least one inconsistency is based on: at least one metamorphic relationship, or at least one semantic reasoner, or combination thereof.

136. The learning method of claim 132, wherein verifying the at least one inconsistency is based on: at least one metamorphic relationship, or at least one semantic reasoner, or combination thereof.

137. The learning method of claim 132, wherein the interacting further comprises:
evaluating, with respect to the at least one expert knowledge structure and the at least one first proposed response, based on verifying the at least one inconsistency, at least one first response; and
providing the evaluated at least one first response;
wherein the at least one first response comprises at least one justification based on: receiving the at least one first query, or evaluating the at least one first proposed response, or detecting the at least one inconsistency, or verifying the at least one inconsistency, or evaluating the at least one first response, or combination thereof.

138. The learning method of claim 132,
wherein verifying the at least one inconsistency represents at least one initiative by the one or more AI construction; and
wherein the interacting further comprises:
mitigating, by the one or more AI construction, based on verifying the at least one inconsistency, at least one loss based on: at least one misconception, or at least one malicious act, or combination thereof.

139. The learning method of claim 27, wherein the collaborating further comprises:
interacting, by the deployed one or more AI construction, with the at least one second entity,
wherein the interacting comprises:
receiving, by the one or more AI construction, from the at least one second entity, at least one first query; and
providing, by the one or more AI construction, based on receiving the at least one first query, at least one first response,
wherein the at least one first response comprises at least one map of reasoning and at least one justification,
wherein the at least one justification is with respect to the at least one map of reasoning, and
wherein the at least one map of reasoning and the at least one justification are evaluated with respect to the at least one expert knowledge structure;
wherein the at least one map of reasoning and the at least one justification enable stepwise reasoning.

140. The learning method of claim 139, wherein the at least one map of reasoning comprises:
at least one statement logically derived with respect to the at least one first query.

141. The learning method of claim 139, wherein the at least one justification is with respect to reasoning based on:
at least one metamorphic relation,
or diversity of expertise with respect to the at least one expert knowledge structure,
or semantic reasoning,
or combination thereof.

142. The learning method of claim 27, wherein the collaborating further comprises:
interacting, by the deployed one or more AI construction, with the at least one second entity,
wherein the interacting comprises:
receiving, by the one or more AI construction, from the at least one second entity, at least one first query;
providing, by the one or more AI construction, based on receiving the at least one first query, at least one first response,
wherein the at least one first response comprises at least one map of reasoning and at least one justification,
wherein the at least one justification is with respect to the at least one map of reasoning, and
wherein the at least one map of reasoning and the at least one justification are evaluated with respect to the at least one expert knowledge structure;
receiving, by the one or more AI construction, based on providing the at least one first response, with respect to the at least one map of reasoning, at least one instruction; and
reevaluating, by the one or more AI construction, based on:
receiving the at least one instruction
and the at least one expert knowledge structure,
the at least one map of reasoning;
wherein the reevaluating enables instruction-following by the one or more AI construction.

143. The learning method of claim 27, wherein the collaborating further comprises:
interacting, by the deployed one or more AI construction, with the at least one second entity,
wherein the interacting comprises:
receiving, by the one or more AI construction, from the at least one second entity, at least one first query, wherein the at least one first query comprises at least one instruction; and
providing, by the one or more AI construction, based on receiving the at least one first query, at least one first response,
wherein the at least one first response comprises compliance with respect to the at least one instruction;
wherein the compliance enables instruction-following by the one or more AI construction.

144. The learning method of claim 143, wherein the compliance with respect to the at least one instruction comprises at least one change with respect to:
at least one response,
or at least one context,
or at least one behavior,
or combination thereof.

145. The learning method of claim 27, wherein the collaborating further comprises:
interacting, by the deployed one or more AI construction, with the at least one second entity,
wherein the interacting comprises:
receiving, by the one or more AI construction, from the at least one second entity, at least one first query, wherein the at least one first query comprises at least one instruction; and
providing, by the one or more AI construction, at least one proposal with respect to the at least one instruction,
wherein the at least one proposal is evaluated with respect to the at least one expert knowledge structure, and
wherein the at least one proposal comprises:
at least one alternative
or at least one alternative and at least one justification.

146. The learning method of claim 145, wherein providing the at least one proposal is based on at least one rationality.

147. The collective learning method of claim 93, further comprising:
deploying, by the at least one processing device, with respect to the at least one field use, the one or more AI construction,
wherein deploying the one or more AI construction comprises:
deploying, with respect to the at least one field use, at least one first context;
wherein the learning in the third learning stage further comprises:
interacting, by the deployed one or more AI construction, with at least one entity,
wherein the exchanging, or the propagating, or combination thereof is based on the interacting;
wherein the interacting comprises:
receiving, with respect to the at least one first context, by the one or more AI construction, from the at least one entity, at least one first query;
providing, by the one or more AI construction, based on receiving the at least one first query, at least one first response;
receiving, with respect to the at least one first context, by the one or more AI construction, based on providing the at least one first response, at least one second query;
comparing, by the one or more AI construction, with respect to the at least one expert knowledge structure, the received at least one second query against the provided at least one first response with respect to the received at least one first query; and
updating, by the one or more AI construction, based on the comparing, the at least one first response; and
wherein updating the at least one first response enables learning in the at least one first context.

148. The collective learning method of claim 147, wherein the deployed at least one first context is transient.

149. The collective learning method of claim 147, further comprising:
updating, based on the comparing, the at least one expert knowledge structure.

150. The collective learning method of claim 93, further comprising:
deploying, by the at least one processing device, with respect to the at least one field use, the one or more AI construction;
wherein the learning in the third learning stage further comprises:
interacting, by the deployed one or more AI construction, with at least one entity,
wherein the exchanging, or the propagating, or combination thereof is based on the interacting;
wherein the interacting comprises:
receiving, by the one or more AI construction, from the at least one entity, at least one first query;
evaluating, by the one or more AI construction, with respect to the at least one expert knowledge structure, based on receiving the at least one first query, at least one first proposed response;
detecting, by the at least one processing device, based on evaluating the at least one first proposed response, at least one inconsistency; and
verifying, by the one or more AI construction, based on detecting the at least one inconsistency, the at least one inconsistency.

151. The collective learning method of claim 150, wherein verifying the at least one inconsistency comprises:
evaluating, by the one or more AI construction, with respect to the at least one expert knowledge structure, at least one second query, wherein at least one consistency between the received at least one first query and the evaluated at least one second query represents at least one fact with respect to the at least one field use; and
evaluating, by the one or more AI construction, with respect to the at least one expert knowledge structure, based on the evaluated at least one second query, at least one second proposed response.

152. The collective learning method of claim 151,
wherein at least one first confidence level is correlated to the at least one second query with respect to the at least one fact;
wherein at least one second confidence level is evaluated, based on the at least one first confidence level, with respect to evaluating the at least one second proposed response; and
wherein the collective learning method enables probabilistic verifying.

153. The collective learning method of claim 150, wherein detecting the at least one inconsistency is based on: at least one collective intelligence, or at least one metamorphic relationship, or at least one semantic reasoner, or combination thereof.

154. The collective learning method of claim 150, wherein verifying the at least one inconsistency is based on: at least one collective intelligence, or at least one metamorphic relationship, or at least one semantic reasoner, or combination thereof.

155. The collective learning method of claim 150, wherein the interacting further comprises:
evaluating, with respect to the at least one expert knowledge structure and the at least one first proposed response, based on verifying the at least one inconsistency, at least one first response; and
providing the evaluated at least one first response;
wherein the at least one first response comprises at least one justification based on: receiving the at least one first query, or evaluating the at least one first proposed response, or detecting the at least one inconsistency, or verifying the at least one inconsistency, or evaluating the at least one first response, or combination thereof.

156. The collective learning method of claim 150,
wherein verifying the at least one inconsistency represents at least one initiative by the one or more AI construction; and
wherein the interacting further comprises:
mitigating, by the one or more AI construction, based on verifying the at least one inconsistency, at least one loss based on: at least one misconception, or at least one malicious act, or combination thereof.

157. The collective learning method of claim 93, further comprising:
deploying, by the at least one processing device, with respect to the at least one field use, the one or more AI construction;
wherein the learning in the third learning stage further comprises:
interacting, by the deployed one or more AI construction, with at least one entity,
wherein the exchanging, or the propagating, or combination thereof is based on the interacting;
wherein the interacting comprises:
receiving, by the one or more AI construction, from the at least one entity, at least one first query; and
providing, by the one or more AI construction, based on receiving the at least one first query, at least one first response,
wherein the at least one first response comprises at least one map of reasoning and at least one justification,
wherein the at least one justification is with respect to the at least one map of reasoning, and
wherein the at least one map of reasoning and the at least one justification are evaluated with respect to the at least one expert knowledge structure; and
wherein the at least one map of reasoning and the at least one justification enable stepwise reasoning.

158. The collective learning method of claim 157, wherein the at least one map of reasoning comprises:
at least one statement logically derived with respect to the at least one first query.

159. The collective learning method of claim 157, wherein the at least one justification is with respect to reasoning based on:
at least one metamorphic relation,
or diversity of expertise with respect to the at least one expert knowledge structure,
or semantic reasoning,
or combination thereof.

160. The collective learning method of claim 93, further comprising:
deploying, by the at least one processing device, with respect to the at least one field use, the one or more AI construction;
wherein the learning in the third learning stage further comprises:
interacting, by the deployed one or more AI construction, with at least one entity,
wherein the exchanging, or the propagating, or combination thereof is based on the interacting;
wherein the interacting comprises:
receiving, by the one or more AI construction, from the at least one entity, at least one first query;
providing, by the one or more AI construction, based on receiving the at least one first query, at least one first response,
wherein the at least one first response comprises at least one map of reasoning and at least one justification,
wherein the at least one justification is with respect to the at least one map of reasoning, and
wherein the at least one map of reasoning and the at least one justification are evaluated with respect to the at least one expert knowledge structure;
receiving, by the one or more AI construction, based on providing the at least one first response, with respect to the at least one map of reasoning, at least one instruction; and
reevaluating, by the one or more AI construction, based on:
receiving the at least one instruction
and the at least one expert knowledge structure,
the at least one map of reasoning; and
wherein the reevaluating enables instruction-following by the one or more AI construction.

161. The collective learning method of claim 93, further comprising:
deploying, by the at least one processing device, with respect to the at least one field use, the one or more AI construction;
wherein the learning in the third learning stage further comprises:
interacting, by the deployed one or more AI construction, with at least one entity,
wherein the exchanging, or the propagating, or combination thereof is based on the interacting;
wherein the interacting comprises:
receiving, by the one or more AI construction, from the at least one entity, at least one first query, wherein the at least one first query comprises at least one instruction; and
providing, by the one or more AI construction, based on receiving the at least one first query, at least one first response,
wherein the at least one first response comprises compliance with respect to the at least one instruction; and
wherein the compliance enables instruction-following by the one or more AI construction.

162. The collective learning method of claim 161, wherein the compliance with respect to the at least one instruction comprises at least one change with respect to:
at least one response,
or at least one context,
or at least one behavior,
or combination thereof.

163. The collective learning method of claim 93, further comprising:
deploying, by the at least one processing device, with respect to the at least one field use, the one or more AI construction;
wherein the learning in the third learning stage further comprises:
interacting, by the deployed one or more AI construction, with at least one entity,
wherein the exchanging, or the propagating, or combination thereof is based on the interacting;
wherein the interacting comprises:
receiving, by the one or more AI construction, from the at least one entity, at least one first query, wherein the at least one first query comprises at least one instruction; and
providing, by the one or more AI construction, at least one proposal with respect to the at least one instruction,
wherein the at least one proposal is evaluated with respect to the at least one expert knowledge structure, and
wherein the at least one proposal comprises:
at least one alternative
or at least one alternative and at least one justification.

164. The collective learning method of claim 163, wherein providing the at least one proposal is based on at least one rationality.

165. The learning method of claim 57,
wherein the learning in the first learning stage further comprises:
learning, in a third learning stage, comprising:
iterating, by the at least one processing device, with respect to at least one first objective, a plurality of sequences based on: the evaluating, the reconciling, and updating the plurality of layers,
wherein the plurality of sequences is with respect to a plurality of attention structures; and
transforming, by the at least one processing device, with respect to the at least one first objective, based on the iterating, at least one higher-order aspect of the at least one nondeterministic complexity into at least one representation of the at least one higher-order aspect,
wherein the at least one nondeterministic complexity is represented by at least one first probability distribution, and
wherein the at least one first probability distribution comprises the at least one representation of the at least one higher-order aspect;
wherein the at least one first objective represents the at least one objective with respect to unsupervised learning; and
wherein the learning in the third learning stage represents unsupervised generative learning with respect to the at least one first probability distribution; and
learning, in a fourth learning stage, based on the learning in the third learning stage, comprising:
fine tuning, by the at least one processing device, with respect to at least one second objective, the at least one first probability distribution,
wherein the at least one second objective represents the at least one objective with respect to supervised fine tuning regarding the at least one field use, and
wherein the learning in the fourth learning stage represents supervised fine tuning regarding the at least one field use; and
wherein the one or more AI construction represents at least one generative transformer AI.

166. The learning method of claim 165,
wherein the at least one nondeterministic complexity is represented by at least one second probability distribution;
wherein the learning in the first learning stage further comprises:
learning, in a fifth learning stage, comprising:
optimizing, with respect to at least one third objective, by: the evaluating, the reconciling, and updating the plurality of layers, the at least one second probability distribution,
wherein the at least one third objective represents the at least one objective regarding the at least one field use,
wherein the optimizing is based on: introduction of noise and reduction of noise, and
wherein the fine-tuned at least one first probability distribution and the optimized at least one second probability distribution are interrelated;
wherein the one or more AI construction represents at least one generative probabilistic AI and the at least one generative transformer AI; and
wherein the one knowledge structure is based on the fine-tuned at least one first probability distribution and the optimized at least one second probability distribution.

167. The learning method of claim 166, further comprising:
diversifying, based on the at least one generative transformer AI and the at least one generative probabilistic AI, at least one expertise with respect to the at least one expert knowledge structure.

168. The learning method of claim 166,
wherein at least one wholistic knowledge structure comprises the at least one expert knowledge structure;
wherein the at least one wholistic knowledge structure is configured on the one or more AI construction; and
wherein the learning in the second learning stage further comprises:
automatically identifying, by the at least one wholistic knowledge structure, based on the one knowledge structure, at least one new goal; and
initiating, by the at least one processing device, at least one action with respect to the automatically identified at least one new goal;
wherein initiating the at least one action is with respect to at least one initiative by the at least one wholistic knowledge structure.

169. The learning method of claim 168,
wherein the at least one initiative is of a basis comprising:
soliciting information,
or exploring,
or searching information sources over external network communications,
or seeking permission,
or combination thereof.

170. The learning method of claim 168, wherein the at least one action is of a basis comprising generative intelligence.

171. The collective learning method of claim 93,
wherein the learning in the first learning stage further comprises:
learning, in a fourth learning stage, comprising:
iterating, by the at least one processing device, with respect to at least one first objective, a plurality of sequences based on: the evaluating, the reconciling, and updating the plurality of layers,
wherein the plurality of sequences is with respect to a plurality of attention structures; and
transforming, by the at least one processing device, with respect to the at least one first objective, based on the iterating, at least one higher-order aspect of the at least one nondeterministic complexity into at least one representation of the at least one higher-order aspect,
wherein the at least one nondeterministic complexity is represented by at least one first probability distribution, and
wherein the at least one first probability distribution comprises the at least one representation of the at least one higher-order aspect;
wherein the at least one first objective represents the at least one objective with respect to unsupervised learning; and
wherein the learning in the fourth learning stage represents unsupervised generative learning with respect to the at least one first probability distribution; and
learning, in a fifth learning stage, based on the learning in the fourth learning stage, comprising:
fine tuning, by the at least one processing device, with respect to at least one second objective, the at least one first probability distribution,
wherein the at least one second objective represents the at least one objective with respect to supervised fine tuning regarding the at least one field use, and
wherein the learning in the fifth learning stage represents supervised fine tuning regarding the at least one field use;
wherein the one or more AI construction represents at least one generative transformer AI; and
wherein the one knowledge structure is based on the fine-tuned at least one first probability distribution.

172. The collective learning method of claim 171, further comprising:
diversifying, based on the at least one generative transformer AI, at least one expertise with respect to the at least one expert knowledge structure.

173. The collective learning method of claim 171,
wherein at least one wholistic knowledge structure comprises the at least one expert knowledge structure;
wherein the at least one wholistic knowledge structure is configured on the one or more AI construction; and
wherein the learning in the second learning stage further comprises:
automatically identifying, by the at least one wholistic knowledge structure, based on the one knowledge structure, at least one new goal; and
initiating, by the at least one processing device, at least one action with respect to the automatically identified at least one new goal;
wherein initiating the at least one action is with respect to at least one initiative by the at least one wholistic knowledge structure.

174. The collective learning method of claim 173,
wherein the at least one initiative is of a basis comprising:
soliciting information,
or exploring,
or searching information sources over external network communications,
or seeking permission,
or combination thereof.

175. The collective learning method of claim 173, wherein the at least one action is of a basis comprising generative intelligence.

176. The collective learning method of claim 93,
wherein the at least one nondeterministic complexity is represented by at least one second probability distribution;
wherein the learning in the first learning stage further comprises:
learning, in a sixth learning stage, comprising:
optimizing, with respect to at least one third objective, by: the evaluating, the reconciling, and updating the plurality of layers, the at least one second probability distribution,
wherein the at least one third objective represents the at least one objective regarding the at least one field use, and
wherein the optimizing is based on: introduction of noise and reduction of noise;
wherein the one or more AI construction represents at least one generative probabilistic AI; and
wherein the one knowledge structure is based on the optimized at least one second probability distribution.

177. The collective learning method of claim 176, further comprising:
diversifying, based on the at least one generative probabilistic AI, at least one expertise with respect to the at least one expert knowledge structure.

178. The attention learning method of claim 109,
wherein the learning in the first learning stage further comprises:
learning, in a second learning stage, comprising:
iterating, by the at least one processing device, with respect to at least one first objective, a plurality of sequences based on: the evaluating, the reconciling, and updating the plurality of layers,
wherein the plurality of sequences is with respect to a plurality of attention structures; and
transforming, by the at least one processing device, with respect to the at least one first objective, based on the iterating, at least one higher-order aspect of the at least one nondeterministic complexity into at least one representation of the at least one higher-order aspect,
wherein the at least one nondeterministic complexity is represented by at least one first probability distribution, and
wherein the at least one first probability distribution comprises the at least one representation of the at least one higher-order aspect;
wherein the at least one first objective represents the at least one objective with respect to unsupervised learning, and
wherein the learning in the second learning stage represents unsupervised generative learning with respect to the at least one first probability distribution; and
learning, in a third learning stage, based on the learning in the second learning stage, comprising:
fine tuning, by the at least one processing device, with respect to at least one second objective, the at least one first probability distribution,
wherein the at least one second objective represents the at least one objective with respect to supervised fine tuning regarding the at least one field use, and
wherein the learning in the third learning stage represents supervised fine tuning regarding the at least one field use;
wherein the one or more AI construction represents at least one generative transformer AI.

179. The attention learning method of claim 178,
wherein the at least one nondeterministic complexity is represented by at least one second probability distribution;
wherein the learning in the first learning stage further comprises:
learning, in a fourth learning stage, comprising:
optimizing, with respect to at least one third objective, by: the evaluating, the reconciling, and updating the plurality of layers, the at least one second probability distribution,
wherein the at least one third objective represents the at least one objective regarding the at least one field use,
wherein the optimizing is based on: introduction of noise and reduction of noise, and
wherein the fine-tuned at least one first probability distribution and the optimized at least one second probability distribution are interrelated;
wherein the one or more AI construction represents at least one generative probabilistic AI and the at least one generative transformer AI; and
wherein the one knowledge structure is based on the fine-tuned at least one first probability distribution and the optimized at least one second probability distribution.

180. The attention learning method of claim 179, further comprising:
diversifying, based on the at least one generative transformer AI and the at least one generative probabilistic AI, at least one expertise with respect to the at least one expert knowledge structure.

181. The attention learning method of claim 179,
wherein at least one wholistic knowledge structure comprises the at least one expert knowledge structure;
wherein the at least one wholistic knowledge structure is configured on the one or more AI construction; and
wherein the attention learning method further comprises:
automatically identifying, by the at least one wholistic knowledge structure, based on the one knowledge structure, at least one new goal; and
initiating, by the at least one processing device, at least one action with respect to the automatically identified at least one new goal;
wherein initiating the at least one action is with respect to at least one initiative by the at least one wholistic knowledge structure.

182. The attention learning method of claim 181,
wherein the at least one initiative is of a basis comprising:
soliciting information,
or exploring,
or searching information sources over external network communications,
or seeking permission,
or combination thereof.

183. The attention learning method of claim 181, wherein the at least one action is of a basis comprising generative intelligence.

184. The attention learning method of claim 178,
wherein the learning in the first learning stage further comprises:
learning, in a fifth learning stage, based on the learning in the third learning stage, comprising:
aligning, by the at least one processing device, the at least one first probability distribution with at least one user preference distribution,
wherein the at least one user preference distribution is based on user preferences.

185. The attention learning method of claim 184,
wherein the user preferences are based on: decisions of at least one live entity, or decisions of at least one AI, or combination thereof; and
wherein aligning the at least one first probability distribution is based on: optimizing at least one policy model with respect to the at least one user preference distribution, or the user preferences, or combination thereof.

186. The learning method of claim 165,
wherein the learning in the first learning stage further comprises:
learning, in a sixth learning stage, based on the learning in the fourth learning stage, comprising:
aligning, by the at least one processing device, the at least one first probability distribution with at least one user preference distribution;
wherein the at least one user preference distribution is based on user preferences.

187. The learning method of claim 186,
wherein the user preferences are based on: decisions of at least one live entity, or decisions of at least one AI, or combination thereof; and
wherein aligning the at least one first probability distribution is based on: optimizing at least one policy model with respect to the at least one user preference distribution, or the user preferences, or combination thereof.

188. The learning method of claim 139, wherein the at least one map of reasoning represents at least one metaheuristic.

189. The learning method of claim 27, wherein differentiating the at least one fact comprises:
focusing at least one attention, by the at least one expert knowledge structure, on at least one first fact.

190. The learning method of claim 27,
wherein differentiating the at least one fact is with respect to at least one varying context regarding the at least one field use; and
wherein differentiating the at least one fact comprises:
focusing at least one attention, by the at least one expert knowledge structure, on at least one first fact; and
attenuating focus, by the at least one expert knowledge structure, on at least one second fact.

191. The learning method of claim 27, further comprising:
extending, based on the learning in the second learning stage, the at least one first domain exposure;
wherein the at least one first domain exposure is shared with the at least one second entity; and
wherein extending the at least one first domain exposure is coordinated by the one or more AI construction and the at least one second entity.

192. The learning method of claim 27, further comprising:
fine tuning, with respect to the at least one field use, based on at least one genetic algorithm, the one knowledge structure.

193. The learning method of claim 165, wherein the plurality of sequences, or the plurality of attention structures, or combination thereof are parallel.

194. The learning method of claim 27, further comprising:
annealing, with respect to the at least one nondeterministic complexity, the one knowledge structure.

195. The learning method of claim 27,
wherein the at least one expert knowledge structure comprises the one knowledge structure.

196. The learning method of claim 27,
wherein the at least one expert knowledge structure is of a basis comprising quantum computation.

197. The attention learning method of claim 121, wherein the at least one map of reasoning represents at least one metaheuristic.

198. The attention learning method of claim 67, further comprising:
fine tuning, with respect to the at least one field use, based on at least one genetic algorithm, the one knowledge structure.

199. The attention learning method of claim 67,
wherein the at least one expert knowledge structure comprises the one knowledge structure.

200. The attention learning method of claim 67,
wherein the at least one expert knowledge structure is of a basis comprising quantum computation.

201. The attention learning method of claim 178, wherein the plurality of sequences, or the plurality of attention structures, or combination thereof are parallel.

202. The attention learning method of claim 67, further comprising:
annealing, with respect to the at least one nondeterministic complexity, the one knowledge structure.

203. The attention learning method of claim 67, wherein the one or more AI construction, with respect to the at least one expert knowledge structure, is generative.

204. The collective learning method of claim 171,
wherein the learning in the first learning stage further comprises:
learning, in a seventh learning stage, based on the learning in the fifth learning stage, comprising:
aligning, by the at least one processing device, the at least one first probability distribution with at least one user preference distribution,
wherein the at least one user preference distribution is based on user preferences.

205. The collective learning method of claim 204,
wherein the user preferences are based on: decisions of at least one live entity, or decisions of at least one AI, or combination thereof; and
wherein aligning the at least one first probability distribution is based on: optimizing at least one policy model with respect to the at least one user preference distribution, or the user preferences, or combination thereof.

206. The collective learning method of claim 176,
wherein the learning in the first learning stage further comprises:
learning, in a seventh learning stage, based on the learning in the sixth learning stage, comprising:
aligning, by the at least one processing device, the at least one second probability distribution with at least one user preference distribution,
wherein the at least one user preference distribution is based on user preferences.

207. The collective learning method of claim 206,
wherein the user preferences are based on: decisions of at least one live entity, or decisions of at least one AI, or combination thereof; and
wherein aligning the at least one second probability distribution is based on: optimizing at least one policy model with respect to the at least one user preference distribution, or the user preferences, or combination thereof.

208. The collective learning method of claim 157, wherein the at least one map of reasoning represents at least one metaheuristic.

209. The collective learning method of claim 93, wherein differentiating the at least one fact comprises:
focusing at least one attention, by the at least one expert knowledge structure, on at least one first fact.

210. The collective learning method of claim 93,
wherein differentiating the at least one fact is with respect to at least one varying context regarding the at least one field use; and
wherein differentiating the at least one fact comprises:
focusing at least one attention, by the at least one expert knowledge structure, on at least one first fact; and
attenuating focus, by the at least one expert knowledge structure, on at least one second fact.

211. The collective learning method of claim 93,
wherein the at least one expert knowledge structure comprises the one knowledge structure.

212. The collective learning method of claim 93,
wherein the at least one expert knowledge structure is of a basis comprising quantum computation.

213. The collective learning method of claim 93, further comprising:
fine tuning, with respect to the at least one field use, based on at least one genetic algorithm, the one knowledge structure.

214. The collective learning method of claim 93, further comprising:
annealing, with respect to the at least one nondeterministic complexity, the one knowledge structure.

215. The collective learning method of claim 171, wherein the plurality of sequences, or the plurality of attention structures, or combination thereof are parallel.

216. The collective learning method of claim 93, wherein the one or more AI construction, with respect to the at least one expert knowledge structure, is generative.

217. The collective learning method of claim 93, further comprising:
continually learning, by the one or more AI construction, based on the learning in the second learning stage and the learning in the third learning stage, with respect to the at least one field use.
